(19) United States
(12) Patent Application Publication
(10) Pub. No.: US 2009/0112642 A1
(43) Pub. Date: Apr. 30, 2009

(54) PATENT INFORMATION ANALYZING APPARATUS, PATENT INFORMATION ANALYZING METHOD, PATENT INFORMATION ANALYZING PROGRAM, AND COMPUTER-READABLE STORAGE MEDIUM

(76) Inventors: Kentaro Uekane, Nara (JP); Osamu Ochi, Nara (JP); Kazuhito Iwai, Hyogo (JP)

Correspondence Address: BIRCH STEWART KOLASCH & BIRCH, PO BOX 747, FALLS CHURCH, VA, 22040-0747, US

(21) Appl. No.: 11/915,315

(22) PCT Filed: May 15, 2006
(86) PCT No.: PCT/JP2006/309635

§ 371 Date: Nov. 21, 2007

(30) Foreign Application Priority Data
May 26, 2005 (JP) 2005-154656
May 26, 2005 (JP) 2005-154657
May 26, 2005 (JP) 2005-154658

(51) Int. Cl. G06Q 10/00; G06N 5/02

(52) U.S. Cl. 705/7; 706/46

(57) ABSTRACT

The claim analysis process section (60) represents, by a numerical value, the scope of right recited in a claim. Furthermore, the first analysis process section (61) adds up the number of sets of patent specification data whose scopes of rights have been represented by numerical values, and calculates the average of the scopes of the rights. Since the average can be used as an index to analyze the numbers and the scopes of inventions created or filed by applicants and attorneys, it becomes possible to objectively analyze the right acquisition capabilities of applicants and attorneys.

### TECHNICAL FIELD

The present invention relates to a patent information analyzing apparatus, a patent information analyzing method, and a patent information analyzing program, which figure out, from information such as an unexamined publication, a patent publication, and a registered utility model publication of a patent or a utility model, the right acquisition capabilities of an applicant of the patent or utility model, and also relates to a computer-readable storage medium on which the program is recorded.

The present invention also relates to a technique for analyzing a patent right or utility model right of an invention described in the patent specification data of an unexamined patent publication, a registered patent publication, a registered utility model publication or the like. More specifically, the present invention relates to a patent information analyzing apparatus, a patent information analyzing method, and a patent information analyzing program, by which whether the invention described in the patent specification data is exercisable is objectively analyzed, and also relates to a computer-readable storage medium on which the program is recorded.

Furthermore, the present invention relates to a patent information analyzing apparatus, a patent information analyzing method, and a patent information analyzing program, by which the scope of a claim of a patent (or utility model) recited in patent specification data is objectively analyzed, and also relates to a computer-readable storage medium on which the program is recorded.

### BACKGROUND ART

Examples of a method of analyzing the value of a patent or utility model are disclosed by the following patent documents 1 and 2. According to the patent document 1, as measures to evaluate each invention, three major evaluation items (patentability, technical value, and economic value) are set, and plural sub-items are further set for each of the major evaluation items. Points are assigned for each sub-item. Calculations are carried out by using the points and a comprehensive analysis is performed, so that each invention is evaluated (graded from A to C) as an important patent (rank A) or an incompetent patent (rank C), for example.

According to the patent document 2, as measures for evaluating each invention or for making comparisons between inventions, four major evaluation items (attractiveness of industry, attractiveness of invention, competition in industry, and strategic importance) are set, and plural sub-items are further set for each of the major evaluation items. Points are assigned for each sub-item. Calculations are carried out by using the points and a bubble chart is drawn, so that each invention or inventions is/are evaluated in accordance with the diameter of each bubble, a position on the chart, or the like.

These methods of evaluation, however, can only perform ex-post analysis of a patent or utility model which has been granted, by evaluating each invention or comparing plural inventions. According to these methods, it is not possible to analyze the grounds for the evaluation result. Therefore, even if it is found that one's company has only a few valuable patents and is inferior in the comprehensive capabilities in patent matters to another company, it is not possible to sufficiently analyze the fundamental causes for the result.

Importantly, how an applicant deals with a patent or utility model throughout a period from the filing of the application to the registration thereof is one of the fundamental causes for the conclusive result of the evaluation.

That is to say, before the filing of the application, what greatly influences on the acquisition of patent right for the applicant is whether claims cover a suitable scope without including unnecessary limitations therein. On the other hand, during the prosecution after the filing and before the registration, the applicant is required to respond to office actions and the like, and what greatly influences on the acquisition of patent right during the prosecution period is whether claims are properly amended.

As such, evaluation of each patent or utility model after the registration thereof is heavily dependent on whether an applicant has the ability to properly deal with the application throughout the period from the filing to the acquisition of the right. To grasp the comprehensive capabilities in patent matters, it is therefore important to assess the right acquisition capabilities of an applicant, which is the capacity of dealing with an application throughout the period from the filing to the registration. On this account, it is required to carry out such analysis automatically and objectively.

(2) In the meanwhile, various techniques for evaluating the value of a patent right have been proposed, and an example of such techniques is disclosed by the patent document 3. According to the technique of the patent document 3, patent rights owned by a company are classified into predetermined categories. The patent rights are analyzed in reference to the categories and evaluated.

That is to say, according to the technique of the patent document 3, a patent right group related to the patent rights to be analyzed is referred to. The precedence and the share (of one applicant in the group) of the patent rights to be analyzed are determined with reference to the patent right group, and the patent rights are classified into four categories. The patent rights are evaluated based on these categories.

For example, in case where a patent right belongs to a category of high precedence and large share, the patent right is viewed as a precedent monopolistic patent right. It is assumed that the filing of the application of the patent right precedes those of other companies and peripheral patents have been acquired by the company which owns the patent right. It is therefore determined that the patent right must be held by the company, and the patent right may be exercised against or licensed to other companies.

On the other hand, a patent right belonging to a category of low precedence and small share is viewed as a latecomer pinpoint patent right. The patent is assumed to be filed later than those of another company and said another company has many patent rights. It is therefore determined that the patent right should be disposed of by, for example, discontinuing the payment of the annual fee for the patent right.

As discussed above, according to the patent document 3, it is determined whether immediate exercise of a patent right against other companies is preferable. However, the number of precedent patent rights and the share of patent rights are not sufficient as factors to make this determination. To determine whether the patent right is actually exercisable, it is necessary to analyze the content of claims. Also, it is necessary to judge whether a product (method) of another company is encompassed within (i.e. infringes) the technical scope of claims of patent specification data of one's company.

An important point for the determination above is whether it is easy to assess the invention recited in claims infringes a patent right of others. Inventions are generally divided into product inventions and method inventions (including product-by-process inventions). Comparing product inventions with method inventions, usually infringement of someone's patent right can be easily proved in cases of product inventions. In addition to the above, inventions include numerical limitation inventions in which constituent features are limited by numerical values and/or mathematical expressions. To determine whether a patent right of a numerical limitation invention infringes someone's patent right, it is necessary to carry out various measurements or the like. It is therefore difficult to prove infringement, in cases of numerical limitation inventions.

As such, the types of inventions recited in claims determine whether it is easy to prove infringement. It is therefore very important to find out the types of inventions.

Analysis of the content of claims may be done one by one by humans, if several or several tens of patent specifications are the targets of the analysis. However, analysis by humans is extremely difficult if the targets of the analysis are several hundred to several thousand patent specifications. To analyze such a large number of patent specifications, it is therefore preferable to automatically and objectively analyze whether the invention recited in claims is easily exercisable, and such a technique is desired.

(3) The patent document 4 discloses a technique to assess the economic value of a patent right. According to the technique of the patent document 4, the economic value of a patent right is assessed based on the length of an independent claim.

As described above, according to the patent document 3, whether a patent right is actually exercisable against other companies is determined. However, since the determination is based on the number of precedent patent rights and the share of patent rights, it is not possible to objectively analyze the scope of a patent right of an invention recited in claims.

In the meanwhile, according to the patent document 4, the length of an independent claim is measured solely by counting the number of characters. In this case, since many of the measured characters may be those related to formality matters and by which the invention is not directly specified, it is difficult to accurately evaluate the scope of the patent right of the invention.

As such, conventional arts are disadvantageous in that it is difficult to accurately analyze how broad the scope of an invention recited in a claim (i.e. scope of a patent claim) is.

To analyze the scope of a patent recited in a claim, analysis by humans is possible if the target of the analysis are several or several tens of patent specifications. However, such analysis by humans is extremely difficult if the targets of analysis are several hundred to several thousand patent specifications. Therefore, to analyze such a large number of patent specifications, it is preferable to automatically and objectively analyze the scope of a patent right based on the recitation in the claim of the patent specification, and such technique is desired.

[patent document 1]

Japanese Laid-Open Patent Application No. 2000-132606 (published on May 12, 2000)

[patent document 2]

Japanese Laid-Open Patent Application No. 2004-145629 (published on May 20, 2004)

[patent document 3]

Japanese Laid-Open Patent Application No. 2003-281358 (published on Oct. 3, 2003)

[patent document 4]

Japanese PCT National Phase Unexamined Patent Publication No. 2004-500617 (internationally published on Dec. 14, 2000)

### DISCLOSURE OF INVENTION

The present invention was done to solve the above-described problem, and the objective of the present invention is to provide a patent information analyzing apparatus, a patent information analyzing method, a patent information analyzing program, and a computer-readable storage medium, which make it possible to objectively analyze the right acquisition capabilities of applicants and attorneys, based on patent specification data of unexamined publications, patent publications, registered utility model publications or the like of patents and utility model.

To achieve the objective above, the patent information analyzing apparatus of the present invention, analyzing at least one set of patent specification data including at least one claim, includes: claim analysis means for representing the scope of right of said at least one claim by a numerical value; and first analysis process means for adding up the total number of said at least one set of patent specification data whose scope of rights have been represented by numerical values by the claim analysis means, and calculating the average of the scopes of rights.

The patent specification data indicates data of the contents in specifications and patent claims (or utility model claims) stipulated by patent laws or the like of the countries (e.g. Japanese Patent Law 36(2) and Japanese Utility Model Law 5(2) in Japan), and the patent specification data is obtained from electronic data of unexamined patent publications and registered patent publications (or utility model publications and registered utility model publication). The patent specification data includes INID (Internationally agreed Numbers for the Identification of Data) code (classification number for bibliographic data) stipulated by WIPO (World Intellectual Property Organization).

The patent specification data may also includes information in regard to the prosecution and proceeding after the registration, such as the numbers specifying the cited documents in an Office Action, how many times the filing of oppositions and trials have been made, and how many times a request of inspection of a matter of record in the specification has been made. Such information in regard to the prosecution and proceeding after the registration may be used as public attention data indicating to what degree the patent specification data has drawn attentions of other companies (i.e. those who are not the applicant of the patent specification data).

The public attention data can be easily obtained from publicly-known patent information databases. The public attention data may be included in the patent specification data or may be independent of the patent specification data.

According to the arrangement above, since the scope of right indicated by a claim is represented by a numerical value by the claim analysis means, it is possible to objectively grasp the scope of right. Furthermore, since the first analysis process means calculates the average of the scopes of rights, it is possible to objectively analyze the right acquisition capabilities of applicants, attorneys, or the like.

That is to say, it is often simply understood that an applicant who has filed a lot of patent applications (i.e. the total number of sets of patent specification data is large) has a high right acquisition capabilities. However, in reality, the right acquisition capabilities of the applicant are not always high if the scope of right indicated in the claim of each set of patent specification data is narrow.

In this regard, not simply focusing on the total number of sets of patent specification data, the aforesaid patent information analyzing apparatus can calculate the average of the scopes of rights recited in the claims of the sets of patent specification data, by the first analysis process means. Since this average is helpful for understanding the number of patents and the scopes thereof of each applicant or each attorney, it is possible to precisely analyze the right acquisition capabilities of each applicant or attorney.

In addition to the above, the patent information analyzing apparatus of the present invention preferably includes first comparative evaluation means for performing a relative comparison of the averages of the scopes of rights calculated by the first analysis process means, between different applicants.

According to this arrangement, the first comparative evaluation means compares and evaluates the averages of the scopes of rights, between different applicants. On this account, not simply comparing the numbers of applications between the applicants, it is possible to relatively analyze the right acquisition capabilities of each applicant, i.e. to analyze the number of applications of each applicant and the scopes of the applications.

In addition to the above, the patent information analyzing apparatus of the present invention preferably includes first comparative evaluation means for performing a relative comparison of the averages of the scopes of rights calculated by the first analysis process means, between different attorneys.

According to the arrangement above, the first comparative evaluation means performs a relative comparison of the averages of the scopes of rights between different attorneys, On this account, not simply comparing the numbers of applications between the attorneys, it is possible to relatively analyze the right acquisition capabilities of each attorney, i.e. to analyze the number of applications of each attorney and the scopes of the applications.

In addition to the above, the patent information analyzing apparatus of the present invention is preferably arranged such that the first comparative evaluation means arranges the averages of the scopes of rights to belong to a single technical field.

According to the arrangement above, the first comparative evaluation means performs a relative comparison of the averages of the scopes of rights belonging to the same technical field, between applicants or between attorneys.

That is to say, the way of describing claims and the contents of invention specifying features are greatly different between technical fields. For example, in the technical field of liquid crystal displays, when the average number of characters in (1) patents of drive technology (2H093 in F term which is patent classification unique to Japan) and the average number of characters in (2) patents of technologies related to substrate, insulating film, and orientation film (2H090 in F term which is patent classification unique to Japan) are compared to one another, the number of characters in the technology (1) is typically larger because the patents of the technology (1) typically include a larger number of invention specifying features related to circuit configuration, the process of driving, or the like. Although the example above uses the patent classification unique to Japan, when a comparison of the average characters between (1) patents of drive technology and (2) patents of technologies related to substrate, insulating film, and orientation film is performed based on IPC which is international patent classification or US class which is unique to U.S.A, the patents of the technology (1) typically include a larger number of invention specifying features related to circuit configuration, the process of driving, or the like, in a similar manner.

As such, since the average number of characters in claims and the average number of invention specifying features are typically different between technical fields, such a difference may influence on the scope of right which is numerically expressed by the claim analysis means. Therefore, the right acquisition capabilities may not be properly evaluated by comparing the values indicating the scopes of rights between technical fields which are hardly related to one another.

However, the aforesaid patent information analyzing apparatus is arranged such that the first comparative evaluation means performs a relative comparison of the averages of the scopes of rights related to the same technical field, between applicants or attorneys. It is therefore possible to perform comparison and evaluation of the right acquisition capabilities of each applicant or attorney, in a fair and proper manner.

In addition to the above, the patent information analyzing apparatus of the present invention is preferably arranged such that said at least one set of patent specification data is obtained from an unexamined patent publication.

According to this arrangement, since the patent specification data is obtained from an unexamined patent publication, it is possible to analyze the ability of drafting a specification of an applicant or attorney, at the time of the filing. That is to say, since an unexamined patent publication includes an original claim, if the scope of right indicated by the claim is numerically represented by the claim analysis means, it is possible to objectively judge whether a claim with a proper scope of right without unnecessary limitations is drafted at the time of filing.

This makes it possible to objectively analyze the ability to draft a specification, which is an example of the right acquisition capabilities.

In addition to the above, the patent information analyzing apparatus of the present invention is preferably arranged such that said at least one set of patent specification data is obtained from a registered patent publication.

According to this arrangement, since the patent specification data is obtained from a registered patent publication, it is possible to analyze the right acquisition capabilities such as the ability to draft a specification and the ability to respond to office actions of an applicant or attorney.

That is to say, since a registered patent publication includes a claim at the time of registration, if the scope of right indicated by the claim is numerically expressed by the claim analysis means, it is possible to objectively judge whether a claim having a proper scope of right without unnecessary limitations is patented.

The inventors of the present invention found a correlation such that, if the scope of right indicated by a claim at the time of the registration is proper, the scope of right indicated by the claim at the time of the filing is more or less proper. Therefore, numerically representing the scope of right indicated by a claim at the time of registration makes it possible to judge whether a claim having a proper scope of right without unnecessary limitations was drafted at the time of filing. It is therefore possible to judge the ability to draft a specification, which is an example of the right acquisition capabilities.

Furthermore, if the scope of right indicated by a claim at the time of registration is proper, it is considered that patent has been obtained without adding an unnecessary limitation during the period of prosecution. On this account, numerically representing the scope of right indicated by a claim at the time of registration makes it possible to analyze the ability to properly respond to office actions (office action response ability).

To achieve the objective above, the patent information analyzing sets of patent specification data including at least one claim, includes: claim analysis means for representing the scope of right of said at least one claim by a numerical value; and second analysis process means for performing a comparison between the scopes of rights, which have been represented by numerical values by the claim analysis means, of the sets of one set of patent specification data belonging to a single application.

According to the arrangement above, the second analysis process means compares the numerically-represented scopes of rights between sets of patent specification data belonging to the same application. It is therefore possible to analyze the right acquisition capabilities such as the ability to respond to office actions issued during the period after the filing and before the registration.

That is to say, sets of patent specification data whose scopes of rights are compared by the second analysis process means are, for example, arranged to be sets of patent specification data belonging to the same application but issued at different times, for example, a set of patent specification data obtained from an unexamined publication and a set of patent specification data obtained from a registered patent publication.

This makes it possible to objectively judge how the scope of right of an application changes through the prosecution, with reference to the result of the comparison by the second analysis process means. It is therefore possible to objectively and precisely analyze the office action response ability indicating whether a claim is properly amended without adding an unnecessary limitation, during the prosecution.

Since this office action response ability is a part of the right acquisition capabilities, it is considered that the right acquisition capabilities are objectively and precisely analyzed.

In addition to the above, the patent information analyzing apparatus of the present invention is preferably arranged such that the sets of patent specification data are specified based on an application number.

According to this arrangement, since plural sets of patent specification data belonging to the same application are specified by the application number, sets of patent specification data which are the targets of comparison by the second analysis process means are easily specified. It is therefore possible to easily analyze the office action response ability.

In addition to the above, the patent information analyzing apparatus of the present invention is preferably arranged such that the sets of patent specification data are obtained from patent specification data of an unexamined patent publication and from a registered patent publication.

According to this arrangement, since the scope of right indicated by a claim in a set of patent specification data obtained from an unexamined patent publication is numerically represented by the claim analysis means, it is possible to objectively judge the scope of right of the claim at the time of the filing. Also, since the scope of right indicated by a claim in a set of patent specification data obtained from a registered patent publication is numerically represented by the claim analysis means, it is possible to objectively judge the scope of right of the claim after the registration.

Therefore, since the second analysis process means compares the value indicating the scope of right of the claim in the unexamined patent publication with the value indicating the scope of right of the claim in the registered patent publication, it is possible to objectively analyze to what degree the claim has been limited during the prosecution, and hence it is possible to analyze the office action response ability in a more precise manner.

In addition to the above, the patent information analyzing apparatus of the present invention preferably includes first comparative evaluation means for performing a comparison and evaluation between differences which are results of comparisons by the second analysis process means, the results of comparisons belonging to a single technical field.

As discussed above, the average number of characters in the claim and the average number of invention specifying features are different between technical fields, and this difference may influence on the scope of right which is numerically represented by the claim analysis means. On this account, when plural results of differences calculated by the second analysis process means are prepared, compared, and evaluated in order to compare and evaluate the right acquisition capabilities of each applicant or attorney, the evaluation may not be properly done if the targets of the comparison belong to technical fields which are hardly related to one another.

According to the aforesaid patent information analyzing apparatus, the first comparative evaluation means performs a comparison and evaluation of results of differences calculated by the second analysis process means, belonging to the same technical field. It is therefore possible to compare and evaluate the right acquisition capabilities of applicants or attorneys, in a further fair and appropriate manner.

In addition to the above, the patent information analyzing apparatus of the present invention includes third analysis process means for analyzing the result of the comparison by the second analysis means, based on data of a patent registration success rate which indicates the rate of registration of applications.

According to the arrangement above, since the result of the comparison by the second analysis process means is analyzed based on the data of the patent registration success rate, it is possible to analyze the patent acquisition strategy of an applicant or attorney.

That is to say, assume that the result of the difference calculated by the second analysis process means indicates that the value indicating the scope of right indicated by a claim of each application of an applicant is significantly increased during the prosecution period. In such a case, if the patent registration success rate of the applicant is judged as high by the third analysis process means, it is considered that the strategy of patent acquisition of the applicant is such that the applicant wants to register the application even if the claim is significantly limited in the prosecution.

On the other hand, assume that the value indicating the scope of right indicated by a claim of each application of an application is not really increased during the prosecution period. In such a case, if the third analysis process means judges that the applicant patent registration success rate of the applicant is low, it is considered that the strategy of patent acquisition of the applicant is such that the applicant wants to register only those applications which can be easily registered without adding many limitations during the prosecution.

The patent registration success rate indicates a ratio between the total number of applications and the number of registered applications. The patent registration success rate in one year can be calculated by, for example, the following way: the number of registrations in one year/(the number of registrations in one year+the number of rejected applications in one year+the number of abandoned or withdrawn applications in one year).

In addition to the above, the patent information analyzing apparatus of the present invention preferably includes third analysis process means for analyzing the result of the comparison by the first comparative evaluation means, based on data of a patent registration success rate which indicates the rate of registration of applications.

According to the arrangement above, since the result of the comparison by the first comparative evaluation means is analyzed by the third analysis process means based on the data of the patent registration success rate, it is possible to properly compare and analyze the patent acquisition strategy of an applicant or attorney.

That is to say, since the targets of the comparison by the first comparative evaluation means are the results of the differences calculated by the second analysis process means, the analysis of the results of the comparison by the first comparative evaluation means by the third analysis process means is equivalent to the analysis of the results of the differences calculated by the second analysis process means by using the data of the patent registration success rate. Therefore, it is possible to evaluate the patent acquisition strategy of an applicant or attorney by analyzing the result of the comparison by the first comparative evaluation means by using the data of the patent registration success rate.

As discussed above, the first comparative evaluation means compares and evaluates the results of the differences calculated by the second analysis process means, belonging to the same technical field. On this account, the result of the comparison by the first comparative evaluation means is suitable for comparing and evaluating the patent acquisition strategies of applicants or attorneys.

The arrangement above therefore makes it possible top properly compare and evaluate the patent acquisition strategies of applicant or attorneys.

To achieve the objective above, a patent information analyzing apparatus of the present invention, analyzing apparatus analyzing at least one set of patent specification data including a registered patent publication or an unexamined patent publication, includes: fourth analysis means for adding up the number of said at least one set of patent specification data and analyzing said at least one set of patent specification data based on public attention data which indicates how said at least one set of patent specification data have drawn attentions.

According to the arrangement above, it is possible to objectively analyze the right acquisition capabilities of an applicant by adding up the number of the sets of patent specification data and analyzing the sets of patent specification data with reference to the public attention data indicating to what degree the patent specification data has drawn attentions.

That is to say, it is typically judged that the number of patent applications (i.e. the total number of sets of patent specification data) is simply proportional to the comprehensive capabilities in patent matters. However, according to the arrangement above, sets of patent specification data are analyzed by not only focusing on the total number of the sets of patent specification data but also using public attention data indicating to what degree these sets of patent specification data have drawn attentions of other companies (companies other than the applicant).

If an applicant has filed many applications drawing widespread attentions of other companies, it is considered that the applicant has filed many applications beyond the current technical level and products of other companies and having possibilities of being licensed to others, and hence the right acquisition capabilities of the applicant are high.

Therefore, the arrangement above makes it possible to analyze the right acquisition capabilities of an applicant, from the perspective of to what degree the applications of the applicant are important.

In addition to the above, the patent information analyzing apparatus of the present invention preferably includes first comparative evaluation means for performing a comparison and evaluation between results of analysis by the fourth analysis process means, the results of analysis belonging to a single technical field.

As discussed above, the average number of characters in the claim and the average number of invention specifying features are different between technical fields. On this account, when plural results of comparisons calculated by the fourth analysis process means are prepared, compared, and evaluated in order to compare and evaluate the right acquisition capabilities of each applicant or attorney, the evaluation may not be properly done if the targets of the comparison belong to technical fields which are hardly related to one another.

According to the aforesaid patent information analyzing apparatus, the first comparative evaluation means performs a comparison and evaluation of results of comparisons by the fourth analysis process means, belonging to the same technical field. It is therefore possible to compare and evaluate the right acquisition capabilities of applicants or attorneys.

In addition to the above, the patent information analyzing apparatus of the present invention is preferably arranged such that the public attention data indicates the number of cases against each of which a notice of trial, an opposition, or a request for reexamination has been filed.

In addition to the above, the patent information analyzing apparatus of the present invention may be arranged such that the public attention data indicates the number of cases which have been cited as documents for denying the novelty or inventive step of an invention taught in another application or have been cited as prior art documents in specifications.

In addition to the above, the patent information analyzing apparatus of the present invention may be arranged such that the public attention data indicates the number of cases to each of which a request of inspection of a matter of record in the specification has been made.

That is to say against an application drawing attentions of other companies, a notice of trial, an opposition, or a request for reexamination is often filed by other companies. It is therefore considered that the number of notices of trial, oppositions, or requests for reexamination can be used as the public attention data.

Moreover, an application drawing attentions of other companies is often cited as a prior art document in examinations by the Patent Office, and the applicant himself/herself also often cites the application as a prior art document. On this account, the number of times when the set of patent specification data is cited to reject the novelty or inventive step of another application or the number of times when the set of patent specification data is cited as a prior art document in specifications can be used as the public attention data.

If a request of inspection of the file wrapper (in which documents related to the application and filed with the Patent Office are stored) has been made, it is considered that a notice of trial or an opposition may be made in future and hence the application has drawn attentions. On this account, the number of request of inspection of a matter of record in the specification can be used as the public attention data.

In addition to the above, the patent information analyzing apparatus of the present invention preferably includes claim analysis means for representing the scope of right of at least one claim in said at least one set of patent specification data, by a numerical value.

According to this arrangement, since the claim analysis means numerically represents the scope of right, it is possible to judge whether the scope of right of a claim drafted by an applicant or attorney is appropriate. It is therefore possible to precisely grasp the right acquisition capabilities of an applicant or attorney.

In addition to the above, the patent information analyzing apparatus of the present invention is preferably arranged such that the claim analysis means counts the number of characters or words constituting an independent claim in said at least one claim.

According to this arrangement, the claim analysis means analyzes the scope of right indicated by claim by counting the number of characters or words constituting an independent claim. That is to say, the scope of right indicated by a claim is determined by the words (characters) in the claim. On this account, the number of limiting words is proportional to the number of limitations, and hence the scope of right is narrow. On the other hand, the scope of right is typically broad if the number of unnecessary limitations is small. As such, if the number of characters or words is small as a result of counting the number of characters or words constituting an independent claim, the scope of right is likely to be broad. On the other hand, if the number of characters or words is large, the scope of right is likely to be narrow.

On this account, the arrangement above makes it possible to properly evaluate the scope of right indicated by a claim.

In addition to the above, the patent information analyzing apparatus of the present invention may be arranged such that the claim analysis means counts the number of constituent features constituting an independent claim of said at least one claims.

According to the arrangement above the claim analysis means analyzes the scope of right indicated by claim by counting the number of constituent features constituting an independent claim. That is to say, the scope of right indicated by a claim is made up of constituted features described therein. On this account, the number of constituent features is proportional to the number of limitations, and hence the scope of right is narrow. On the other hand, the scope of right is typically broad if the number of constituted features is small.

For example, comparing a claim with two constituent features A and B, such as (3) “A [symbol] B [symbol] [symbol] ” with a claim with four constituent features A to D, such as (4) “A [symbol] B [symbol] C [symbol] D [symbol] [symbol] ”, it is concluded that the scope of right of the claim (3) having fewer constituent features is clearly broad, whereas the scope of right of the claim (4) is narrower than that of the claim (3).

On this account, the arrangement above makes it possible to properly evaluate the scope of right indicated by a claim.

In addition to the above, the patent information analyzing apparatus of the present invention is preferably arranged such that the first comparative evaluation means judges that technical fields are identical, if substantially identical patent classification symbols are assigned to said at least one set of patent specification data.

According to the arrangement above, the first comparative evaluation means judges whether technical fields are identical or not with reference to patent classification symbols assigned to sets of patent specification data (e.g. IPC (International Patent Classification), FI (File Index) and F term in Japan, and US Class in U.S.A.). It is therefore possible to precisely and easily judge whether technical fields are identical or not.

The phrase “substantially identical patent classification symbol” indicates patent classification symbols which are different in expression but are considered to be substantially identical. For example, IPC, which is an example of patent classification symbols, has major divisions indicating the outlines of the fields of inventions, and intermediate and minor divisions indicating narrower fields. For example, two IPCs which are the same in major divisions but different in intermediate or minor divisions are not identical with one another in expression but indicate the substantially same field. These two are therefore the substantially same patent classification symbols.

In addition to the above, the patent information analyzing apparatus of the present invention preferably includes output means for outputting, on an applicant by applicant basis, the results of the comparisons by the first comparative evaluation means to an output device.

According to this arrangement, the display content on the output device allows a viewer to understand at a glance the right acquisition capabilities of each applicant from the results of the comparisons by the first comparative evaluation means.

In addition to the above, the patent information analyzing apparatus of the present invention preferably includes output means for outputting, on an attorney by attorney basis, the results of the comparisons by the first comparative evaluation means to an output device.

According to this arrangement, the display content on the output device allows a viewer to understand at a glance the right acquisition capabilities of each attorney from the results of the comparisons by the first comparative evaluation means.

In addition to the above, the patent information analyzing apparatus of the present invention is preferably arranged such that the output means causes the output device to display an average right acquisition capability of applicants or attorneys in the technical field to which the comparisons by the first comparative evaluation means relate.

According to this arrangement, viewing the display on the output device, the viewer can grasp the average right acquisition capabilities of applicant or attorneys of the same technical field. It is therefore possible to compare and evaluate the right acquisition capabilities of an applicant or attorney with the industry average right acquisition capabilities.

To achieve the objective above, a patent information analyzing method of the present invention, for analyzing at least one set of patent specification data including at least one claim, includes the steps of: (i) representing, by a numerical value, the scope of right of said at least one claim; and (ii) adding up the total number of said at least one set of patent specification data whose scopes of rights have been represented by numerical values in the step (i), and calculating the average of the scopes of rights thus represented by the numerical values.

To achieve the objective above, a patent information analyzing method of the present invention, for analyzing sets of patent specification data including at least one claim, includes the steps of: (i) representing, by a numerical value, the scope of right of said at least one claim; and (ii) performing a comparison between the scopes of rights, which have been represented by numerical values in the step (i), of the sets of patent specification data belonging to a single application.

To achieve the objective above, a patent information analyzing method of the present invention, for analyzing at least one set of patent specification data including a registered patent publication or an unexamined patent publication, includes the step of adding up the number of said at least one set of patent specification data and analyzing said at least one set of patent specification data based on public attention data which indicates how said at least one set of patent specification data have drawn attentions.

According to the aforesaid patent information analyzing methods, because the functions equivalent to those of the patent information analyzing apparatuses of the present invention, it is possible to obtain the effects equivalent to those of the patent information analyzing apparatuses of the present invention.

As described above, in the present invention, it is possible to objectively analyze the right acquisition capabilities of an applicant, with reference to patent specification data.

2. Also, the present invention was done to solve the problem above, and the objective of the present invention is to provide a patent information analyzing apparatus, a patent information analyzing method, a patent information analyzing program and a storage medium, by which whether the invention recited in a claim of a patent specification is easily exercisable can be objectively analyzed.

To achieve the objective above, a patent information analyzing apparatus, analyzing at least one set of patent specification data including at least one claim, includes: character string comparison means for comparing at least one character string in said at least one claim with at least one predetermined character string indicating the type of an invention; and invention type judging means for judging the type of an invention recited in said at least one claim based on the result of the comparison by the character string comparison means.

According to the arrangement above, the apparatus compares at least one character string in a claim of patent specification data with predetermined at least one character string indicating the type of an invention, so as to determine the type of the invention recited in the claim. It has been known that whether a patent right is easily exercisable can be determined typically based on the type of the invention recited in a claim. The apparatus can therefore make it possible to analyze whether the patent right of the invention which is the target of analysis is easily exercisable, based on the type of the invention thus specified.

To achieve the objective above, a patent information analyzing method of the present invention, for analyzing at least one set of patent specification data, which is used for a patent information analyzing apparatus processing said at least one set of patent specification data including at least one claim, includes the steps of: (i) comparing at least one character string in said at least one claim with predetermined at least one character string indicating the type of an invention; and (ii) judging the type of an invention recited in said at least one claim, based on the result of the comparison in the step (i).

According to the method above, the effects similar to those of the patent information analyzing apparatus of the present invention are exerted.

Another patent information analyzing apparatus of the present invention, analyzing at least one set of patent specification data including at least one claim, includes: character string comparison means for comparing at least one character string in said at least one claim with predetermined at least one character string indicating a numerical limitation invention; and numerical limitation invention judging means for judging whether an invention recited in said at least one claim is a numerical limitation invention, based on the result of the comparison by the character string comparison means.

According to this arrangement, the apparatus judges whether the invention recited in a claim of a set of patent specification data includes a numerical limitation, by comparing at least one character string in the claim of the set of patent specification data with predetermined at least one character string indicating a numerical limitation. It has been know that an invention in which an invention specifying feature is limited by a value or a numerical expression is typically not easily exercisable. The apparatus can therefore analyze whether the patent right of the invention which is the target of analysis is easily exercisable, based on the type of the invention thus specified.

To achieve the objective above, another patent information analyzing method of the present invention, for analyzing at least one set of patent specification data, which is used for a patent information analyzing apparatus processing said at least one set of patent specification data including at least one claim, includes the steps of: (i) comparing at least one character string in said at least one claim with predetermined at least one character string indicating a numerical limitation; and (ii) judging whether an invention recited in said at least one claim is a numerical limitation invention, based on the result of the comparison in the step (i).

According to the method above, the effects equivalent to those of the patent information analyzing apparatus of the present invention can be exerted.

Another patent information analyzing apparatus of the present invention, analyzing at least one set of patent specification data including at least one claim, includes: invention type judging means for judging the type of an invention recited in said at least one claim by comparing at least one character string in said at least one claim with predetermined at least one character string indicating the type of an invention; and numerical limitation invention judging means for judging whether the invention recited in at least one claim is a numerical limitation invention, by comparing said at least one character string in said at least one claim with the predetermined at least one character string indicating the numerical limitation invention.

According to the arrangement above, the apparatus judges the type of the invention recited in the claim of the set of patent specification data, by comparing at least one character string in the claim with predetermined at least one character string indicating the type of the invention. Furthermore, it is judged whether the invention recited in the claim includes a numerical limitation, by comparing at least one character string in the claim of the set of patent specification data with predetermined at least one character string indicating a numerical limitation. It has been known that whether a patent right is easily exercisable can be determined typically based on the type of the invention recited in a claim. It has also been known that an invention in which an invention specifying feature is limited by a value or a numerical expression is not easily exercisable.

In this manner, the apparatus judges the type of the invention which is the target of analysis and also judges whether the invention is a numerical limitation invention. The apparatus can therefore precisely analyze whether the invention which is the target of analysis is easily exercisable.

To achieve the objective above, another patent information analyzing method of the present invention, for analyzing at least one set of patent specification data, which is used for a patent information analyzing apparatus processing said at least one set of patent specification data including at least one claim, includes the steps of: (i) judging the type of an invention recited in said at least one claim by comparing at least one character string in said at least one claim with predetermined at least one character string indicating the type of an invention; and (ii) judging whether an invention recited in at least one claim is a numerical limitation invention, by comparing said at least one character string in said at least one claim with predetermined at least one character string indicating a numerical limitation invention.

According to the method above, the effects similar to those of the patent information analyzing apparatus of the present invention are exerted.

In addition to the above, the patent information analyzing apparatus of the present invention is preferably arranged such that said at least one claim is an independent claim.

According to the arrangement above, the apparatus judges the type of the invention recited in an independent claim. The number of limitations in the invention pertaining to an independent claim is typically smaller than those recited in the invention pertaining to a dependent claim. The apparatus can therefore analyze a claim reciting an invention having a broader scope of right.

In addition to the above, the patent information analyzing apparatus of the present invention is preferably arranged such that the independent claim is the first claim of claims of said at least one set of patent specification data.

According to the arrangement above, the apparatus judges the type of the invention recited in the first claim of the claims of the set of patent specification data, i.e. the invention recited in claim 1. Claim 1 which is the first claim of claims typically pertains to the most important invention in one patent specification. In other words, in a patent specification, an independent claim may be the most important main claim. The apparatus can therefore judge the type of the most important inventions, among inventions recited in a set of patent specification data.

In addition to the above, the patent information analyzing apparatus of the present invention is preferably arranged such that said at least one character string indicating the type of invention indicates a product invention, and the invention type judging means judges that the invention recited in said at least one claim is a product invention. Also, it is preferably arranged such that said at least one character string indicating the product invention are at least one of “ [symbol] ”, “ [symbol] ”, “ [symbol] ”, “ [symbol] ”, “ [symbol] ”, “ [symbol] ”, and “ [symbol] ” in Japanese patent specifications written in Japanese. In cases of U.S. patent specifications (written in English), said at least one character string may be a word (character string) indicating a product invention, such as “apparatus” Not limited to these arrangements, the patent information analyzing apparatus of the present invention may judge, in accordance with patent specifications of different countries, that a word (character string) indicates a product invention in the languages of respective countries. According to this arrangement, the apparatus can surely judge that the invention recited in a claim is a product invention.

In addition to the above, the patent information analyzing apparatus of the present invention is preferably arranged such that said at least one character string indicating the type of invention indicates a method invention, and the invention type judging means judges that the invention recited in said at least one claim is a method invention. Also, it is preferably arranged such that said at least one character string indicating the method invention is at least one of “ [symbol] ”, “ [symbol] ”, and “ [symbol] ” in Japanese patent specifications written in Japanese. In cases of U.S. patent specifications (written in English), said at least one character string may be a word (character string) indicating a method invention, such as “process” Not limited to these arrangements, the patent information analyzing apparatus of the present invention may judge, in accordance with patent specifications of different countries, that a word (character string) indicates a product invention in the languages of respective countries. According to this arrangement, the apparatus can surely judge that the invention recited in a claim is a method invention.

In addition to the above, the patent information analyzing apparatus of the present invention is preferably arranged such that the invention type judging means determines that the invention recited in said at least one claim is a product invention, if the character string indicating the method invention is not recited in said at least one claim. The invention type judging means judges that an invention, which is judged not to be a method invention, as a product invention. That is to say, it is generally considered that a claim including a character string indicating a method invention is almost certainly a claim pertaining to a method invention. On this account, by determining inventions other than the above as product inventions, the apparatus can surely judge that the invention recited in a claim is a product invention.

In addition to the above, the patent information analyzing apparatus of the present invention is preferably arranged such that said at least one character string indicating the numerical limitation invention is a unit symbol, an arithmetic sign which is a part of a numerical expression, and/or a symbol indicating a numerical quantity. According to this arrangement, the apparatus can surely judge that the invention recited in a claim is a numerical limitation invention.

In addition to the above, the patent information analyzing apparatus of the present invention preferably includes invention quantity counting means for counting the number of the types of the inventions specified by the invention type judging means.

According to this arrangement, the apparatus can analyze how many claims pertain to easily-exercisable inventions and how many claims pertain to inventions which are not easily exercisable.

In addition to the above, the patent information analyzing apparatus of the present invention preferably includes numerical limitation invention quantity counting means for counting the number of the numerical limitation inventions specified by the numerical limitation invention judging means.

According to this arrangement, the apparatus can analyze how many claims pertain to easily-exercisable inventions and how many claims pertain to inventions which are not easily exercisable.

In addition to the above, the patent information analyzing apparatus of the present invention preferably includes second comparative evaluation means for evaluating said at least one set of patent specification data, based on the result of the counting of the number of the inventions by the invention quantity counting means.

According to this arrangement, the apparatus evaluates sets of patent specification data based on the number of the types of inventions. On this account, in case where plural sets of patent specification data are the targets of analysis, the sets of patent specification data are analyzed based on the number of easily-exercisable inventions and the number of inventions which are not easily exercisable. This allows the apparatus to objectively evaluate the sets of patent specification data.

In addition to the above, the patent information analyzing apparatus of the present invention preferably includes second comparative evaluation means for evaluating said at least one set of patent specification data based on the result of the counting of the number of the numerical limitation inventions by the numerical limitation invention quantity counting means.

According to this arrangement, the apparatus evaluates sets of patent specification data based on the number of numerical limitation inventions. On this account, in case where plural sets of patent specification data are the targets of analysis, the sets of patent specification data are analyzed based on the number of easily-exercisable inventions and the number of inventions which are not easily exercisable. This allows the apparatus to objectively evaluate the sets of patent specification data.

In addition to the above, the patent information analyzing apparatus of the present invention is preferably arranged such that the invention quantity counting means counts the number of inventions recited in claims of said at least one set of patent specification data belonging to a single technical field, among the results of the analysis by the invention type judging means.

The criterion of the judgment of the type of an invention, a product invention or a method invention, may be greatly different between technical fields. On this account, the component ratio of the types of inventions may be greatly different between technical fields. For example, while 70% of the inventions in one technical field are product inventions, only 20% of the inventions in another technical field are product inventions.

The apparatus therefore counts the number of inventions recited in claims of sets of patent specification data belonging to the same technical field. On this account, the apparatus can fairly and objectively analyze the sets of patent specification data which are the targets of analysis.

In addition to the above, the patent information analyzing apparatus of the present invention is preferably arranged such that the numerical limitation invention quantity counting means counts the number of numerical limitation inventions recited in claims of said at least one set of patent specification data belonging to a single technical field, among the results of the analysis by the numerical limitation invention judging means.

The criterion of the judgment of the type of an invention, a numerical invention or a non-numerical limitation invention, may be greatly different between technical fields. On this account, the component ratio of the types of inventions may be greatly different between technical fields. For example, while 15% of the inventions in one technical field are numerical limitation inventions, 75% of the inventions in another technical field are non-numerical limitation inventions.

The apparatus therefore counts the number of numerical-limitation inventions recited in claims of sets of patent specification data belonging to the same technical field. On this account, the apparatus can fairly and objectively analyze the sets of patent specification data which are the targets of analysis.

In addition to the above, the patent information analyzing apparatus of the present invention is preferably arranged such that said at least one set of patent specification data belonging to the single technical field are sets of patent specification data to which substantially identical patent classification symbols are assigned.

According to the arrangement above, the apparatus analyzes sets of patent specification data having substantially identical patent classification symbols. The patent classification symbols are IPC (International Patent Classification) and FI (File Index) and F term which are unique to Japan, in case of Japanese patent application specifications, or US Class in U.S. patent application specifications. This allows the apparatus to precisely and easily judge to which technical field the set of patent specification data which is the target of analysis belongs.

The phrase “substantially identical patent classification symbol” indicates patent classification symbols which are different in expression but are considered to be substantially identical. For example, IPC, which is an example of patent classification symbols, has major divisions indicating the outlines of the fields of inventions, and intermediate and minor divisions indicating narrower fields. For example, two IPCs which are the same in major divisions but different in intermediate or minor divisions are not identical with one another in expression but indicate the substantially same field. These two are therefore the substantially same patent classification symbols.

In addition to the above, the patent information analyzing apparatus of the present invention is preferably arranged such that the invention quantity counting means counts the number of inventions of each applicant of said at least one set of patent specification data, among the results of the analysis by the invention type judging means.

According to the arrangement above, the apparatus counts the number of inventions of each applicant of patent specification data. This allows the apparatus to performs a relative comparison and evaluation of patent rights of each applicant.

In addition to the above, the patent information analyzing apparatus of the present invention preferably includes output means for outputting, on an applicant by applicant basis, the results of the comparisons by the second comparative evaluation means to an output device.

According to this arrangement, viewing the display content on the output device, the viewer can grasp at a glance the number of easily-exercisable inventions and the number of inventions not easily exercisable, on an applicant by applicant basis.

As discussed above, the present invention makes it possible to objectively analyze whether an invention recited in a claim of a patent specification is easily exercisable.

3. The present invention was done to solve the problem above, and the objective of the present invention is to provide a patent information analyzing apparatus, a patent information analyzing method, a patent information analyzing program, and a storage medium, by which the scope of a patent claim (or utility model claim) of a patent (or utility model) pertaining to an invention can be objectively analyzed.

To achieve the objective above, a patent information analyzing apparatus of the present invention, analyzing at least one set of patent specification data including at least one claim, includes: non-invention-specifying character deletion means for deleting, from said at least one claim, at least one formal character string which does not directly specify an invention recited in said at least one claim; and invention-specifying character counting means for counting the number of characters in said at least one claim from which said at least one formal character string has been deleted.

According to the arrangement above, the apparatus deletes, from a claim in a set of patent specification data, at least one formal character string not directly specifying the invention recited in the claim.

As formal character strings in Japanese patent specifications, the apparatus deletes symbols such as “pause mark ( [symbol] )”, “full stop ( [symbol] )”, “comma (,)”, “semicolon (;)”, “colon (:)”, and “space”, reference terms referring to a preceding word or a subsequent word, such as “ [symbol] ”, “ [symbol] ”, “ [symbol] ”, “ [symbol] ”, “ [symbol] ”, and “ [symbol] ”, and formal character strings which are used for formal reasons in claims and do not specify an invention, such as “ [symbol] [symbol] ”, “ [symbol] [symbol] ”, and “ [symbol] [symbol] ”.

Furthermore, after deleting at least one of these character strings, the apparatus counts the number of characters in the claim. This allows the apparatus to precisely count the number of characters pertaining to invention specifying features.

The way of writing claims in patent specifications is typically different between applicants. For example, while there are claims including many “pause mark ( [symbol] )” or “ [symbol] ”, there are claims in which the numbers of these terms are small. The apparatus makes it possible to reduce influences of formal character strings, when the number of characters in a claim is counted.

Typically, the scope of right of a patent claim is proportional to the number of characters in the claim. For example, comparing a claim made up of 40 characters and a claim made up of 100 characters, it is considered that the scope of right of the former claim is broader than the scope of right of the latter claim. In other words, the scope of right indicated by a claim is determined by the words (characters) in the claim. On this account, the number of limiting words is proportional to the number of limitations, and hence the scope of right is narrow. On the other hand, the scope of right is typically broad if the number of unnecessary limitations is small. As such, if the number of characters is small as a result of counting the number of characters constituting a claim, the scope of right is likely to be broad. On the other hand, if the number of characters is large, the scope of right is likely to be narrow.

Because of the above, the apparatus can precisely and objectively analyze the scope of right of a patent claim pertaining to an invention recited in a claim of a Japanese specification.

To achieve the objective above, a patent information analyzing method of the present invention, for analyzing at least one set of patent specification data, which is used for a patent information analyzing apparatus processing said at least one set of patent specification data including at least one claim, includes the steps of: (i) deleting, from said at least one claim, at least one formal character string which does not directly specify an invention recited in said at least one claim; and (ii) counting the number of characters in said at least one claim from which said at least one formal character string has been deleted.

According to the method above, the effects equivalent to the patent information analyzing apparatus of the present invention can be exerted.

To achieve the objective above, a patent information analyzing apparatus of the present invention, analyzing at least one set of patent specification data including at least one claim, includes: invention constituent feature extraction means for comparing at least one character string in said at least one claim with predetermined at least one invention constituent feature searching character string so as to extract, from the patent specification data, said at least one invention constituent feature in said at least one claim; and invention constituent feature counting means for counting the number of said at least one invention constituent feature extracted by the invention constituent feature extraction means.

According to this account, the apparatus compares at least one character string included in the claim with predetermined at least one invention constituent feature searching character string so as to extract, from the patent specification data, said at least one invention constituent feature and counts the number of the invention constituent feature. It has been known that the scope of a patent claim is narrowed as the number of invention constituent features in a claim increases. For example, comparing a claim with two constituent features A and B, such as (5) “A [symbol] B [symbol] [symbol] ” with a claim with four constituent features A to D, such as (6) “A [symbol] B [symbol] C [symbol] D [symbol] [symbol] ”, it is concluded that the scope of right of the claim (5) having fewer constituent features is clearly broad, whereas the scope of right of the claim (6) is narrower than that of the claim (5).

The apparatus can therefore objectively analyze the scope of a patent claim pertaining to a claim which is the target of analysis, by counting the number of invention constituent features in the claim.

To achieve the objective above, a patent information analyzing method, for analyzing at least one set of patent specification data, which is used for a patent information analyzing apparatus processing said at least one set of patent specification data including at least one claim, includes the steps of: (i) comparing at least one character string in said at least one claim with predetermined at least one invention constituent feature searching character string so as to extract, from said at least one set of patent specification data, at least one invention constituent feature in said at least one claim; and (ii) counting the number of said at least one invention constituent feature extracted in the step (i).

According to the method above, the effects equivalent to the patent information analyzing apparatus of the present invention can be exerted.

To achieve the objective above, a patent information analyzing apparatus, analyzing at least one set of patent specification data including at least one claim, includes generic term extraction means for extracting at least one generic term from said at least one claim of said at least one set of patent specification data.

According to the arrangement above, the apparatus can analyze the scope of right indicated by a claim by extracting generic terms from the character strings constituting the claim. That is to say, the scope of right indicated by a claim is determined by the words in the claim. On this account, a claim including a generic term which broadly express an invention tends to have a broad scope of right. On this account, it is possible to analyze whether the scope of a claim is broad, by checking if a generic term is included in character strings constituting an independent claim. For example, if the result of the extraction shows that the term in a claim of a Japanese patent specification is not “spring” or “rubber” but “elastic member” which is a superordinate conception of “spring” and “rubber”, it is considered that the scope of the patent claim is likely to be broad.

In this manner, the apparatus can objectively analyze the scope of a patent claim pertaining to an invention recited in a claim.

To achieve the objective above, a patent information analyzing method, for analyzing at least one set of patent specification data, which is used for a patent information analyzing apparatus processing said at least one set of patent specification data including at least one claim, includes the step of extracting at least one generic term from said at least one claim of said at least one set of patent specification data.

According to the method above, the effects equivalent to the patent information analyzing apparatus of the present invention can be exerted.

To achieve the objective above, a patent information analyzing apparatus, analyzing at least one set of patent specification data including at least one claim, includes word counting means for counting the number of words in said at least one claim by counting at least the number of spaces in said at least one claim.

According to this arrangement, the apparatus can count the number of words each of which is sandwiched by spaces, by counting the number of spaces between words in an independent claim of particularly English claims such as those of U.S. patents. This makes it possible to objectively analyze the scope of right of a claim. That is to say, the scope of right of an English claim is determined by the terms (words) therein. If the number of limiting words is large, there are a large number of limitations and hence the scope of right is likely to be narrow. On the other hand, if the number of unnecessary limitations is small, the scope of right tends to be broad.

For this reason, the apparatus counts the number of spaces (i.e. the number of words) constituting a claim of an U.S. patent specification, and judges that the scope of right is likely to be broad if the number of spaces is small and hence the number of words is small, whereas the scope of right is likely to be narrow if the number of spaces is large and hence the number of words is large.

In this manner, the apparatus can objectively analyze the scope of a patent claim pertaining to an invention recited in a claim.

To achieve the objective above, a patent information analyzing method, for analyzing at least one set of patent specification data, which is used for a patent information analyzing apparatus processing said at least one set of patent specification data including at least one claim, includes the step of counting the number of words in said at least one claim by counting at least the number of spaces in said at least one claim.

According to the method above, the effects equivalent to the patent information analyzing apparatus of the present invention can be exerted.

In addition to the above, the patent information analyzing apparatus of the present invention is preferably arranged such that said at least one claim is an independent claim.

According to the arrangement above, the apparatus analyzes the scope of the invention recited in an independent claim. The number of limitations in the invention pertaining to an independent claim is typically smaller than those recited in the invention pertaining to a dependent claim. The apparatus can therefore analyze a claim reciting an invention having a broader scope of right.

In addition to the above, the patent information analyzing apparatus of the present invention is preferably arranged such that the independent claim is the first claim in claims of said at least one set of patent specification data.

According to the arrangement above, the apparatus analyzes the scope of the invention recited in the first claim of the claims of the set of patent specification data, i.e. the invention recited in claim 1. Claim 1 which is the first claim of claims typically pertains to the most important invention in one patent specification. In other words, in a patent specification, an independent claim may be the most important main claim. The apparatus can therefore analyze the scope of the most important inventions, among inventions recited in a set of patent specification data.

In addition to the above, the patent information analyzing apparatus of the present invention preferably includes invention constituent feature character counting means for counting the number of characters in said at least one invention constituent feature extracted by the invention constituent feature extraction means.

According to the arrangement above, the apparatus counts the number of characters in invention constituent features. The apparatus can therefore objectively analyze the scope of a patent claim, such as the scope of right is narrow if the number of characters is large whereas the scope of right is broad if the number of characters is small.

In addition to the above, the patent information analyzing apparatus of the present invention preferably includes generic term counting means for counting the number of said at least one generic term extracted by the generic term extraction means.

According to this arrangement, the apparatus counts the number of generic terms in the claim. It is typically considered that an invention pertaining to a claim of a patent specification has a broad scope of right, if a large number of generic terms are included. The apparatus can therefore further objectively analyze the scope of a patent claim pertaining to a claim by counting the number of generic terms in the claim.

In addition to the above, the patent information analyzing apparatus of the present invention preferably includes input means for receiving data input from outside, the non-invention-specifying character deletion means deleting, from said at least one claim, said at least one formal character string input through the input means.

According to the arrangement above, since the user can optionally specify non-invention-specifying characters, the apparatus can determine the words to be deleted, in accordance with, for example, the technical field of a patent specification which is the target of analysis, and hence detailed analysis suitable for the situation can be done.

In addition to the above, the patent information analyzing apparatus of the present invention preferably includes third comparative evaluation means for evaluating said at least one set of patent specification data, based on the result of the counting by the invention-specifying character counting means.

According to the arrangement above, patent specification data is evaluated based on the number of characters in a claim from which at least one of non-invention-specifying characters has been deleted. On this account, to analyze plural sets of patent specification data, it is possible to perform a comparison and evaluation of the sets of patent specification data, based on the numbers of characters in the claims. The apparatus can therefore objectively evaluate the sets of patent specification data.

In addition to the above, the patent information analyzing apparatus of the present invention preferably includes third comparative evaluation means for evaluating said at least one set of patent specification data, based on the result of the counting by the invention constituent feature counting means.

According to this arrangement, the apparatus evaluates patent specification data based on the number of invention constituent features in a claim. On this account, to analyze plural sets of patent specification data, it is possible to perform a comparison and evaluation of the sets of patent specification data, based on the numbers of invention constituent features in the claims. The apparatus can therefore objectively evaluate the sets of patent specification data.

In addition to the above, the patent information analyzing apparatus of the present invention preferably includes third comparative evaluation means for evaluating said at least one set of patent specification data, based on the result of the counting by the invention constituent feature character counting means.

According to this arrangement, the apparatus evaluates patent specification data based on the number of characters in invention constituent features in a claim. On this account, to analyze plural sets of patent specification data, it is possible to perform a comparison and evaluation of the sets of patent specification data, based on the numbers of characters in invention constituent features in the claims. The apparatus can therefore objectively evaluate the sets of patent specification data.

In addition to the above, the patent information analyzing apparatus of the present invention preferably includes third comparative evaluation means for evaluating said at least one set of patent specification data, based on the result of the counting by the generic term counting means.

According to this arrangement, the apparatus evaluates patent specification data based on the number of generic terms in a claim. On this account, to analyze plural sets of patent specification data, it is possible to perform a comparison and evaluation of the sets of patent specification data, based on the numbers of generic terms in the claims. The apparatus can therefore objectively evaluate the sets of patent specification data.

In addition to the above, the patent information analyzing apparatus of the present invention preferably includes third comparative evaluation means for evaluating said at least one set of patent specification data, based on the result of the counting by the word counting means.

According to this arrangement, the apparatus evaluates patent specification data based on the number of words in a claim. On this account, to analyze plural sets of patent specification data, it is possible to perform a comparison and evaluation of the sets of patent specification data, based on the numbers of words in the claims. The apparatus can therefore objectively evaluate the sets of patent specification data.

The third comparative evaluation means evaluates the result of the counting of at least one set of patent specification data belonging to a technical field and the result of the counting of at least one set of patent specification data belonging to the same technical field, so as to evaluate these sets of patent specification data.

That is to say, the way of describing claims and the contents of invention specifying features may be greatly different between technical fields. For example, in the technical field of liquid crystal displays, when claims in (7) patents of drive technology (2H093 in F term which is patent classification unique to Japan) and claims in (8) patents of technologies related to substrate, insulating film, and orientation film (2H093 in F term which is patent classification unique to Japan) are compared to one another, the number of characters in the claims of the technology (7) is typically larger because the patents of the technology (7) typically include a larger number of invention specifying features related to circuit configuration, the process of driving, or the like. Although the example above uses the patent classification unique to Japan, when a comparison of the average characters between (7) patents of drive technology and (8) patents of technologies related to substrate, insulating film, and orientation film is performed based on IPC which is international patent classification or US class which is unique to U.S.A, the patents of the technology (7) typically include a larger number of invention specifying features related to circuit configuration, the process of driving, or the like, in a similar manner.

On this account, as compared to a case where patents of the technology (7) are compared with patents of the technology (8), a result of analysis with a high reliability is obtained in an equitable manner, by comparing patent specifications belonging to a specific technical field.

On this account, the apparatus can fairly and objectively analyze plural sets of patent specification data, by evaluating the result of the counting of patent specification data of a technical field and the result of the counting of patent specification data of the same technical field.

In addition to the above, the patent information analyzing apparatus of the present invention is preferably arranged such that the sets of patent specification data belonging to the same technical field are sets of patent specification data to which substantially identical patent classification symbols are assigned.

According to the arrangement above, the apparatus analyzes sets of patent specification data having substantially same patent classification symbols. What are meant by “same patent classification symbol” and “substantially same patent classification symbols” have been described above.

This allows the apparatus to precisely and easily determine to which technical field a set of patent specification data which is the target of analysis belongs.

In addition to the above, the patent information analyzing apparatus of the present invention preferably includes output means for outputting, on an applicant by applicant basis, the results of the comparisons by the third comparative evaluation means to an output device.

According to this arrangement, viewing the display contents on the output device, one can understand at a glance the number of inventions having broad scopes and the number of inventions having narrow scopes of each applicant.

In addition to the above, the patent information analyzing apparatus of the present invention preferably includes ranking means for ranking the results of the counting in the order in which the counted number is larger or smaller.

According to this arrangement, the apparatus ranks the results of the counting in the order in which the counted number is larger or smaller. In this way the apparatus can extract information in regard to the strength of patent right (the scope of a patent claim) from a large number of patent specifications. The user can therefore efficiently sort many sets of patent specification data into necessary ones and unnecessary ones.

For example, the user can check patent specifications in the order corresponding to the importance and ease of exercisability against other companies, by checking the information of patent specifications each having claim 1 with the fewer number of characters. Also, the user can check patent rights in the order corresponding to narrower scopes and difficulty in exercisability against other companies, by checking the information of patent specifications each having claim 1 with the larger number of characters. This allows the user to efficiently take inventory of patent rights which have narrow scopes and are not easily exercisable. In other words, it is possible to efficiently find patent rights which are unnecessary and may be abandoned.

In addition to the above, the patent information analyzing apparatus of the present invention preferably includes second invention type judging means for judging the type of an invention recited in said at least one claim, by comparing at least one character string in said at least one claim with predetermined at least one character string indicating the types of an invention.

According to the arrangement above, the apparatus can delete, for example, invention feature non-specifying characters from the claim data which is judged to pertain to a product invention. On this account, the apparatus can analyze a claim of a patent specification having a broader scope of a patent claim, and hence patent specification data can be analyzed in a more detailed manner.

In addition to the above, the patent information analyzing apparatus of the present invention preferably includes second numerical limitation invention judging means for judging whether an invention recited in said at least one claim is a numerical limitation invention, by comparing at least one character string in said at least one claim with predetermined at least one character string indicating a numerical limitation.

According to the arrangement above, the apparatus can delete, for example, invention feature non-specifying characters from the claim data which is judged to pertain to an invention not including a numerical limitation. On this account, the apparatus can analyze a claim of a patent specification having a broader scope of a patent claim, and hence patent specification data can be analyzed in a more detailed manner.

The patent information analyzing apparatus may be realized by a computer. In such case, the scope of the present invention encompasses a patent information analyzing program which realizes the patent information analyzing apparatus by a computer by causing the computer to operate as the aforesaid means, and a computer-readable storage medium storing the patent information analyzing program.

As described above, the patent information analyzing apparatus of the present invention makes it possible to objectively analyze the scope of a patent claim pertaining to an invention recited in a claim of patent specification data.

### BRIEF DESCRIPTION OF DRAWINGS

FIG. 1 is a block diagram showing a patent information analyzing apparatus of an embodiment of the present invention.

FIG. 2 includes a flowchart and other figures showing how the patent information analyzing apparatus of FIG. 1 operates.

FIG. 3 includes a flowchart and other figures showing how the patent information analyzing apparatus of FIG. 1 operates.

FIG. 4(a) shows an example of a screen displayed by the patent information analyzing apparatus of FIG. 1.

FIG. 4(b) shows an example of a screen displayed by the patent information analyzing apparatus of FIG. 1.

FIG. 5 is a block diagram showing a patent information analyzing apparatus of another embodiment of the present invention.

FIG. 6 includes a flowchart and other figures showing how the patent information analyzing apparatus of FIG. 5 operates.

FIG. 7 includes a flowchart and other figures showing how the patent information analyzing apparatus of FIG. 5 operates.

FIG. 8(a) shows an example of a screen displayed by the patent information analyzing apparatus of FIG. 5.

FIG. 8(b) shows an example of a screen displayed by the patent information analyzing apparatus of FIG. 5.

FIG. 9 includes a flowchart and other figures showing how the patent information analyzing apparatus of FIG. 5 operates.

FIG. 10(a) shows an example of a screen displayed by the patent information analyzing apparatus of FIG. 5.

FIG. 10(b) shows an example of a screen displayed by the patent information analyzing apparatus of FIG. 5.

FIG. 11 is a block diagram showing a patent information analyzing apparatus of a further embodiment of the present invention.

FIG. 12 includes a flowchart and other figures showing how the patent information analyzing apparatus of FIG. 11 operates.

FIG. 13 includes a flowchart and other figures showing how the patent information analyzing apparatus of FIG. 11 operates.

FIG. 14 shows an example of a screen displayed by the patent information analyzing apparatus of FIG. 11.

FIG. 15 is a block diagram showing a patent information analyzing apparatus of Fourth Embodiment of the present invention.

FIG. 16 illustrates how the patent information analyzing apparatus of Fourth Embodiment operates. FIG. 16(a) is a flowchart showing the operation of the patent information analyzing apparatus, whereas FIG. 16(b) shows examples of text data processed by the patent information analyzing apparatus and a result of analysis to be output.

FIG. 17 illustrates how the patent information analyzing apparatus of Fourth Embodiment operates. FIG. 17(a) is a flowchart showing the operation of the patent information analyzing apparatus, whereas FIG. 17(b) shows examples of text data processed by the patent information analyzing apparatus and a result of analysis to be output.

FIG. 18 is a block diagram showing a patent information analyzing apparatus of Fifth Embodiment of the present invention.

FIG. 19 illustrates how the patent information analyzing apparatus of Fifth Embodiment operates. FIG. 19(a) is a flowchart showing the operation of the patent information analyzing apparatus, whereas FIG. 19(b) shows examples of text data processed by the patent information analyzing apparatus and a result of analysis to be output.

FIG. 20 illustrates how the patent information analyzing apparatus of Fifth Embodiment operates. FIG. 20(a) is a flowchart showing the operation of the patent information analyzing apparatus, whereas FIG. 20(b) shows examples of text data processed by the patent information analyzing apparatus and a result of analysis to be output.

FIG. 21 is a block diagram showing a patent information analyzing apparatus of Sixth Embodiment of the present invention.

FIG. 22 is a block diagram showing a patent information analyzing apparatus of Seventh Embodiment of the present invention.

FIG. 23 illustrates how the patent information analyzing apparatus of Seventh Embodiment operates. FIG. 23(a) is a flowchart showing the operation of the patent information analyzing apparatus, whereas FIG. 23(b) shows examples of text data processed by the patent information analyzing apparatus and a result of analysis to be output.

FIG. 24 is a block diagram showing a patent information analyzing apparatus of Eighth Embodiment of the present invention.

FIG. 25 illustrates how the patent information analyzing apparatus of Eighth Embodiment operates. FIG. 25(a) is a flowchart showing the operation of the patent information analyzing apparatus, whereas FIG. 25(b) shows examples of text data processed by the patent information analyzing apparatus and a result of analysis to be output.

FIG. 26 illustrates how the patent information analyzing apparatus of Eighth Embodiment operates. FIG. 26(a) is a flowchart showing the operation of the patent information analyzing apparatus, whereas FIG. 26(b) shows examples of text data processed by the patent information analyzing apparatus and a result of analysis to be output.

FIG. 27 is a block diagram showing a patent information analyzing apparatus of Ninth Embodiment of the present invention.

FIG. 28 illustrates how the patent information analyzing apparatus of Ninth Embodiment operates. FIG. 28(a) is a flowchart showing the operation of the patent information analyzing apparatus, whereas FIG. 28(b) shows examples of text data processed by the patent information analyzing apparatus and a result of analysis to be output.

FIG. 29 is a block diagram showing a patent information analyzing apparatus of Tenth Embodiment of the present invention.

FIG. 30 is a block diagram showing a patent information analyzing apparatus of Tenth Embodiment of the present invention.

FIG. 31 is a block diagram showing a patent information analyzing apparatus of Tenth Embodiment of the present invention.

FIG. 32 is a block diagram showing a patent information analyzing apparatus of Tenth Embodiment of the present invention.

FIG. 33 is a block diagram showing a patent information analyzing apparatus of Eleventh Embodiment of the present invention.

FIG. 34 illustrates how the patent information analyzing apparatus of Eleventh Embodiment operates.

FIG. 35 illustrates how the patent information analyzing apparatus of Eleventh Embodiment operates.

FIG. 36 is a block diagram showing a patent information analyzing apparatus of Twelfth Embodiment of the present invention.

FIG. 37 illustrates how the patent information analyzing apparatus of Twelfth Embodiment operates. FIG. 37(a) is a flowchart showing the operation of the patent information analyzing apparatus, whereas FIG. 37(b) shows examples of text data processed by the patent information analyzing apparatus and a result of analysis to be output.

FIG. 38 shows another type of text data analyzed by the patent information analyzing apparatus of Twelfth Embodiment.

FIG. 39 illustrates how the patent information analyzing apparatus of Twelfth Embodiment operates.

FIG. 40 illustrates how the patent information analyzing apparatus of Thirteenth Embodiment operates.

FIG. 40(a) is a flowchart showing the operation of the patent information analyzing apparatus, whereas FIG. 40(b) shows examples of text data processed by the patent information analyzing apparatus and a result of analysis to be output.

FIG. 41 illustrates how a patent information analyzing apparatus of Fourteenth Embodiment operates.

FIG. 42 illustrates how a patent information analyzing apparatus of Fifteenth Embodiment operates.

### BEST MODE FOR CARRYING OUT THE INVENTION

The following will describe embodiments of the present invention with reference to figures.

A patent specification often include plural claims, and claim 1 which is the first claim of the claims is typically related to the most important invention. In other words, claim 1 of a patent specification may be the most important claim, i.e. main claim. It is therefore assumed hereinafter that a patent information analyzing apparatus of each embodiment analyzes only claim 1 which is the main claim.

### First Embodiment

### Apparatus Configuration

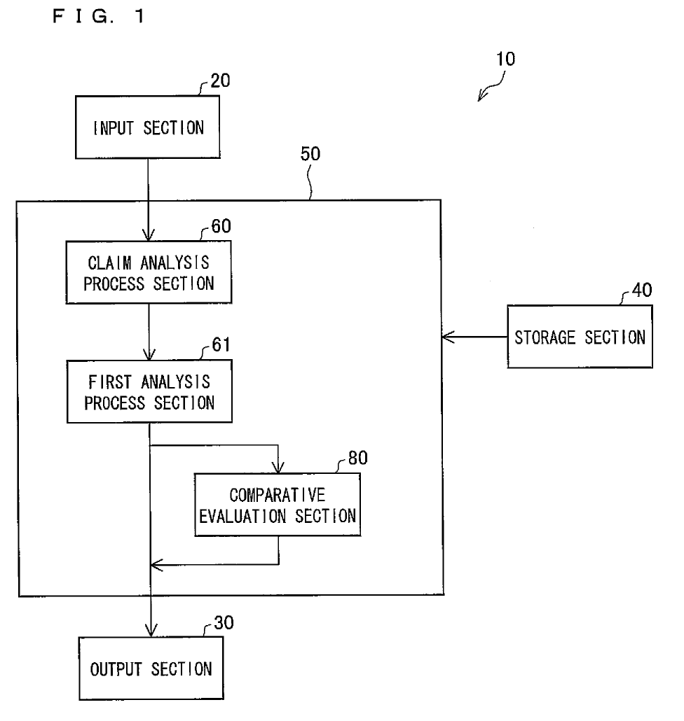

As an embodiment of the present invention, the following will describe, with reference to FIGS. 1-4, a patent information analyzing apparatus and a patent information analyzing method, by which the right acquisition capabilities of an applicant at the time of filing or registration are analyzed.

FIG. 1 is a block diagram showing the patent information analyzing apparatus 1 of the present embodiment. As shown in the figure, the patent information analyzing apparatus 10 includes an input section 20, a data processing section 50, an output section (output means) 30, and a storage section 40.

The input section 20 functions as an input interface and is constituted by a keyboard or the like.

The data processing section 50 performs various data processes. More specifically, the data processing section 50 includes a claim analysis process section (claim analysis means) 60, a first analysis process section (first analysis process means) 61, and a comparative evaluation section (first comparative evaluation means) 80. Functions of these blocks constituting the data processing section 50 will be discussed later.

The output section 30 outputs a result of data processing by the data processing section 50 to an output device. The output device is constituted by a monitor, a printer, or the like.

The storage section 40 stores in advance various types of patent specification data, as text data or the like. For example, as patent specification data, the storage section 40 stores data of an unexamined patent publication issued by the patent office. In addition to this, a registered patent publication and a registered utility model publication may be stored. Alternatively, patent specification data that one's company has make use of may be stored. The storage section 40 may be a CD-ROM, DVD-ROM, or a hard disc, which stores such types of data.

The following will specifically describe functions of the blocks constituting the data processing section 50.

The claim analysis process section 60 expresses the technical scope of an invention recited in the claim (hereinafter, scope of the right) by numerical characters. To be more specific, the claim analysis process section 60 counts the number of characters of claim 1 which is an independent claim in claims so as to express the scope of the right by numerical characters.

The first analysis process section 61 add up the number of claims whose scopes of right are expressed by numerical characters by the claim analysis process section 60 and calculates the average of the values indicating the scopes of the right numerically expressed by the claim analysis process section 60.

The comparative evaluation section 80 compares sets of patent specification data of applications belonging to the same technical field with one another.

Now, how the patent information analyzing apparatus shown in FIG. 1 operates will be explained.

First, through the input section 20, the number (e.g. application number, publication number, registration number, or the like) for specifying the case to be analyzed is input. Based on the number input through the input section 20, the data processing section 50 reads out, from the storage section 40, the patent specification data of the case to be analyzed.

Then the claim analysis process section 60 counts the number of characters or words in the text data of claim 1 which is an independent claim included in the patent specification data read out by the data processing section 50. In case of Japanese, one full-width character is represented by 2 bytes if the patent specification data is shift-JIS text data. The number of characters is therefore counted by counting the bytes of the target data. In case of English, one character is represented by one byte and hence the number of characters is counted by counting the bytes of the target data. Alternatively, the number of words can be almost accurately assumed by counting the number of spaces, periods, commas, colons, and semicolons.

Then the first analysis process section 61 adds up the number of the sets of patent specification data which are input through the input section 20, and calculates the average of the numbers of characters counted by the claim analysis process section 60.

The result of the process performed by the first analysis process section 61 is supplied from the output section 30 to an output device, and is displayed on a monitor or printed by a printer, for example.

In case of a relative comparison between the scopes of the patent rights recited in claims of plural sets of patent specification data, the comparative evaluation section 80 compares plural sets of patent specification data belonging to a particular technical field. To achieve such a relative comparison, plural sets of patent specification data are input in advance by inputting the patent numbers of the sets of patent specification data or specifying the IPC of the section or sub-group, through the input section 20. With reference to the sets of patent specification data, the claim analysis process section 60 counts the numbers of characters in claims in advance.

Thereafter, the comparative evaluation section 80 extracts plural sets of patent specification data in the same technical field, based on a patent class symbol such as IPC, FI, F term or the like, which is specified by the user. Furthermore, the comparative evaluation section 80 calculates the average of the numbers of characters in claims of the respective sets of patent specification data thus extracted. This makes it possible to assess the numbers of characters in claims of the inventions filed by applicants for the same industry.

The comparative evaluation section 80 performs a relative comparison between the average number of characters in claims in the industry with the numbers of characters in patents owned by one's company or of another company, so as to carry out relative evaluation of, for example, the comprehensive capabilities in patent matters of the companies. The comparative evaluation section 80 outputs the result of the comparative evaluation to the output section 30.

<2. Operation Flow>

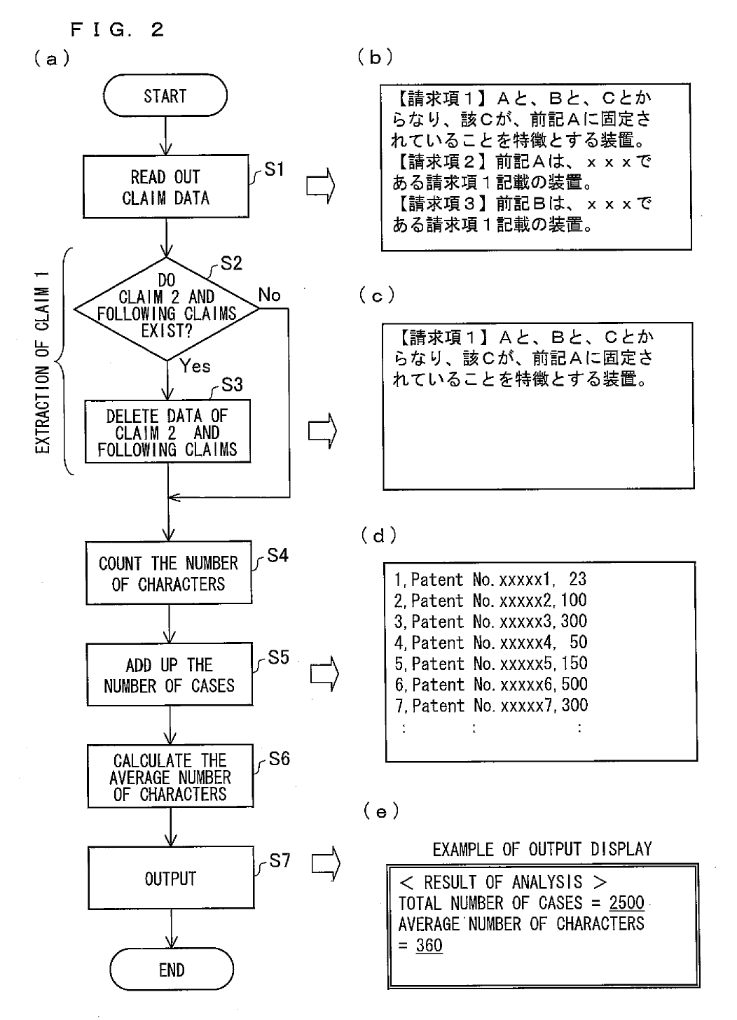

The following will specifically explain how the data processing section 50 operates, with reference to FIG. 2. The (a) part of FIG. 2 is a flowchart of counting of the number of characters by the data processing section 50 and of various processes. The (b)-(d) parts of FIG. 2 indicate data structures stored in a work memory (which is not illustrated and provided in the data processing section 50). The (e) part of FIG. 2 shows an example of a display screen on the output device, based on an output from the output section 30.

First, as shown in the (a) part of FIG. 2, when a patent number or the like, which is the target of analysis, is input through the input section 20, the data processing section 50 reads out, from the storage section 40, the claim of the patent specification data of the target patent with reference to the patent number or the like, as Japanese text data. The data processing section 50 then stores the data in the work memory (not illustrated) in the data processing section 50 (S1). An example of the data structure stored in the work memory is shown in the (b) part of FIG. 2.

Then the claim analysis process section 60 searches for the work memory to check whether claim 2 and later claims exist in the data stored in the work memory, in order to extracts, from the data in the work memory, only character strings related to claim 1 (S2).

The search in S2 may be achieved by checking whether a character string “[ [symbol] 2] ”, which indicates the existence of claim 2, is included in the data in the work memory.

It is noted that the character “[” indicates [ [symbol] 1].

Also, the character “]” indicates [ [symbol] 2].

If the character string “[ [symbol] 2]” is found as a result of the search, the claim analysis process section 60 delete the character string “[ [symbol] 2]” and all character strings following the character string “[ [symbol] 2]” (S3). As a result, only a character string related to claim 1 is extracted. After the step S3, stored in the work memory is, for example, data with the structure shown in the (c) part of FIG. 2.

To find out a character string from text data, a character string which is the target of search is stored in a memory (not illustrated) for searching target characters in advance, and character strings stored in the work memory are searched for the target character string, by using a character search technique such as pattern matching.

After S3, the claim analysis process section 60 counts the number of characters in the data stored in the work memory (S4).

For example, in case where the data in the work memory is Japanese text data with JIS code, the number of characters can be counted by checking an amount of the target data, because one width character is made up of 2 bytes. In other words, when the amount of the target data is 200 bytes, it is determined that the number of characters in the data is 100.

After S4, the first analysis process section 61 tabulates the number of sets of patent specification data whose numbers of characters have been counted by the claim analysis process section 60, the patent numbers, the number of characters in claims, or the like (S5). The result of the tabulation is stored in the work memory, with the data structure shown in the (d) part of FIG. 2.

In the data structure shown in the (d) part of FIG. 2, results of data processing for a set of patent specification data by the data processing section 50 are stored in the order of the serial number, the patent number, and the number of characters in claim 1 (supplied from the claim analysis process section 60), and these items are separated by commas. Also, an item for a specific set of patent specification data and items of other sets of patent specification data are separated by a line feed character.

After S5, the first analysis process section 61 calculates the average of characters in claims 1 of sets of patent specification data stored in the work memory (S6).

Then the output section 30 outputs the total number and the average number of characters of the patent specification data, which are the result of the analysis by the first analysis process section 61 (S7). The (e) part of FIG. 2 shows an example of a display screen on the output device, which is generated based on the output from the output section 30.

As a result of S1-S7 above, the data processing section 50 counts the number of characters in claim 1 of each set of patent specification data, and the results of the counting are output by the output section 30.

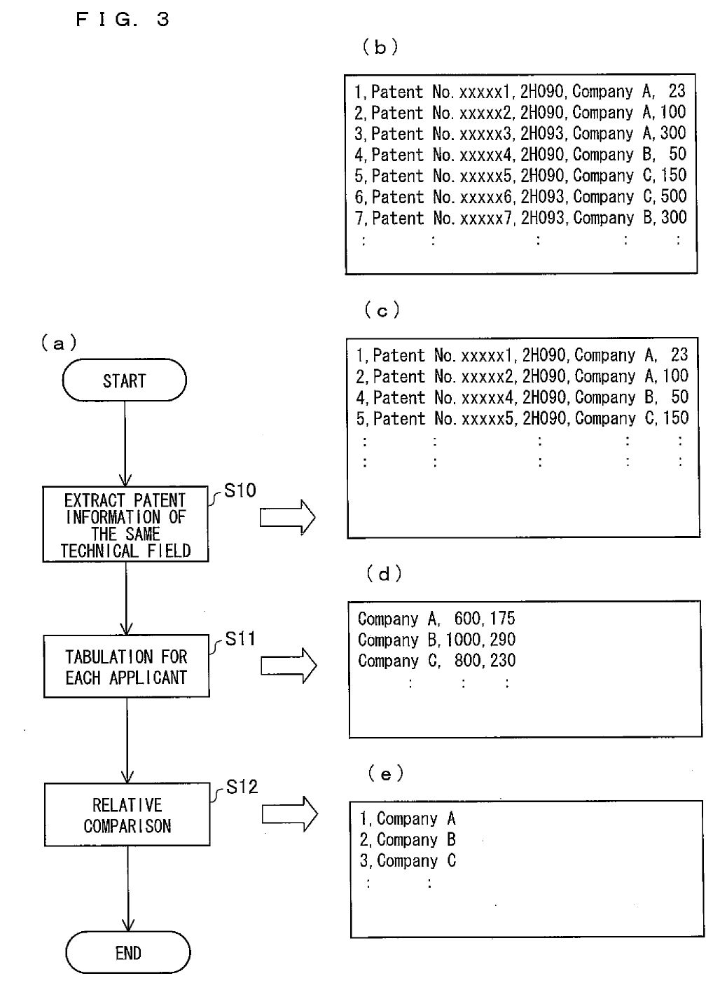

Referring to FIG. 3, the following explains a flow at the time of a relative comparison between the scopes of patent rights recited in claims of sets of patent specification data.

The (a) part of FIG. 3 is a flowchart showing how a relative comparison between the scopes of patent rights recited in claims of sets of patent specification data is carried out by the comparative evaluation section 80. The (b)-(e) parts of FIG. 3 show examples of data structures in a work memory (which is provided in the data processing section 50 and is not illustrated).

To perform a relative comparison between plural sets of patent specification data, data shown in the (b) part of FIG. 3 is prepared in the work memory, first of all.

That is, according to the data structure shown in the (b) part of FIG. 3, items for a set of patent specification data are provided in the order of the serial number, the patent number, F term, the applicant name, and the number of characters in claim 1, and the items are separated by commas. These sets of data are stored in the work memory. An item for a particular set of the patent specification data and items for other types of patent specification data are separated by a line feed character.

These items are arranged to be storable in such a manner that plural sets of patent specification data are input in advance by inputting patent numbers thereof, specifying a particular technical field with reference to IPC or the like, through the input section 20, and the number of characters in the claim of each set of patent specification data is counted by the claim analysis process section 60.

First, the comparative evaluation section 80 extracts, from the data shown in the (b) part of FIG. 3, only sets of patent specification data belonging to a specific technical field (F term: 2H090 in this embodiment) which has been specified in advance, and stores the extracted data in the work memory (S10). As a result of this, the work memory stores, for example, data with the structure shown in the (c) part of FIG. 3.

The comparative evaluation section 80 figures out the total number of sets of patent specification data and the average of the number of characters of the sets of patent specification data of each applicant, in order to perform a relative comparison between the numbers of patents and the numbers of characters in claims of applicants (S11). In doing so, as shown in the (d) part of FIG. 3, the work memory stores applicant names, the total numbers of cases, and the average numbers of characters in each claim 1 in this order, and these items are separated by commas.

Then the comparative evaluation section 80 perform a relative comparison between the numbers of characters in claims 1 and the total numbers of cases, on an applicant by applicant basis (S12). In other words, the comparative evaluation section 80 performs the relative comparison such that an applicant whose numbers of characters in claims 1 are small and the total number of cases is large ranks high. In the present embodiment, the comparative evaluation section 80 ranks the company A whose average number of characters is the smallest as the highest, the company C as the second highest, and the company B as the third highest. After the relative comparison in S12, the items in the work memory are provided in the order of ranks and applicant names and are separated by commas.

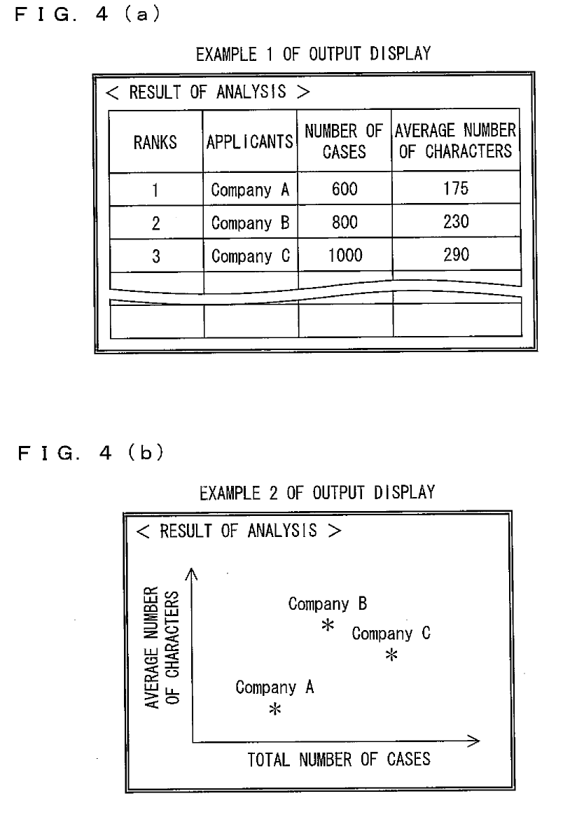

When the data shown in the (d) part of FIG. 3 is sent from the output section 30 to the output device, a table in which the ranks, applicants, the numbers of cases, and average number of characters are arranged to correlate with one another may be displayed as shown in FIG. 4(a).

Alternatively, a graph shown in FIG. 4(b) may be displayed. In this graph, the horizontal axis indicates the total numbers of cases whereas the vertical axis indicates the average numbers of characters in claims, and values of respective applicants are plotted. Displaying such a graph makes it possible to promptly understand the total number of patents owned by each applicant and the average number of characters in claim.

In the explanation above, sets of patent specification data owned by each applicants are added up. Alternatively, sets of patent specification data may be added up for each attorney of a patent application, and average numbers of characters of respective attorneys may be displayed. This makes it possible to judge the right acquisition capabilities of each attorney.

<3. Summary>

As described above, for plural sets of patent specification data, the patent information analyzing apparatus 1 of the present embodiment can objectively analyze the right acquisition capabilities of each applicant by representing the scopes of patent rights recited in claims by numerical values and calculating the average of the numerical values, and further figuring out the total number of sets of patent specification data.

Furthermore, on an applicant by applicant basis, a relative comparison between the average values of the scopes of rights calculated from sets of patent specification data and the total numbers of sets of patent specification data is performed. It is therefore possible to not only compare the numbers of applications of companies but also grasp the scopes of inventions recited in applications of each applicant

Even if an applicant has filed a large number of applications, it is considered that the right acquisition capabilities of that applicant are not always high, if the scopes of rights of the applications are narrow. On the other hand, if an applicant owns many applications having broad scopes of rights even though the total number of applications of that applicant is small, it is considered that the right acquisition capabilities of that applicant are high. As such, the right acquisition capabilities are preferably determined by comprehensively examining the number of applications and the scopes of rights.

The patent information analyzing apparatus 1 of the present embodiment makes it possible to judge how many patents having broad scopes of rights are owned by each applicant. It is therefore possible to objectively analyze the right acquisition capabilities of each applicant.

The patent information analyzing apparatus 1 of the present embodiment carries out the analysis by obtaining patent specification data from the database of registered patents. On this account, it is possible to analyze, as right acquisition capabilities, the applicant's ability to draft a specification and ability to respond to office actions. That is to say, if an applicant has many patents which have broad scopes of rights after being registered, it is considered that the applicant is highly capable of drafting specifications. It is also considered that the applicant has a good ability to respond to office actions, because claims are registered without being unnecessarily limited in the course of responses to office actions.

Furthermore, by obtaining patent specification data from the database of unexamined publications, it is possible to analyze, as the right acquisition capabilities, the ability to draft a specification, at the time of application.

The method of representing the scope of right by a numerical value is not limited to the method by which the number of characters in a claim is counted. The number of words in a claim may be counted instead of characters.

Alternatively, the scope of right may be represented by a numerical value in such a manner that the number of constituent features of independent claims is counted.

That is to say, claims listed in “Type of Claims” of the table 1 below are arranged such that constituent features are separated by a character string such as “ [symbol] ”. In case of such claims, the number of constituent features can be calculated by the following “method”.

TABLE 1

| | (Typical) Structures |
|---|---|
| Type of Claims | of Claims |
| Feature-enumerating claims | A [symbol] B [symbol] C [symbol] |
| | ( [symbol] )X_{°} |
| Jepson claims (preamble + | A [symbol] B [symbol] C [symbol] |
| characterizing portion) | X [symbol] ( [symbol] ), |
| | A [symbol] Ya, B [symbol] Yb [symbol] |
| | [symbol] [symbol] X_{°} |
| Feature-enumeration + explanation | A [symbol] B [symbol] C [symbol] |
| of relations among features | A [symbol] B [symbol] Zab |
| | [symbol] |
| | B [symbol] C [symbol] Zbc |
| | [symbol] |
| | C [symbol] A [symbol] Zca |
| | [symbol] X_{°} |

“Method”: The following character strings (1)-(3) are searched in claims and the number thereof is counted.

Character string (1): particle “ [symbol] ”+pause mark “ [symbol] ”, i.e. “ [symbol] ”

Character string (2): “ [symbol] ”

Character string (3): “ [symbol] ”

Although the patent information analyzing apparatus in this case analyzes only claim 1, all claims may be analyzed. In doing so, the target of analysis is preferably an invention recited in an independent claim. Typically the number of constituent features recited in independent claims is smaller than those recited in dependent claims. Therefore an invention recited in an independent claim is preferably chosen as the target of analysis.

To distinguish an independent claim from a dependent claim, for example, character strings constituting a claim are checked. That is to say, a dependent claim includes a recitation indicating reference to another claim such as “ [symbol] [symbol] 1 [symbol] 3 [symbol] ” and always includes the character string “ [symbol] ”. On the other hand, since an independent claim does not refer to another claim, the independent claim does not include the character string “ [symbol] ”. It is therefore possible to distinguish an independent claim from a dependent claim by checking whether the claim includes the character string “ [symbol] ”.

### Second Embodiment

A patent information analyzing apparatus of the present embodiment analyzes only claim 1 which is a main claim.

<Apparatus Configuration>

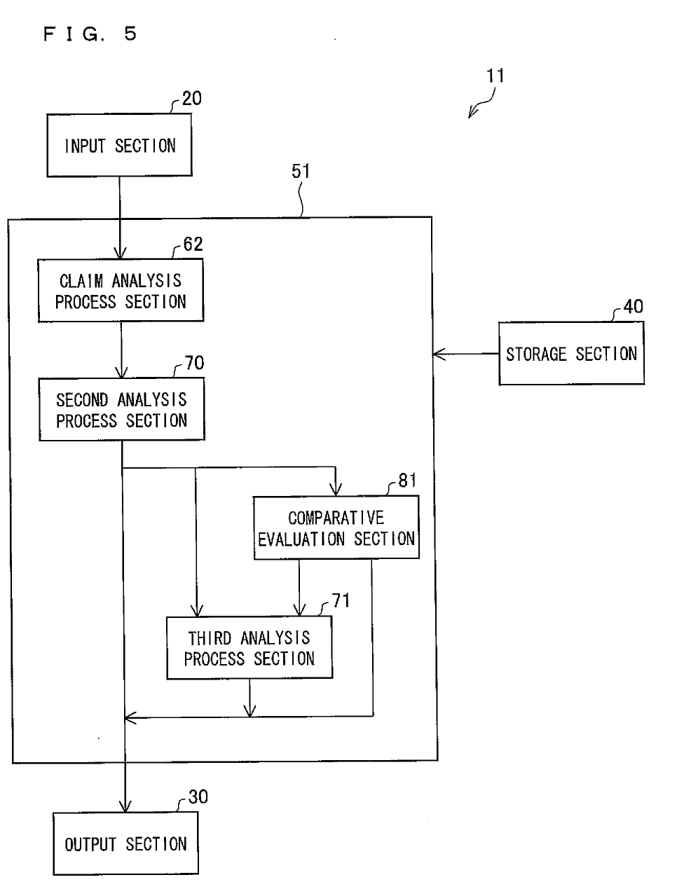

As another embodiment of the present invention, the following will explain a patent information analyzing apparatus and a patent information analyzing method by which the right acquisition capabilities of an applicant through responses to office actions and until registration, with reference to FIGS. 5-10. It is noted that members having the same functions as those described in First Embodiment are given the same numbers, so that the descriptions are omitted for the sake of convenience.

As shown in FIG. 5, the patent information analyzing apparatus 11 of the present embodiment includes an input section 20, a data processing section 51, an output section 30, and a storage section 40.

The data processing section 51 performs various data processes, and includes a claim analysis process section (claim analysis means) 62, a second analysis process section (second analysis process means) 70, a comparative evaluation section (first comparative evaluation means) 81, and a third analysis process section (third analysis process means) 71.

The claim analysis process section 62 represents the scope of an invention recited in a claim by a numerical value. In the present embodiment, the scope of right is represented by a numerical value by counting the number of characters constituting claim 1 which is an independent claim among claims.

The second analysis process section 70 performs a comparison between numerical values regarding plural sets of patent specification data belonging to the same application, which values have been calculated by the claim analysis process section 62.

The comparative evaluation section 81 performs a relative comparison between the scopes of rights recited in claims of plural sets of patent specification data.

The third analysis process section 71 analyzes the result of the comparison by the second analysis process section 70 or the comparative evaluation section 81, with reference to the data of a patent registration success rate of each applicant.

The following will describe how the above-described patent information analyzing apparatus 11 operates.

First, an application number or the like, which is the target of analysis, is input through the input section 20. Based on the application number or the like thus input, the data processing section 51 reads out, from the storage section 40, text data of an unexamined publication and a publication of registered patent corresponding to the patent specification data of the target patent.

Furthermore, the claim analysis process section 62 counts the number of characters in the text data of claim 1 which is an independent claim included in each of the unexamined publication and the publication of registered patent.

Subsequently, the second analysis process section 70 performs a comparison between the numbers of the characters of the unexamined publications and the publications of registered patents, which have been counted by the claim analysis process section 62, and calculates the difference therebetween. The difference is output by the output section 30 to the output device, in the form of display on the monitor, printout, or the like.

To perform a relative comparison between the scopes of rights indicated in claims of sets of patent specification data, the comparative evaluation section 81 compares sets of patent specification data belonging to a specific technical fields with one another.

In the third analysis process section 71, the result of the comparison by the second analysis process section 70 or the comparative evaluation section 81 is analyzed with reference to the data of patent registration success rate. The result of the analysis is output to the output section 30 (details will be given below).

<2. Operation Flow>

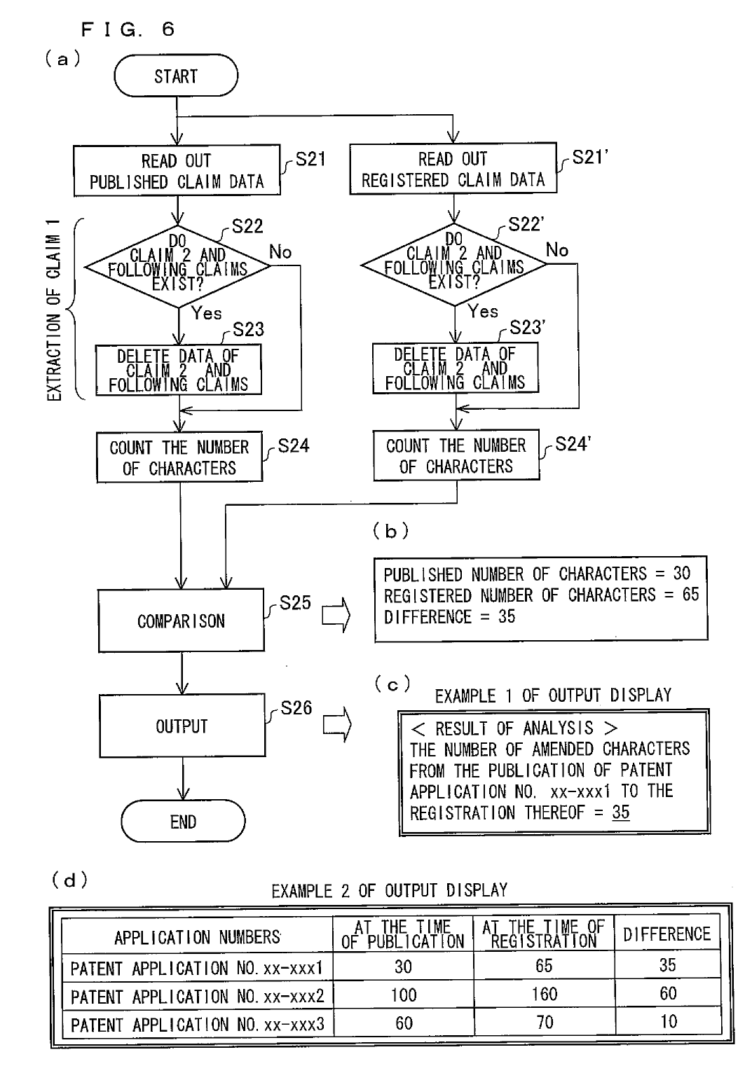

The following will describe how the data processing section 51 operates, with reference to FIG. 6. The (a) part of FIG. 6 is a flowchart showing a case where the number of characters in a claim is counted and various processes are carried out in the data processing section 51. The (b) part of FIG. 6 shows the data structure in a work memory (which is provided in the data processing section 51 and is not illustrated). The (c) and (d) parts of FIG. 6 show examples of a display screen of the output device, which is generated based on an output from the output section 30.

First, the data processing section 51 counts the number of characters in claim 1 of an unexamined publication, through the steps S21-S24. The steps S21-S24 are not described here because they are identical with S1-S4 shown in the (a) part of FIG. 2.

Also, the data processing section 51 counts the number of characters in claim 1 of a publication of registered patent, by the steps S21′-S24′. The steps S21′-S24′ are not described here because they are identical with S1-S4 shown in the (a) part of FIG. 2.

After the steps S24 and S24′, the second analysis process section 70 compares the number of characters in claim 1 of the unexamined publication counted in S24 with the number of characters in claim 1 of the publication of registered patent counted in S24′, and figures out a difference therebetween (S25). As shown in the (b) part of FIG. 6, the second analysis process section 70 stores, in the work memory, (i) the published number of characters (the number of characters in claim 1 of the unexamined publication), (ii) the registered number of characters (the number of characters in claim 1 of the publication of registered patent), and (iii) the difference between the published number of characters and the registered number of characters.

Then the output section 30 outputs the result of the comparison in S25 (S26). For example, as shown in the (c) part of FIG. 6, the output section 30 displays, on the monitor, the difference between the published number of characters and the registered number of characters, in association with the application number. In case where the numbers of characters in claims of plural sets of patent specification data are counted, the output section 30 may display, on the output device, a table in which the application numbers, the published numbers of characters, the registered numbers of characters, and the differences, as shown in the (d) part of FIG. 6.

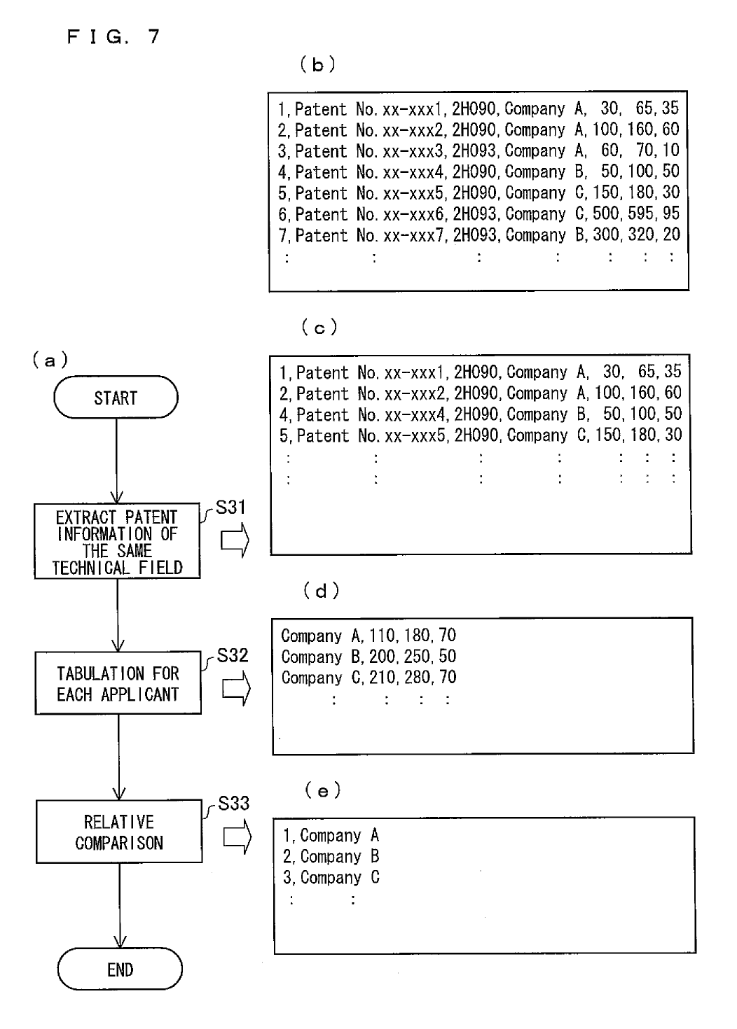

Now, the following will discuss a case where a relative comparison between plural sets of patent specification data is carried out, with reference to FIG. 7.

The (a) part of FIG. 7 is a flowchart showing a case where a relative comparison between plural sets of patent specification data is carried out and analysis is performed by the comparative evaluation section 81. The (b)-(c) parts of FIG. 7 show examples of data structures in a work memory (which is provided in the data processing section 51 and is not illustrated).

For a relative comparison between plural sets of patent specification data, data with the structure shown in the (b) part of FIG. 7 is prepared in the work memory. The data structure shown in the (b) part of FIG. 7 is arranged such that items of a set of patent specification data are stored in the order of the serial number, the patent number, F term, the applicant name, the published number of characters, the registered number of characters, and the difference between the published number of characters and the registered number of characters, and these items are separated by commas. An item for a particular set of the patent specification data and items for other types of patent specification data are separated by a line feed character.

These items are arranged to be storable in such a manner that plural sets of patent specification data are input in advance by inputting application numbers thereof, specifying a particular technical field with reference to IPC or the like, through the input section 20, and the number of characters in the claim of each set of patent specification data is counted by the claim analysis process section 62.

First, the comparative evaluation section 81 extracts, from the data shown in the (b) part of FIG. 7, only sets of patent specification data belonging to a particular technical field (in the present embodiment, F term: 2H090) specified in advance, and stores the extracted data in the work memory (S31). In doing so, the data stored in the work memory has, for example, the structure shown in the (c) part of FIG. 7.

Furthermore, to perform a relative comparison between the published numbers of characters and the registered numbers of characters of patents of applicants, the comparative evaluation section 81 calculates, on an applicant by applicant basis, (i) the average of the published number of characters, (ii) the average of the registered number of characters, and (iii) the difference between the averages (S32). In doing so, as shown in the (d) part of FIG. 7, the work memory stores the applicant names, the average of published numbers of characters, the average of registered numbers of characters, and the difference between averages in this order, and these items are separated by commas.

Furthermore, the comparative evaluation section 81 determines the order of applicants in such a manner that an applicant whose average of registered numbers of characters is small and a difference between published numbers of characters and registered numbers of characters is small ranks high (S33). In the present embodiment, the company A whose average of the registered numbers of characters is the smallest is ranked as the highest, and the companies B and C are ranked as the second highest and the third highest, respectively. As shown in the (e) part of FIG. 7, the items in this case are stored in the work memory in the order of the ranks and the applicant names in this order, and are separated by commas.

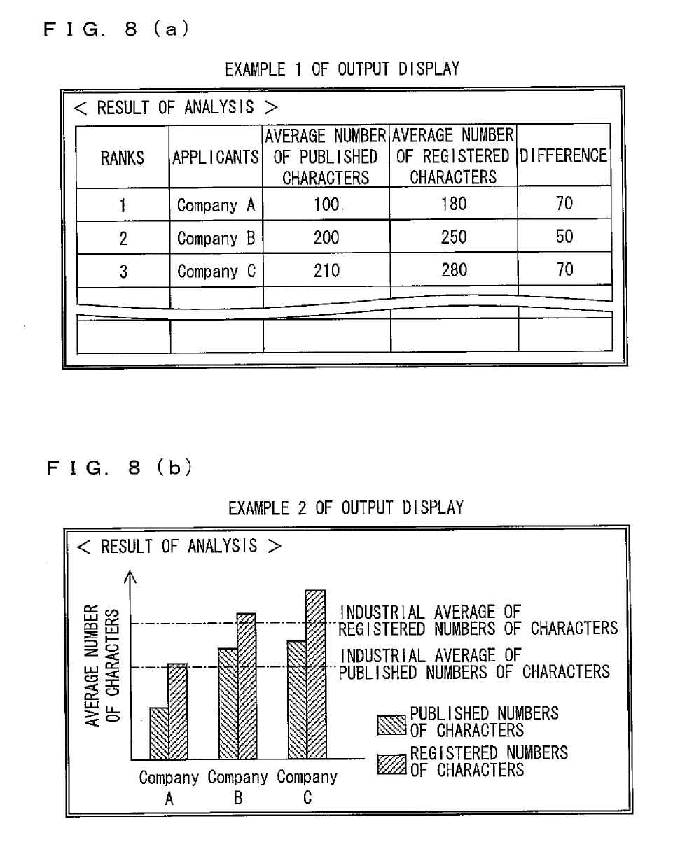

At the time of outputting the data stored as shown in the (e) part of FIG. 7 from the output section 30, as shown in FIG. 8(a), a table may be displayed on the output device. In the table, the ranks, the applicants, the (average) published numbers of characters, the (average) registered number of characters, and the differences between the published numbers of characters and the registered numbers of characters are associated with one another.

Alternatively, a graph shown in FIG. 8(b) may be displayed. In this graph, the horizontal axis indicates the applicants whereas the vertical axis indicates the average numbers of characters in claims, and the average of the published number of characters and the average of the registered number of characters of each applicant are indicated by bars. Since the result of a relative comparison between the applicants is shown by a graph, it is possible to recognize at a glance how the published numbers of characters or registered numbers of characters of each applicant are deviated from the industry average (average number of characters of all applications with the same F term) indicated by a dotted line or a chain line in FIG. 8(b), and hence a relative comparison between the applicants can be easily done. It is noted that the industry average of the published number of characters or registered number of characters can be figured out by, for example, calculating the average of published numbers of characters or registered numbers of characters of plural sets of patent specification data having the same F term. The industry in this embodiment is a technical field of liquid crystal displays, because patent specification data with the F term 2H090 is analyzed.

In the explanation above, the difference between the published number of characters and the registered number of characters is calculated on an applicant by applicant basis. Alternatively, the difference may be calculated for each attorney of patent applications. In this case, the displays shown in FIG. 8(a) and FIG. 8(b) may be drawn not on an applicant by applicant basis but on an attorney by attorney basis. This makes it possible to judge the right acquisition capabilities of each attorney.

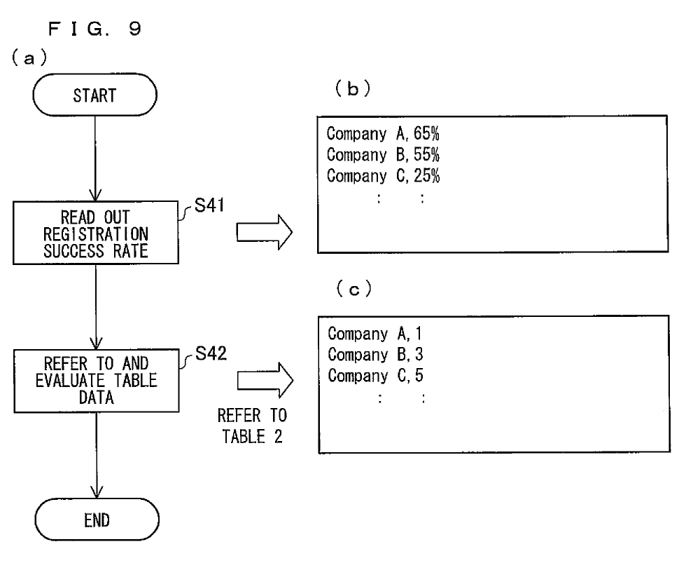

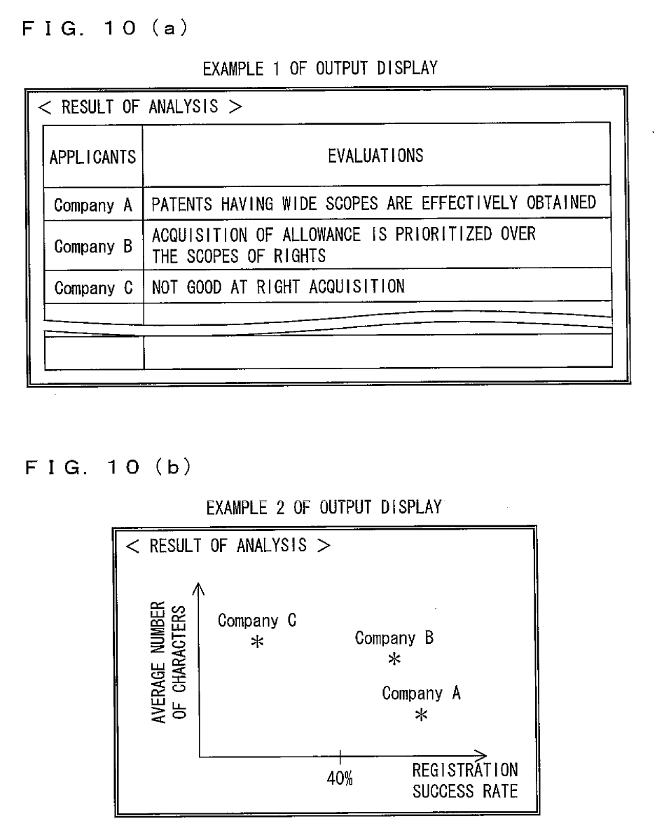

The following will describe a case where analysis is carried out using the data of patent registration success rate, in addition to the result of the comparison by the second analysis process section 70 or the comparative evaluation section 81, with reference to FIG. 9. The (a) part of FIG. 9 is a flowchart of analysis by performing a comparison between plural sets of patent specification data in the third analysis process section 71. The (b) and (c) parts of FIG. 9 indicate the data structures in a work memory (which is provided in the data processing section 51 and is not illustrated).

First, the third analysis process section 71 reads out a patent registration success rate on an applicant by applicant basis (S41). The registration success rates may be stored in advance in the storage section 40 or another memory, or may be calculated as below.

The registration success rate for one year can be calculated by a mathematical expression as follows: the number of registrations in one year/(the number of registrations in one year+the number of rejected applications in one year+the number of abandoned or withdrawn applications).

The registration success rate of each applicant, which has been read out and stored in the work memory, may be arranged such that, as shown in the (b) part of FIG. 9, the applicant name and the registration success rate are listed in this order and these items are separated by commas.

Also, the third analysis process section 71 stores in advance an evaluation determination table shown in Table 2 in the storage section 40 or another memory, and performs evaluation with reference to this evaluation determination table and based on the following three conditions: the registration success rate, the registered number of characters, and the difference between the published number of characters and the registered number of characters (S42).

TABLE 2

| | | | NUMBER OF | |
|---|---|---|---|---|
| | | | CHARACTERS | |
| | | REGISTRATION | AT THE TIME | |
| | | SUCCESS | OF | |
| NO. | EVALUATIONS | RATE | REGISTRATION | DIFFERENCES |
| 1 | PATENTS HAVING | HIGH | SMALL | — |
| | WIDE SCOPES ARE | | | |
| | EFFECTIVELY | | | |
| | OBTAINED | | | |
| 2 | PRIOR ART SEARCH | HIGH | — | SMALL |
| | IS SUFFICIENTLY | | | |
| | DONE AT THE TIME | | | |
| | OF APPLICATION | | | |
| 3 | ACQUISITION OF | HIGH | LARGE | AVERAGE TO |
| | ALLOWANCE IS | LARGE | | |
| | PRIORITIZED OVER | | | |
| | THE SCOPES OF | | | |
| | RIGHTS | | | |
| 4 | ONLY | AVERAGE TO | — | SMALL |
| | EASILY-PATENTABLE | LOW | | |
| | APPLICATIONS ARE | | | |
| | REGISTERED | | | |
| 5 | NOT GOOD AT | LOW | LARGE | — |
| | RIGHT ACQUISITION | | | |

| | | |
|---|---|---|
| 6 | AVERAGE RIGHT | CONDITIONS OTHER THAN THE ABOVE |
| | ACQUISITION | |
| | CAPABILITIES | |

In Table 2, the registered numbers of characters and the differences may be evaluated as large, average, and small, in such a manner that, for example, the numbers of characters are evaluated as “average” if the numbers are about 90% to 110% of the industry average, the numbers are evaluated as “large” if the numbers are larger than “average”, and the numbers are evaluated as “small” if the numbers are smaller than “average”.

The registration success rates may be evaluated as large, average, and small in the following manner: the average registration success rate of all applicants is calculated, and an applicant whose registration success rate is about 90% to 110% of the average is evaluated as “average”, an applicant whose registration success rate is higher than “average” is evaluated as “high”, and an applicant whose registration success rate is lower than “average” is “low”.

Evaluating the data shown in the (b) part of FIG. 9, the company A is evaluated as high in the registration success rate and small in the registered numbers of characters. Therefore the evaluation No. 1 “PATENTS HAVING WIDE SCOPES ARE EFFECTIVELY OBTAINED” is applicable to the company A, according to Table 2.

In the meanwhile, the company B is evaluated as high in the registration success rate, large in the registered numbers of characters, and average to large in the differences. Therefore the evaluation No. 3 “ACQUISITION OF ALLOWANCE IS PRIORITIZED OVER THE SCOPES OF RIGHTS” is applicable to the company B, according to Table 2.

The company C is evaluated as low in the registration success rate and large in the registered numbers of characters. Therefore, the evaluation No. 5 “NOT GOOD AT RIGHT ACQUISITION” is applicable to the company C, according to Table 2.

The result of the evaluations of the right acquisition capabilities of the companies by the third analysis process section 71 are stored in the work memory in the order of the applicant names and the evaluation numbers as shown in (c) part of FIG. 9.

If the result of the analysis by the third analysis process section 71 is applicable to plural conditions in the table, plural evaluations may be given. For example, when the registration success rate=high, the registered numbers of characters=small, and the differences=small, evaluations No. 1 and No. 2 may be applicable.

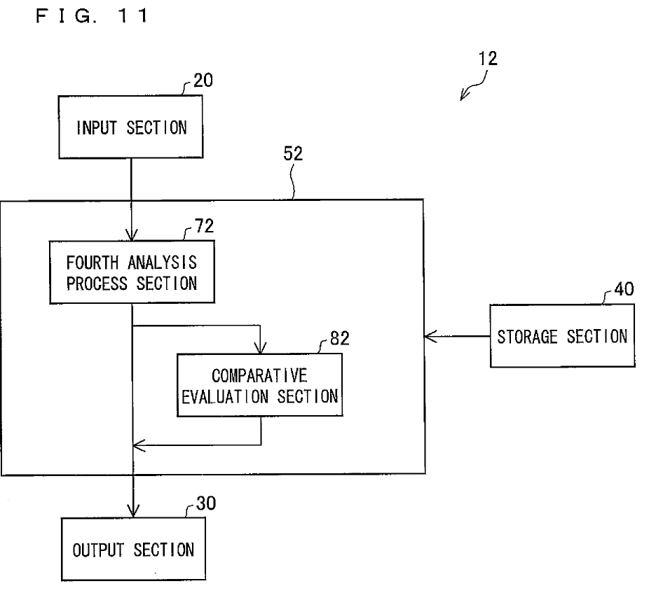

When the data stored in the work memory is output by the output section 30 as shown in the (c) part of FIG. 9, a table in which applicants are associated with evaluation results may be displayed by the output device, as shown in FIG. 10(a).

Alternatively, a graph shown in FIG. 10(b) may be displayed. In this graph, the horizontal axis indicates the registration success rates and the vertical axis indicates the averages of registered numbers of characters, and the registration success rate and the average of the registered numbers of characters of each applicant are plotted. Such a graph makes it possible to recognize at a glance the differences between the applicants in the right acquisition capabilities, patent acquisition strategy, or the like, and hence a relative comparison between the applicants can be easily done.

As a matter of course, the displays shown in FIG. 10(a) and FIG. 10(b) may be generated in an attorney by attorney basis.

<3. Summary>

As discussed above, the patent information analyzing apparatus 11 of the present embodiment makes it possible to analyze one's ability to respond to office actions as the right acquisition capabilities, by representing the scopes of rights by numerical values and comparing the values between sets of patent specification data (unexamined publications and publications of registered patents) belonging to the same application.

To perform a relative comparison between results obtained from plural sets of patent specification data, a highly-reliable result can be obtained by comparing results of analysis of plural sets of patent specification data belonging to a particular technical field. Moreover, analysis can be done in a more detailed manner, by performing analysis using the data of the patent registration success rates.

Being similar to First Embodiment, the scope of right may be represented by a numerical value by counting the number of characters in a claim or counting the number of constituent features recited in an independent claim.

Although in the case above the target of analysis by the patent information analyzing apparatus is only claim 1, all claims may be the targets of analysis. In such a case, inventions pertaining to independent claims are preferably chosen as the targets of analysis. That is to say, limitations recited in independent claims are typically fewer than those recited in dependent claims. It is therefore preferable that invention pertaining to independent claims be chosen as the targets of analysis.

### Third Embodiment

### Apparatus Configuration

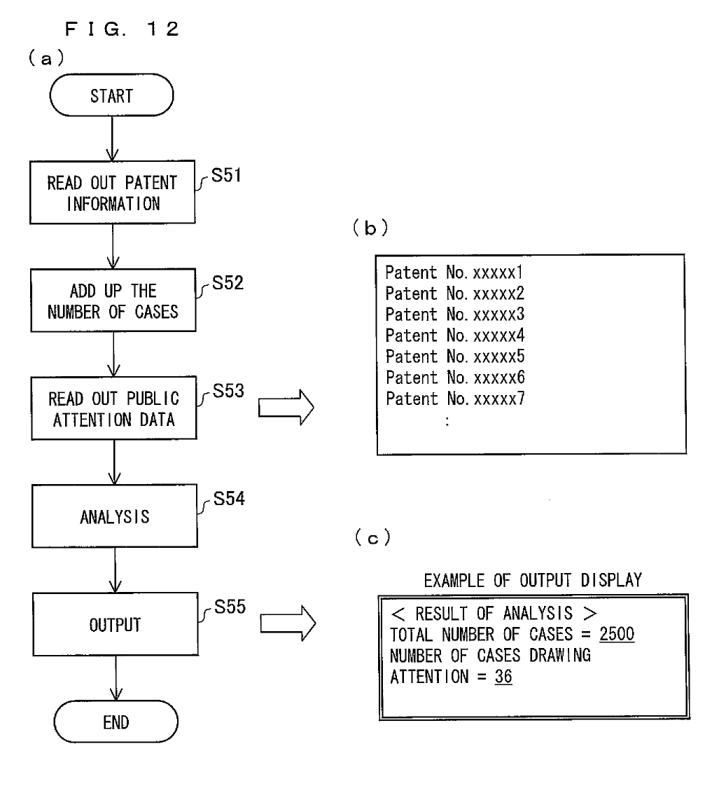

As a further embodiment of the present invention, with reference to FIGS. 11-14, the following will describe a patent information analyzing apparatus and a patent information analyzing method, by which the right utilization capabilities of an applicant after registration are analyzed. It is noted that members of the patent information analyzing apparatus of the present embodiment having the same functions as those described in First Embodiment are given the same numbers, so that the descriptions are omitted for the sake of convenience.

As shown in FIG. 11, the patent information analyzing apparatus 12 of the present embodiment includes an input section 20, a data processing section 52, an output section 30, and a storage section 40.

The data processing section 52 performs various data processes, and includes a fourth analysis process section (fourth analysis process means) 72 and a comparative evaluation section (first comparative evaluation means) 82.

The fourth analysis process section 72 adds up the number of sets of patent specification data input to the input section 20, and analyzes the sets of patent specification data based on data (public attention data) indicating the public attention to each set of patent specification data

The comparative evaluation section 82 performs a relative comparison between the scopes of rights recited in claims of plural sets of patent specification data.

Now, the following will describe how the patent information analyzing apparatus 12 operates. First, plural patent numbers or the like, of the targets of analysis are input through the input section 20. Based on the patent numbers or the like thus input, the data processing section 52 reads out sets of patent specification data of target patents from the storage section 40, as text data.

Subsequently, the fourth analysis process section 72 adds up the numbers of the sets of patent specification data which are the targets of analysis, and reads out, from the storage section 40 or another memory (not illustrated), the patent number of a patent which has drawn public attention and hence against each of which a notice of trial or an opposition has been filed. The fourth analysis process section 72 then inquires, among the patent numbers input through the input section 20, how many patents against each of which a notice of trial or an opposition has been filed are included.

The result of the inquiry by the fourth analysis process section 72 is output to the output device in the form of monitor display, printout, or the like, by the output section 30.

Alternatively, in case where a relative comparison between the scopes of rights recited in claims of plural sets of patent specification data is conducted, the comparative evaluation section 82 performs a comparison between plural sets of patent specification data belonging to a specific technical field.

<2. Operation Flow>

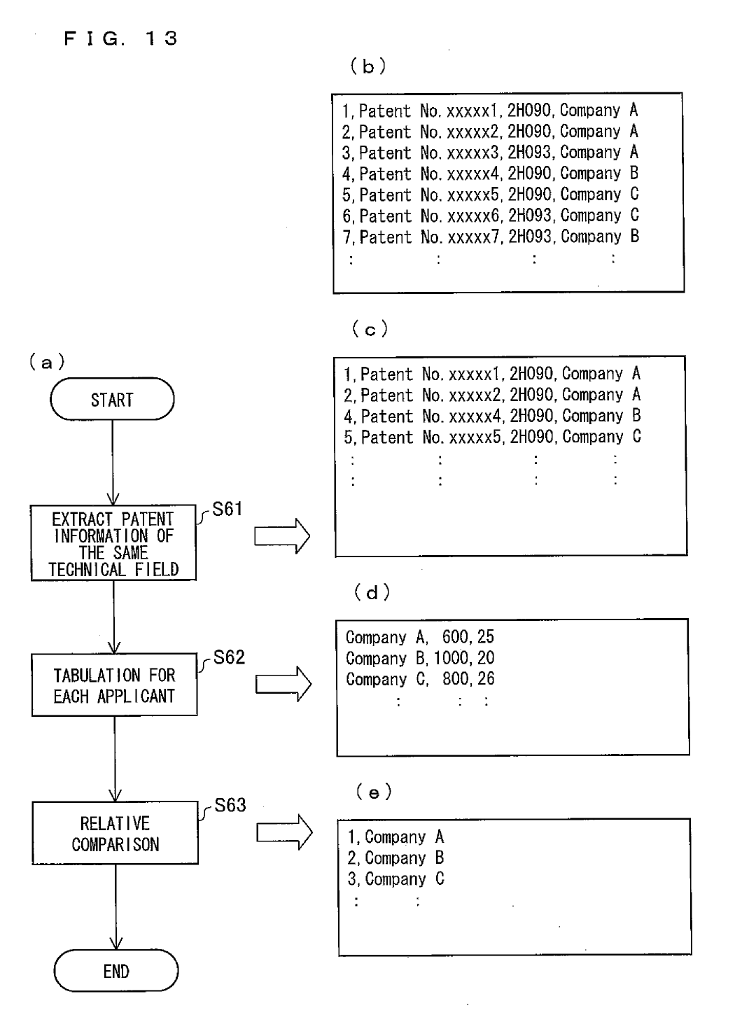

The following will specifically describe how the data processing section 52 operates, with reference to FIG. 12. The (a) part of FIG. 12 is a flowchart at the time of performing analysis mainly by the data processing section 52 in consideration of the attention of other companies. The (b) part of FIG. 12 shows the data structure in a work memory (which is provided in the data processing section 52 and is not illustrated). The (c) part of FIG. 12 shows an example of a display screen on the output device, which is based on an output from the output section 30.

First, receiving patent numbers or the like of the targets of analysis, which are input through the input section 20, the data processing section 52 reads out, as text data, sets of patent specification data of the target patents from the storage section 40, with reference to the input patent numbers or the like, and stores the data in the work memory (not illustrated) in the data processing section 52 (S51).

The fourth analysis process section 72 then adds up the number of sets of patent specification data input through the input section 20 and tabulates the patent numbers (S52).

Furthermore, the fourth analysis process section 72 reads out, as public attention data, the patent number of a patent against each of which a notice of trial or an opposition has been filed, from the storage section 40, another memory (not illustrated), or the like (S53). In doing so, the work memory stores patent numbers of patents against each of which a notice of trial or an opposition has been filed, as shown in the (b) part of FIG. 12.

In addition to the above, the fourth analysis process section 72 inquires, among the patent numbers of the targets of analysis, how many patents against each of which a notice of trial or an opposition has been filed are included (S54).

Then the output section 30 outputs the result of the inquiry by the fourth analysis process section 72 in S54 to the output device, in the form of monitor display, printout, or the like (S55). For example, as shown in the (c) part of FIG. 12, the output section 30 displays, on the output device, a screen showing the total number of cases and the number of cases drawing attention. The total number of cases indicates the number of sets of patent specification data analyzed by the fourth analysis process section 72, whereas the number of cases drawing attention indicates the number of patents against each of which a notice of trial or an opposition has been filed, which have been found out by the fourth analysis process section 72.

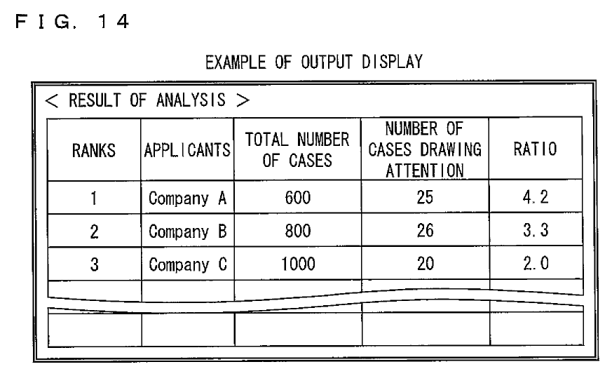

Subsequently, a case where a relative comparison between plural sets of patent specification data is performed will be discussed with reference to FIG. 13. The (a) part of FIG. 13 is a flowchart at the time of a relative comparison between plural sets of patent specification data by the comparative evaluation section 82. The (b)-(e) parts of FIG. 13 show examples of the data structure in a work memory (which is provided in the data processing section 52 and is not illustrated).

To perform a relative comparison between plural sets of patent specification data, first of all, the data with the structure shown in the (b) part of FIG. 13 is prepared in the work memory. The data structure shown in the (b) part of FIG. 13 is arranged such that items for a single set of patent specification data are stored in the order of serial number, patent number, F term, and applicant name, and the items are separated by commas. An item for a particular set of the patent specification data and items for other types of patent specification data are separated by a line feed character.

These items are arranged to be storable in such a manner that plural sets of patent specification data are input in advance by inputting application numbers thereof, specifying a particular technical field with reference to IPC or the like, through the input section 20. An arrangement similar to the claim analysis process section 60 (see First Embodiment) may be provided in the patent information analyzing apparatus 12 and the number of characters in a claim in the patent specification data may be counted and the counter number of characters may be stored in the work memory.

First, the comparative evaluation section 82 extracts, from the data shown in the (b) part of FIG. 13, only sets of patent specification data belonging to a particular technical field (in the present embodiment, F term: 2H090) specified in advance, and stores the extracted data in the work memory (S61). In doing so, the data stored in the work memory has, for example, the structure shown in the (c) part of FIG. 13.

Furthermore, the comparative evaluation section 82 adds up the total number of sets of patent specification data that each applicant has and the number of cases against each of which a notice of trial or an opposition has been filed, in order to perform a relative comparison between applicants in the number of patents that each applicant has and the number of cases against each of which a notice of trial or an opposition has been filed (S62). In doing so, the work memory stores, as shown in the (d) part of FIG. 13, items in the order of the applicant name, the total number of cases, and the number of cases against each of which a notice of trial or an opposition has been filed, and the items are separated by commas.

Then the comparative evaluation section 82 determines the order of applicants in such a manner that an applicant, who has a high percentage of cases against each of which a notice of trial or an opposition has been filed out of the total number of cases, is ranked as high (S63). In the present embodiment, the company A having the highest percentage (25/600=4.2%) is ranked as the highest, the company C (26/800=3.3%) is ranked as the second highest, and the company B (20/1000=2.0%) is ranked as the third highest. In doing so, the data in the work memory is arranged such that the ranks and the applicant names are stored in this order and these items are separated by commas, as shown in the (c) part of FIG. 13.

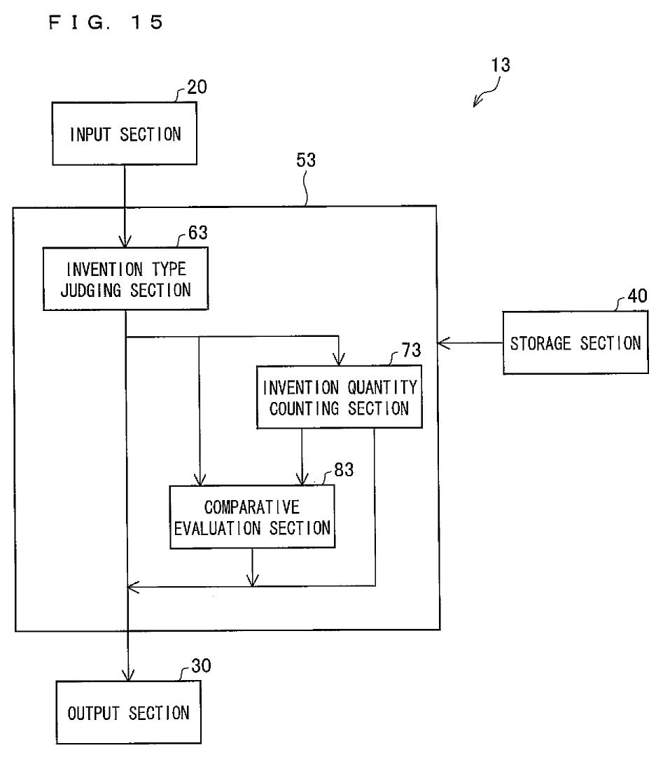

When the data stored as shown in the (e) part of FIG. 13 is output from the output section 30, a table in which the total number of ranks, applicants, and sets of patent specification data, the number of cases (public attention cases) against each of which a notice of trial or an opposition has been filed, and the ratio between the total number of cases and the public attention cases are associated with one another may be output by the output device, as shown in FIG. 14. The display shown in FIG. 14 may be generated on an attorney by attorney basis, as a matter of course.

<3. Summary>

As described above, the patent information analyzing apparatus 12 of the present embodiment adds up the number of sets of patent specification data and performs analysis with reference to the public attention data (the number of cases against each of which a notice of trial or an opposition has been filed) with respect to the sets of patent specification data. The patent information analyzing apparatus 12 of the present embodiment therefore makes it possible to analyze to what degree the sets of patent specification data draw attention of other companies (i.e. those who are not the applicant of these sets of patent specification data). It is therefore possible to objectively analyze the right acquisition capabilities of an applicant, from the perspective of to what degree the applications filed by the applicant are important. Furthermore, since sets of patent specification data belonging to a specific technical field are compared to one another, it is possible to obtain a highly reliable result of analysis.

It is noted that the public attention data is not necessarily limited to cases against each of which a notice of trial or an opposition has been filed. For example, the public attention data may be cases which have been cited as documents for denying the novelty or inventive step of an invention taught in another application (number of cited patents) or cases to which a request of inspection has been made to the patent office. The public attention data may be a combination of the aforesaid examples.

<Supplemental Remarks for First to Third Embodiments>

The right acquisition capabilities of an applicant may be comprehensively analyzed by appropriately combining the data processing sections 50, 51, and 52 of First to Third Embodiments.

Also, the result of the analysis by the data processing section 52 of Third Embodiment may be used for checking the results of the analysis by the data processing sections 50 and 51 of First and Second Embodiments. In other words, whether an important patent drawing attention of other companies has been eventually obtained can be checked by using the result of the analysis of the data processing section 52, and hence the right acquisition capabilities analyzed by the data processing section 50 or 51 can be verified.

### Fourth Embodiment

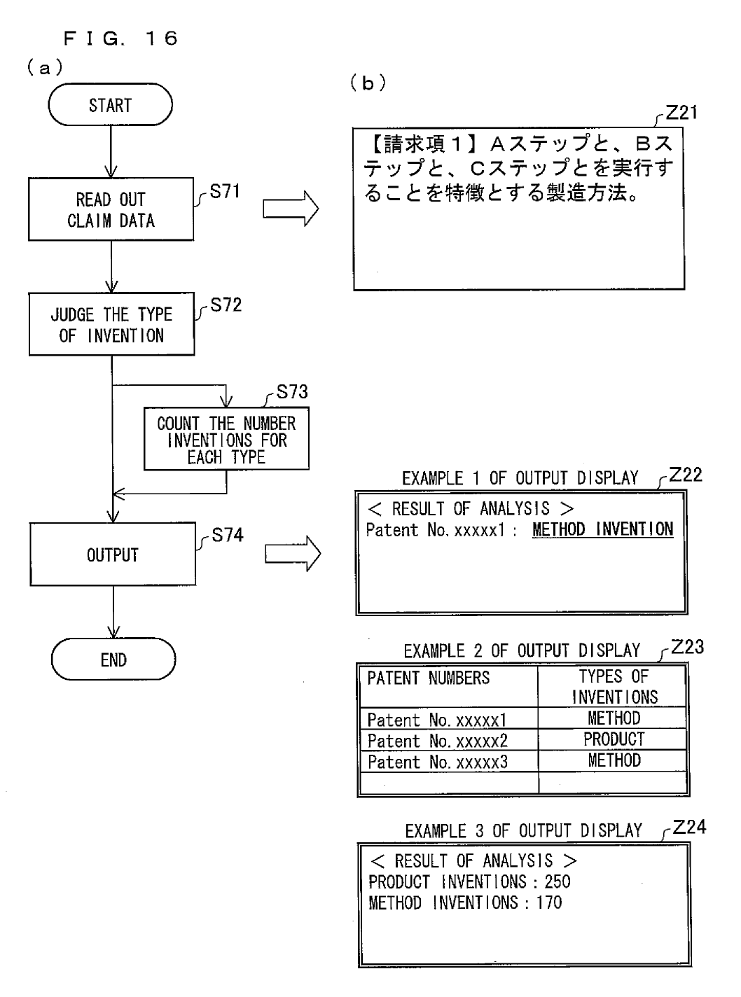

The following will describe an embodiment of the present invention with reference to FIG. 15 to FIG. 18.

<Apparatus Configuration>

The following will describe a patent information analyzing apparatus 13 of the present embodiment, with reference to FIG. 15. FIG. 15 is a block diagram showing the patent information analyzing apparatus 13 of Fourth Embodiment. As shown in the figure, the patent information analyzing apparatus 13 includes an input section 20, an output section 30 (output means), a storage section 40, and a data processing section 53.

The input section 20, the output section 30, and the storage section 40 are identical with those recited in First Embodiment, and hence the descriptions thereof are omitted.

The data processing section 53 analyzes sets of patent specification data having patent numbers input through the input section 20. In doing so, the data processing section 53 reads out, from the storage section 40, the sets of patent specification data having the patent numbers thus input. In particular, the data processing section 53 reads out claim 1 of a set of patent specification data. In the present embodiment, the data processing section 53 reads out claim 1 of a set of patent specification data, as Japanese text data. The data processing section 53 stores the text data thus read out in a work memory (not illustrated). The data processing section 53 therefore analyzes the text data stored in the work memory which is not illustrated.

Details of the data processing section 53 will be given. As shown in FIG. 15, the data processing section 53 includes, an invention type judging section 63 (character string comparison means, invention type judging means), an invention quantity counting section 73 (invention quantity counting means), and a comparative evaluation section 83 (second comparative evaluation means).

The invention type judging section 63 judges the type of an invention recited in claim 1 of a set of patent specification data. In doing so, the invention type judging section 63 judges whether the invention pertaining to claim 1 is a product invention or a method invention. The invention type judging section 63 performs the judgment of the type of an invention by means of a character search technique such as pattern matching.

The patent information analyzing apparatus 13 stores in advance character strings for specifying the types of inventions, in a ROM (Read Only Memory, not illustrated). The invention type judging section 63 reads out the data from the ROM and use it for the pattern matching. The storage medium in which character strings for specifying the types of inventions may be a CD-ROM, a DVD-ROM, or a hard disc.

Claims of Japanese patent specifications are typically arranged such that a character string for specifying the type of the invention is followed by a character string ending with “full stop ( [symbol] )”. For example, a claim of a product invention is arranged such that a character string ending with the phrase such as “ [symbol] ”, “ [symbol] ”, “ [symbol] ”, “ [symbol] ”, “ [symbol] ”, “ [symbol] ”, and “ [symbol] ” is followed by “₀”. A claim of a method invention is arranged such that a character string ending with the phrase such as “ [symbol] ”, “ [symbol] ”, and “ [symbol] ”, is followed by “ [symbol] ”.

The invention type judging section 63 reads out, from the ROM, such character strings that indicate the types of inventions. The invention type judging section 63 therefore judges whether the ending phrase of a claim ends with one of predetermined character strings indicating the types of inventions, by comparing the ending phrase of the claim as the target of analysis with the predetermined character strings indicating the types of inventions, which have been read out from the ROM. If it is judged that the ending phrase of the claim is a character string indicating a product invention, The invention type judging section 63 judges that the claim as the target of analysis is a claim pertaining to a product invention. In the meanwhile, if it is judged that the ending phrase of a claim is a character string indicating a method invention, the invention type judging section 63 judges that the claim as the target of analysis is a claim pertaining to a method invention.

It is noted that a claim (independent claim) in an English patent specification is typically constituted by three parts, which are preamble (introductory part describing a target of claim), transitional phrase (connecting the preamble and substantive part) and substantive part (which is an important part describing the characteristic of the invention). The word (character string) indicating the type of the invention is typically found in the preamble. On this account, the invention type judging section 63 makes judgments of the type of an invention by comparing the words in the preamble with the predetermined character strings indicating the types of inventions, which have been read out from the ROM (in case of English, “apparatus” in case of product inventions and “process” in case of method inventions).

The invention type judging section 63 associates the patent number of a set of patent specification data to be analyzed with the invention type indicating character string which has been identified. For example, the invention type judging section 63 associates a patent number “ . . . ” with the character string “method invention”. The invention type judging section 63 outputs the data generated by the association to the invention quantity counting section 73 and the comparative evaluation section 83.

The patent information analyzing apparatus 13 can analyze plural sets of patent specification data. In doing so, the invention quantity counting section 73 counts the number of types of inventions that the invention type judging section 63 has identified. More specifically, the invention quantity counting section 73 receives, from the invention type judging section 63, text data in which a patent number is associated with an invention type indicating character string. With this, the invention quantity counting section 73 counts how many sets of patent specification data pertain to product inventions are included among the sets of patent specification data which are the targets of analysis. Furthermore, among the sets of patent specification data which are the targets of analysis, how many sets of patent specification data pertain to method inventions are included is counted. The invention quantity counting section 73 outputs the results of the counting to the output section 30.

In case where all claims of sets of patent specification data are the targets of analysis, the number of types of inventions is counted for each set of patent specification data.

The comparative evaluation section 83 compares sets of patent specification data belonging to the same technical field with one another. More specifically, the comparative evaluation section 83 compares a set of patent specification data belonging to a technical field with another set of patent specification data belonging to the same technical field. In this case, sets of patent specification data belonging to the same technical field are those having a substantially identical patent classification symbol.

The phrase “substantially identical patent classification symbol” indicates patent classification symbols which are different in expression but are considered to be substantially identical. For example, IPC, which is an example of patent classification symbols, has major divisions indicating the outlines of the fields of inventions, and intermediate and minor divisions indicating narrower fields. For example, two IPCs which are the same in major divisions but different in intermediate or minor divisions are not identical with one another in expression but indicate the substantially same field. These two are therefore the substantially same patent classification symbols.

The comparative evaluation section 83 receives a patent classification symbol of a field to be analyzed. The comparative evaluation section 83 may receive, as a patent classification symbol, a patent classification symbol which is input by the user through the input section 20. Alternatively, as a patent classification symbol, a patent classification symbol stored in a work memory (not illustrated) in advance may be used. For example, as a patent classification symbol, IPC (International Patent Classification), FI (File Index), and F term which are recited in patent specification data are used in cases of Japanese patent specifications. In cases of U.S. patent specifications, US classes may be used. As a result, the comparative evaluation section 83 extracts a result of analysis of sets of patent specification data with a specific patent classification symbol. It is therefore possible to precisely and easily specify to which field the set of patent specification data which is the target of analysis belongs.

For example, the comparative evaluation section 83 extracts product inventions from the result of the analysis. Furthermore, the comparative evaluation section 83 counts the number of product inventions of each applicant. Also, the comparative evaluation section 83 divides the total number of product inventions by the number of applicants, so as to calculate the industry average of product inventions in a field (i.e. the average in one field). The comparative evaluation section 83 performs similar processes for method inventions.

In this manner, the comparative evaluation section 83 performs a relative comparison between plural sets of patent specification data to find whether the patent right of an invention recited in a claim is easily exercisable. The comparative evaluation section 83 outputs the result of the comparison to the output section 30. Also, the comparative evaluation section 83 performs a relative comparison between the number of patent rights of one's company with the numbers of patent rights of other companies. By doing so, the strength of the patent rights of each company or the like is analyzed. The comparative evaluation section 83 outputs the result of the comparison to the output section 30.

<2. Operation Flow>

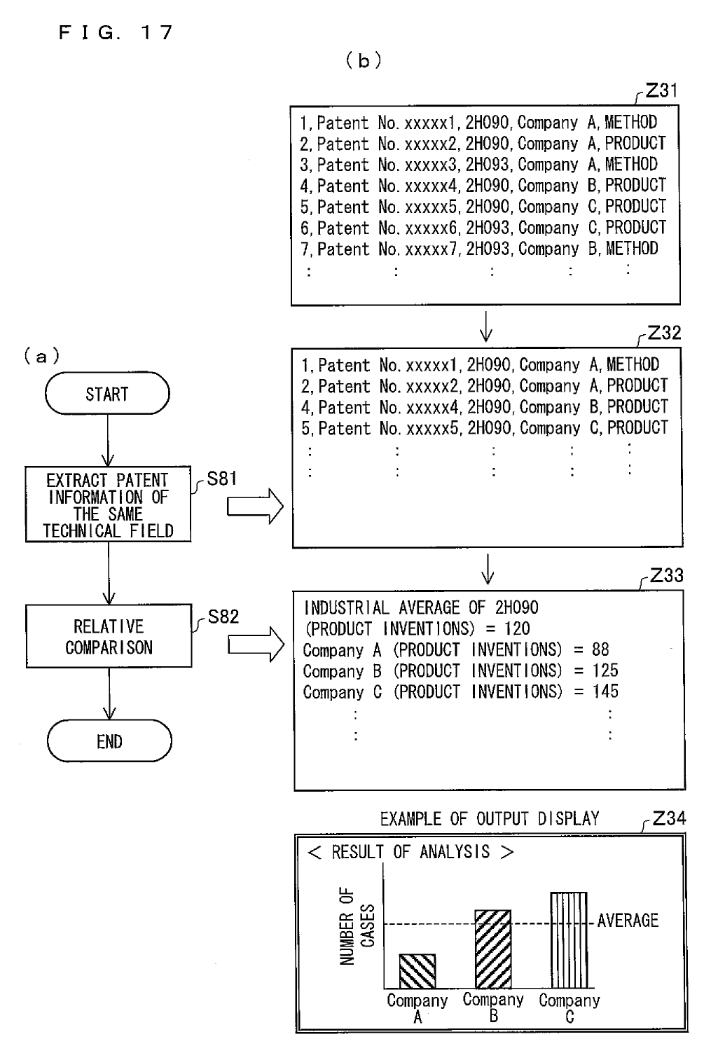

The following will describe how the patent information analyzing apparatus 13 operates, with reference to FIGS. 16 and 17. FIG. 16 illustrates how the patent information analyzing apparatus 13 of Fourth Embodiment operates. The (a) part of FIG. 16 is a flowchart showing the operation of the patent information analyzing apparatus 13. The (b) part of FIG. 16 shows examples of text data processed by the patent information analyzing apparatus 13 and results of analysis to be output. As shown in the figure, the user input a patent number of the target of analysis, through the input section 20. Based on the patent number thus input, the invention type judging section 63 reads out a set of patent specification data having the patent number, from the storage section 40 (S71).

As shown in the (b) part of FIG. 16, in the present embodiment, the invention type judging section 63 reads out text data of Z21 from the storage section 40. That is, what is read out is text data of [ [symbol] 1] which includes a character string “A [symbol] B [symbol] C [symbol] [symbol] [symbol] [symbol] ”.

Subsequently, the invention type judging section 63 judges the type of the invention recited in the claim which is the target of analysis (S72). In doing so, the invention type judging section 63 checks the ending phrase of the claim. In the example shown in the (b) part of FIG. 16, the claim ends with “ [symbol] ”. The invention type judging section 63 therefore judges that the invention recited in the claim is a method invention. The invention type judging section 63 performs this step for respective sets of patent specification data, and outputs the result of the analysis to the invention quantity counting section 73 and the comparative evaluation section 83.

Receiving the result of the analysis by the invention type judging section 63, the invention quantity counting section 73 counts the number of inventions, for each type of invention (S73). In the example shown in the part (b) of FIG. 16, the number of product inventions is 250 and the number of method inventions is 170. The invention quantity counting section 73 outputs the result of the counting to the output section 30.

Thereafter, the output section 30 outputs the result of the analysis to the output device (S74). In doing so, the output section 30 outputs the result of the analysis indicated by Z22. As a result, the output device indicates that the patent with the patent number “xxxxx1” is a method invention, by monitor display, printout, or the like.

In case where plural sets of patent specification data are analyzed, the output section 30 outputs the result of the analysis indicated by Z23. That is, a table in which plural patent numbers of inventions are associated with the types thereof. Therefore, in the example of Z23, the output device indicates that the patent number “xxxxx1” is a method invention by monitor display, printout, or the like. The output device also indicates that the patent number “xxxxx2” is a product invention by monitor display, printout, or the like. Furthermore, the output device indicates that the patent number “xxxxx3” is a method invention by monitor display, printout, or the like.

Also, the output section 30 outputs the result of the counting by the invention quantity counting section 73. In doing so, the output section 30 outputs the result of the analysis indicated by Z24. In other words, the output section 30 outputs the number of product inventions and the number of method inventions. In the example shown in the part (b) of FIG. 16, the output from the output section 30 shows that there are 250 product inventions and 170 method inventions. The output device therefore outputs the result of the analysis indicated by Z24 by monitor display, printout, or the like.

Referring to FIG. 17, the following will describe a case where the patent information analyzing apparatus 13 analyzes sets of patent specification data belonging to the same field and compares them. FIG. 17 illustrates how the patent information analyzing apparatus 13 of Fourth Embodiment operates. The (a) part of FIG. 17 is a flowchart showing the operation of the patent information analyzing apparatus 13. The (b) part of FIG. 17 shows examples of text data processed by the patent information analyzing apparatus 13 and a result of analysis to be output.

With reference to patent numbers which have been input, the invention type judging section 63 reads out, from the storage section 40, sets of patent specification data corresponding to the patent numbers thus input. The invention type judging section 63 performs the aforesaid analysis so as to determine the types of the inventions recited in the claims of the sets of patent specification data. Furthermore, the invention type judging section 63 extracts, from the sets of patent specification data, the applicants and F terms which indicate the patent classification unique to Japan (S81). In this way, the invention type judging section 63 generates the data having the format indicated by X31 in the (b) part of FIG. 17. That is to say, the generated data is arranged such that serial numbers starting from 1, patent numbers, F terms, applicants, and the types of inventions are associated with one another. The data generated by the invention type judging section 63 and shown in the (b) part of FIG. 17 is arranged such that items are separated by commas and sets of data for respective cases are separated by line feed characters.

The comparative evaluation section 83 performs a relative comparison between sets of patent specification data, based on the data indicated by Z31 of the (b) part of FIG. 17 (S82). First, the comparative evaluation section 83 extracts all lines of data having the F term “2H090” as indicated by Z32 in the (b) part of FIG. 17. Furthermore, the comparative evaluation section 83 counts the number of product inventions of each applicant, as indicated by Z33 in the (b) part of FIG. 17. In this example, the comparative evaluation section 83 counts that there are 88 product inventions of the company A, 125 product inventions of the company B, and 145 product inventions of the company C.

The comparative evaluation section 83, furthermore, counts the industry average of product inventions. In the example, the comparative evaluation section 83 calculates that the industry average of product inventions is 120.

The industry in the present embodiment is a technical field of liquid crystal displays, because the targets of analysis are sets of patent specification data having the F term “2H090”.

The output section 30 outputs, as a graph, the number of product inventions of each applicant, as indicated by Z34 in the (b) part of FIG. 17. In response to this, the output device performs monitor display, printout, or the like of the graph indicated by Z34. In doing so, the industry average is also shown as indicated by the dotted line in the figure. This graph allows the user to understand at a glance the number of patent rights owned by each applicant. It is therefore possible to perform a relative comparison between the applicants, and sets of patent specification data are fairly analyzed in a highly reliable manner.

The patent information analyzing apparatus 13 may judge the type of an invention recited in a claim by a method other than the above. In other words, another judging technique by which the type of an invention can be judged may be adopted. For example, the type of an invention may be judged by detecting whether the last phrase of the character strings constituting the claim is a noun indicating a product.

### Fifth Embodiment

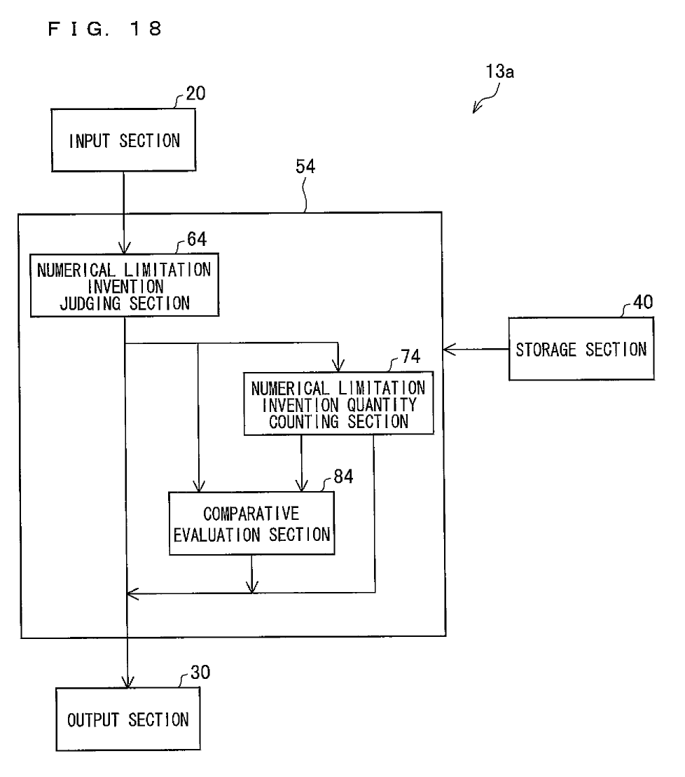

The following will describe Fifth Embodiment of the present invention with reference to FIGS. 18-20.

The patent information analyzing apparatus 13a of the present embodiment judges whether an invention recited in a claim of a set of patent specification data is a numerical limitation invention.

<Apparatus Configuration>

The following will describe a patent information analyzing apparatus 13a of the present embodiment with reference to, FIG. 18. FIG. 18 is a block diagram showing the patent information analyzing apparatus 13a of Fifth Embodiment. As shown in the figure, the patent information analyzing apparatus 13a includes an input section 20, an output section 30, a storage section 40, and a data processing section 54.

Among these members, the input section 20, the output section 30, and the storage section 40 are identical with those shown in FIG. 15 and hence the explanations are omitted.

The following will describe the data processing section 54 with reference to FIG. 18. As shown in FIG. 18, the data processing section 54 includes a numerical limitation invention judging section 64 (character string comparison means, numerical limitation invention judging means), a numerical limitation invention quantity counting section 74 (numerical limitation invention quantity counting means), and a comparative evaluation section 84 (second comparative evaluation means).

The numerical limitation invention judging section 64 judges the type of an invention recited in claim 1 of a set of patent specification data. In doing so, the numerical limitation invention judging section 64 judges whether the invention pertaining to claim 1 is a numerical limitation invention. The numerical limitation invention judging section 64 makes a judgment by means of a character search technique such as pattern matching.

The patent information analyzing apparatus 13a stores in advance character strings indicating predetermined numerical limitations in a ROM (not illustrated). The numerical limitation invention judging section 64 therefore reads out this data from the ROM and use it for the pattern matching. The storage medium storing character strings indicating numerical limitations in advance may be a CD-ROM, a DVD-ROM, a hard disc, or the like.

Examples of the character strings indicating numerical limitations include unit symbols (e.g. “°”, “μ”, and “%”). Other examples are arithmetic signs (e.g. “≧”, “>”, “≦” and “<”). and character strings indicating quantities (e.g. “not less than” and “less than). If an invention pertaining to a claim of a set of patent specification is a numerical limitation invention, the claim includes at least one of the aforesaid character strings indicating numerical limitations.

The numerical limitation invention judging section 64 reads out these character strings indicating numerical limitations from the ROM. The numerical limitation invention judging section 64 therefore compares the character strings in the claim which is the target of analysis with the character strings which are read out from the ROM and indicating numerical limitations, so as to judge whether the claim includes a character string indicating a predetermined numerical limitation. If it is judged that the claim includes a character string indicating a predetermined numerical limitation, the numerical limitation invention judging section 64 determines that the claim which is the target of analysis is a claim related to a numerical limitation invention. On the other hand, if it is judged that the claim does not include a character string indicating a predetermined numerical limitation, the numerical limitation invention judging section 64 determines that the claim which is the target of analysis relates to an invention not including a numerical limitation.

The numerical limitation invention judging section 64 associates the patent number of the set of patent specification data which is the target of analysis with the invention type indicating character string thus specified. For example, the numerical limitation invention judging section 64 associates the patent number “ . . . ” with the character string “numerical limitation invention”. The numerical limitation invention judging section 64 outputs the data generated by this association to the numerical limitation invention quantity counting section 74 and the comparative evaluation section 84.

The patent information analyzing apparatus 13a can analyze plural sets of patent specification data. Therefore the numerical limitation invention quantity counting section 74 counts the number of inventions specified by the numerical limitation invention judging section 64, for each type of invention. More specifically, the numerical limitation invention quantity counting section 74 receives, from the numerical limitation invention judging section 64, text data in which a patent number is associated with an invention type indicating character string. The numerical limitation invention quantity counting section 74 then counts how sets of patent specification data related to many numerical limitation inventions are included in all sets of patent specification data to be analyzed. Furthermore, the numerical limitation invention quantity counting section 74 counts how many sets of patent specification data related to inventions not relating to numerical limitations are included in all sets of patent specification data to be analyzed. The numerical limitation invention quantity counting section 74 sends the result of the counting to the output section 30.

In case where all claims of sets of patent specification data are the targets of analysis, the number of numerical limitation inventions is counted for each set of patent specification data.

The comparative evaluation section 84 compares sets of patent specification data belonging to the same field with one another. More specifically, the comparative evaluation section 84 compares a set of patent specification data belonging to a technical field with a set of patent specification data belonging to the same technical field. Sets of patent specification data belonging to the same field in this case are those having a substantially identical patent classification symbol.

The phrase “substantially identical patent classification symbol” indicates patent classification symbols which are different in expression but are considered to be substantially identical. For example, IPC, which is an example of patent classification symbols, has major divisions indicating the outlines of the fields of inventions, and intermediate and minor divisions indicating narrower fields. For example, two IPCs which are the same in major divisions but different in intermediate or minor divisions are not identical with one another in expression but indicate the substantially same field. These two are therefore the substantially same patent classification symbols.

The comparative evaluation section 84 receives the patent classification symbol of the field to be processed. The comparative evaluation section 84 may receive, as a patent classification symbol, a patent classification symbol that the user has input through the input section 20. Alternatively, as a patent classification symbol, a patent classification symbol stored in a work memory (not illustrated) in advance may be used. For example, as a patent classification symbol, IPC included in patent specification data or FI and F term which are patent classifications unique to Japan. With this, the comparative evaluation section 84 extracts the result of the analysis of sets of patent specification data with specific patent classification symbols.

For example, the comparative evaluation section 84 extracts numerical limitation inventions from the result of the analysis. Then the comparative evaluation section 84 counts the number of numerical limitation invention of each applicant. In addition to this, the comparative evaluation section 84 divides the total number of numerical limitation inventions by the number applicants so as to calculate the industry average of numerical limitation inventions in one technical field. The comparative evaluation section 84 similarly deals with inventions unrelated to numerical limitations.

In this manner, the comparative evaluation section 84 performs a relative comparison between sets of patent specification data to determine whether the patent right of the invention recited in a claim is exercisable. The comparative evaluation section 84 outputs the result of the comparison to the output section 30. Also, the comparative evaluation section 84 performs a relative comparison between the number of patent rights of one's company with the number of patent rights of other companies. By doing so, the strength of the patent rights of each company or the like is analyzed. The comparative evaluation section 84 outputs the result of the comparison to the output section 30.

<2. Operation Flow>

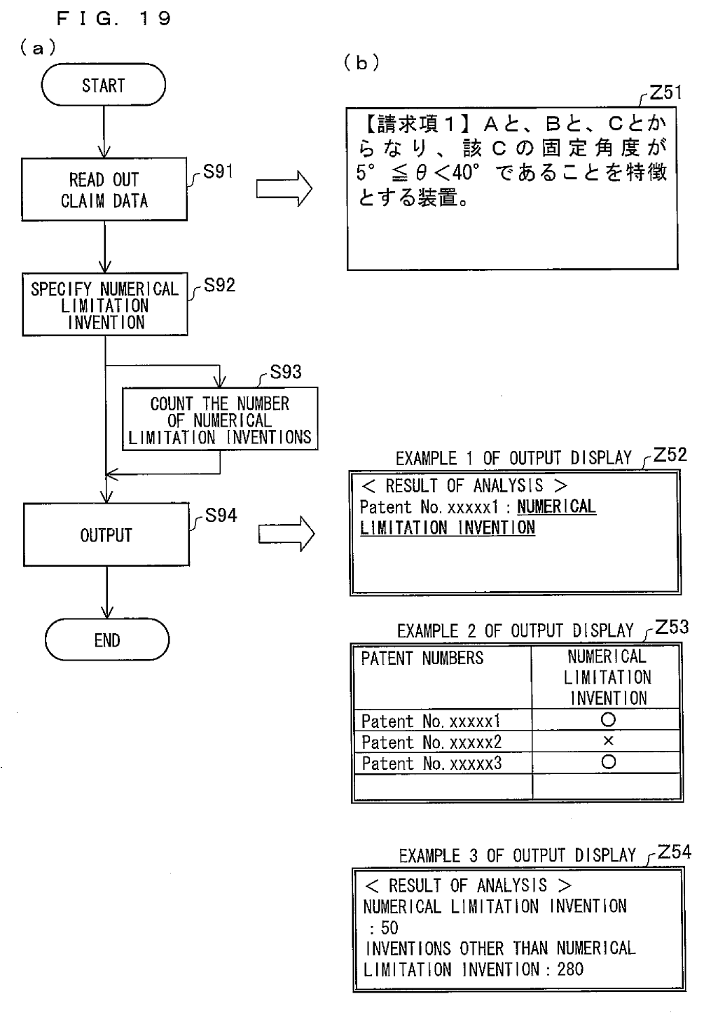

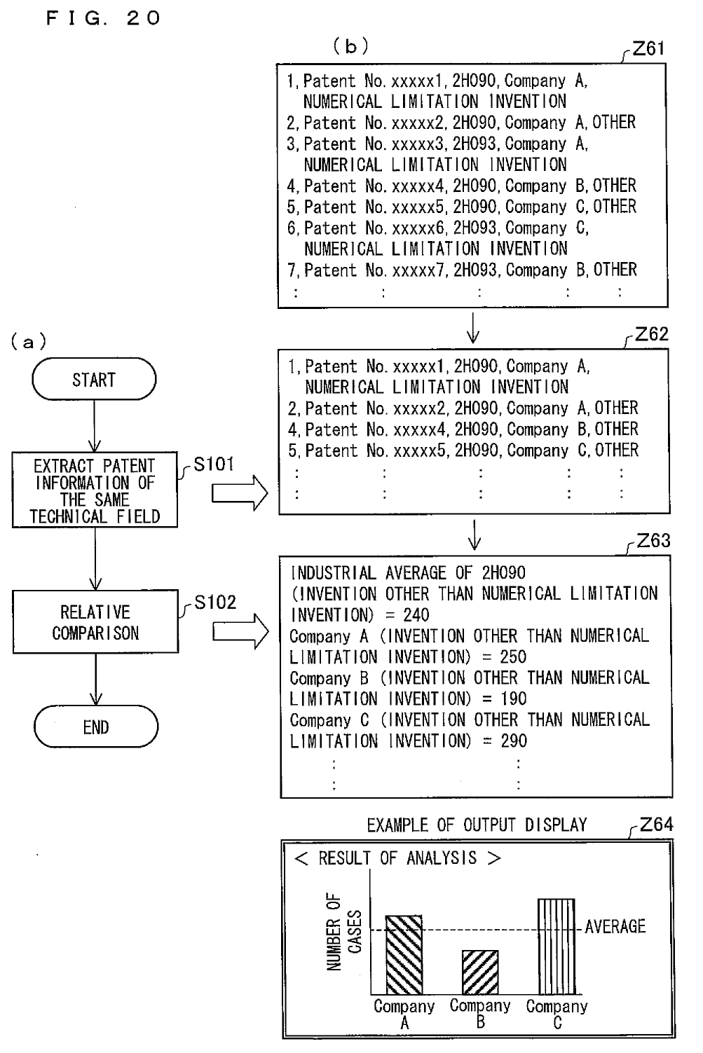

The following will describe how the patent information analyzing apparatus 13a operates, with reference to FIG. 19 and FIG. 20. FIG. 19 illustrates the operation of the patent information analyzing apparatus 13a of Fifth Embodiment. The (a) part of FIG. 19 is a flowchart showing how the patent information analyzing apparatus 13a operates. The (b) part of FIG. 19 shows examples of text data processed by the patent information analyzing apparatus 13a and a result of analysis to be output. As shown in the figure, the user inputs a patent number of the target of analysis by using the input section 20. Based on the patent number thus input, the numerical limitation invention judging section 64 reads out a set of patent specification data having the patent number from the storage section 40 (S91).

As shown in the (b) part of FIG. 19, in the present embodiment, the numerical limitation invention judging section 64 reads out text data indicated by Z51 from the storage section 40. In other words, the numerical limitation invention judging section 64 reads out text data of [1] including the character string “A [symbol] B [symbol] C [symbol] C [symbol] 5°≦θ<40° [symbol] [symbol] ”.

Subsequently, the numerical limitation invention judging section 64 judges the type of the invention recited in the claim which is the target of analysis (S92). In doing so, the numerical limitation invention judging section 64 checks the character strings in the claim. In the example shown in the (b) part of FIG. 19, the claim includes “°”, “≦”, and “<”. All of these character strings indicate that there is a numerical limitation. The numerical limitation invention judging section 64 therefore judges that the invention pertaining to the claim is a numerical limitation invention. The numerical limitation invention judging section 64 performs this process with respect to each of plural sets of patent specification data, and outputs the result of the analysis to the numerical limitation invention quantity counting section 74 and the comparative evaluation section 84.

Receiving the result of the analysis by the numerical limitation invention judging section 64, the numerical limitation invention quantity counting section 74 counts the number of inventions of each type of inventions (S93). In the example shown in the (b) part of FIG. 19, there are 50 numerical limitation inventions and 280 inventions which are unrelated to numerical limitations. The numerical limitation invention quantity counting section 74 outputs the result of the counting to the output section 30.

The output section 30 then outputs the result of the analysis (S94). In doing so, the output section 30 outputs the result of the analysis indicated by Z52. In the example shown in Z52, the output section 30 shows that the patent with the patent number “xxxxx1” is a numerical limitation invention.

When plural sets of patent specification data are analyzed, the output section 30 outputs the result of the analysis indicated by Z53 to the output device. In the example shown in Z53, the sign “∘” indicates a numerical limitation invention whereas the sign “x” indicates an invention without a numerical limitation. In other words, the output section 30 outputs a table in which patent numbers of inventions are associated with the types thereof.

As a result, in the example of Z53, the output device indicates that the patent number “xxxxx1” is an numerical limitation invention by monitor display, printout, or the like. The output device also indicates that the patent number “xxxxx2” is an invention without a numerical limitation, by monitor display, printout, or the like. The output device also indicates that the patent number “xxxxx3” is an numerical limitation invention, by monitor display, printout, or the like.

The output section 30 outputs, to the output device, the result of the counting by the numerical limitation invention quantity counting section 74. In doing so, the output section 30 outputs the result of the analysis indicated by Z54. That is to say, the output section 30 outputs the total number of numerical limitation inventions and the total number of inventions without numerical limitations. In the example shown in the (b) part of FIG. 19, the output of the output section 30 shows that there are 50 numerical limitation inventions and there are 280 inventions without numerical limitations.

Now, referring to FIG. 20, the following will describe a case where the patent information analyzing apparatus 13a analyzes sets of patent specification data belonging to the same technical field and compares one another. FIG. 20 illustrates how the patent information analyzing apparatus 13a of Fifth Embodiment operates. The (a) part of FIG. 20 is a flowchart showing the operation of the patent information analyzing apparatus 13a. The (b) part of FIG. 20 shows examples of text data processed by the patent information analyzing apparatus 13a and a result of analysis to be output.

Based on a patent number which has been input, the numerical limitation invention judging section 64 reads out a set of patent data with this patent number from the storage section 40. The numerical limitation invention judging section 64 performs the aforesaid analysis so as to specify the type of the invention recited in the claim of the set of patent specification data. Furthermore, the numerical limitation invention judging section 64 extracts the F term and applicant from each set of patent specification data (S101). As a result of this, the numerical limitation invention judging section 64 generates data with the format indicated by Z61 in the (b) part of FIG. 20. The generated data is arranged such that serial numbers starting from 1, patent numbers, F terms, applicants, and the types of inventions (numerical limitation invention or not) are associated with one another. The data generated by the numerical limitation invention judging section 64, which is shown in the (b) part of FIG. 20, is arranged such that the items are separated by commas and sets of data for respective cases are separated by line feed characters.

Based on the text data indicated by Z61 in the (b) part of FIG. 20, the comparative evaluation section 84 performs a relative comparison between sets of patent specification data (S102). First, as indicated by Z62 in the (b) part of FIG. 20, the comparative evaluation section 84 extracts all sets of line data with the F term “2H090”. Furthermore, as indicated by Z63 in the (b) part of FIG. 20, the comparative evaluation section 84 counts the number of inventions without numerical limitations of each applicant. In this example, the comparative evaluation section 84 determines that the company A owns 250 inventions without numerical limitations, the company B owns 190 inventions without numerical limitations, and the company C owns 290 inventions without numerical limitations,

Furthermore, the comparative evaluation section 84 calculates the industrial average of inventions without numerical limitations. In the present case, the comparative evaluation section 84 determines that the industrial average of inventions without numerical limitations is 240.

As indicated by Z64 in the (b) part of FIG. 20, the output section 30 outputs, to the output device, a graph indicating the number of inventions without numerical limitations of each applicant. As a result, the output device outputs the graph of Z64 in the form of monitor display, printout, or the like. In doing so, as indicated by the dotted line in the figure, the industrial average is also indicated. This graph allows the user to understand at a glance the number of patent rights of each applicant. It is therefore possible to perform a relative comparison between the applicants. Sets of patent specification data are analyzed fairly and with a high reliability.

The patent information analyzing apparatus 13a may determine the type of an invention recited in a claim by a method other than the above. In other words, another judging technique by which the type of an invention can be judged may be adopted. For example, the type of an invention may be judged by detecting whether the character strings constituting the claim includes a character string such as [ [symbol] ] which indicates a numerical expression. The signs “[ ]” are brackets which are a pair of control signs included in patent specifications.

<3. Summary>

As discussed above, according to the present embodiment, the type of the invention recited in a claim is determined, and also whether the invention is a numerical limitation invention is determined. This makes it possible to precisely analyze whether the invention is easily exercisable.

### Sixth Embodiment

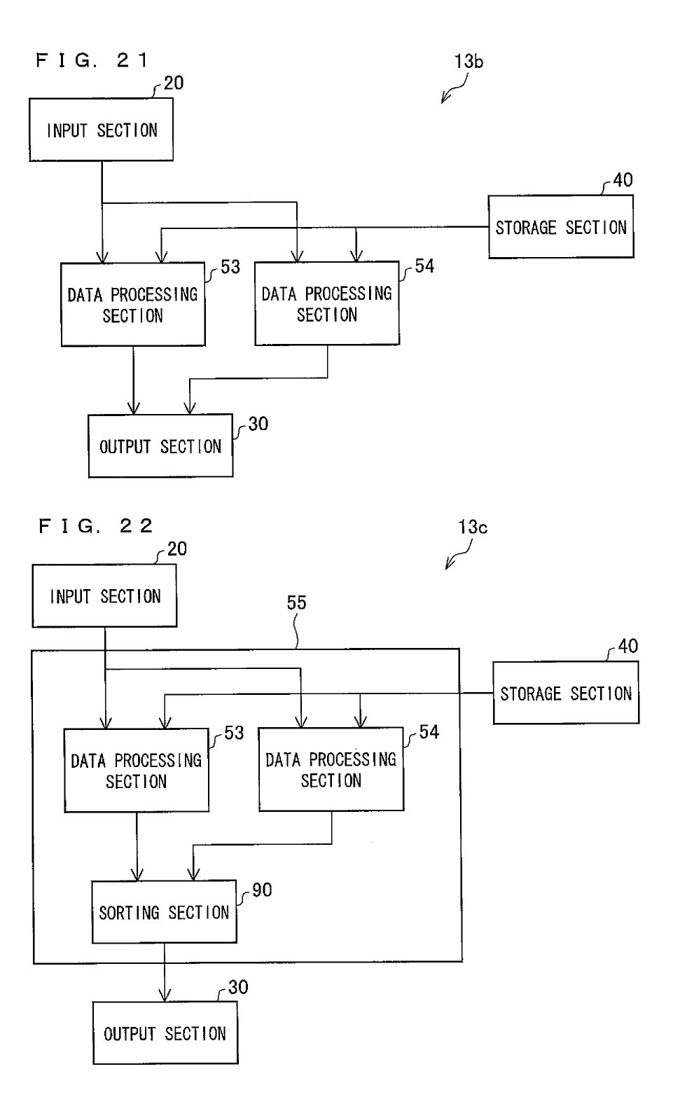

The following will describe Sixth Embodiment of the present invention with reference to FIG. 21.

The patent information analyzing apparatus 13b of the present embodiment judges whether the invention recited in a claim of a set of patent specification data is a product invention or a method invention. The patent information analyzing apparatus 13b further judges whether the invention is a numerical limitation invention or not. In other words, the patent information analyzing apparatus 13b is arranged such that the patent information analyzing apparatus 13 of Fourth Embodiment is combined with the patent information analyzing apparatus 13a of Fifth Embodiment.

<Apparatus Configuration>

The following will describe the patent information analyzing apparatus 13b of the present embodiment with reference to FIG. 21. FIG. 21 is a block diagram showing the patent information analyzing apparatus 13b of Sixth Embodiment. As shown in the figure, the patent information analyzing apparatus 13b includes an input section 20, an output section 30, a storage section 40, a data processing section 53, and a data processing section 54.

These sections are identical those of the patent information analyzing apparatus 13 or the patent information analyzing apparatus 13a, and hence detailed explanations are omitted.

<2. Operation Flow>

The following will discuss how the patent information analyzing apparatus 13b operates. First, the user inputs a patent number of a patent to be analyzed, through the input section 20. Based on the patent number thus input, the data processing section 53 and the data processing section 54 reads out the set of patent specification data with this patent number, from the storage section 40. Then the data processing section 53 judges whether the invention pertaining to the claim is a product invention or a method invention. Furthermore, the data processing section 54 judges whether or not the invention pertaining to the claim is a numerical limitation invention. The data processing section 53 and the data processing section 54 output the result of the analysis to the output section 30.

On account of the above, the patent information analyzing apparatus 13b can precisely determine whether the invention pertaining to the claim is easily exercisable.

In the present embodiment, the data processing section 53 and the data processing section 54 analyze text data concurrently with the above. Not limited to this, the patent information analyzing apparatus 13b may be arranged such that the data processing section 54 performs analysis after the data processing section 53 analyzes text data. Conversely, the data processing section 53 may perform analysis after the data processing section 54 analyzes text data

### Seventh Embodiment

The following will describe Seventh Embodiment of the present invention with reference to FIG. 22.

The patent information analyzing apparatus 13c of the present embodiment judges whether an invention recited in a claim of a set of patent specification data is a product invention or a method invention. The patent information analyzing apparatus 13c further judges whether or not the invention is a numerical limitation invention. In addition, the patent information analyzing apparatus 13c sorts out results of analysis of plural sets of patent specification data.

<Apparatus Configuration>

The following will describe the patent information analyzing apparatus 13c of the present embodiment with reference to FIG. 22. FIG. 22 is a block diagram showing the patent information analyzing apparatus 13c of Seventh Embodiment. As shown in the figure, the patent information analyzing apparatus 13c includes an input section 20, an output section 30, a storage section 40, and a data processing section 55.

Among these members, the input section 20, the output section 30, and the storage section 40 are identical with those shown in FIG. 15, and hence the explanations are omitted.

Details of the data processing section 55 will be given. As shown in FIG. 22, the data processing section 55 includes a data processing section 53, a data processing section 54, and a sorting section 90 (sorting means). Among these members, the data processing section 53 and the data processing section 54 are identical with those of the patent information analyzing apparatus 13b of Sixth Embodiment and hence the explanations are omitted.

The sorting section 90 appropriately sorts the results of analysis of sets of patent specification data into those likely to be easily exercisable and those unlikely to be easily exercisable, based on the result of analysis by the data processing section 53 and the result of analysis by the data processing section 54. For example, the sorting section 90 classifies, based on the results of the analysis, inventions which are product inventions and unrelated to numerical limitations as inventions which are easily exercisable. On the other hand, based on the results of the analysis, the sorting section 90 classifies inventions which are both method inventions and numerical limitation inventions as those cannot be easily exercisable.

<2. Operation Flow>

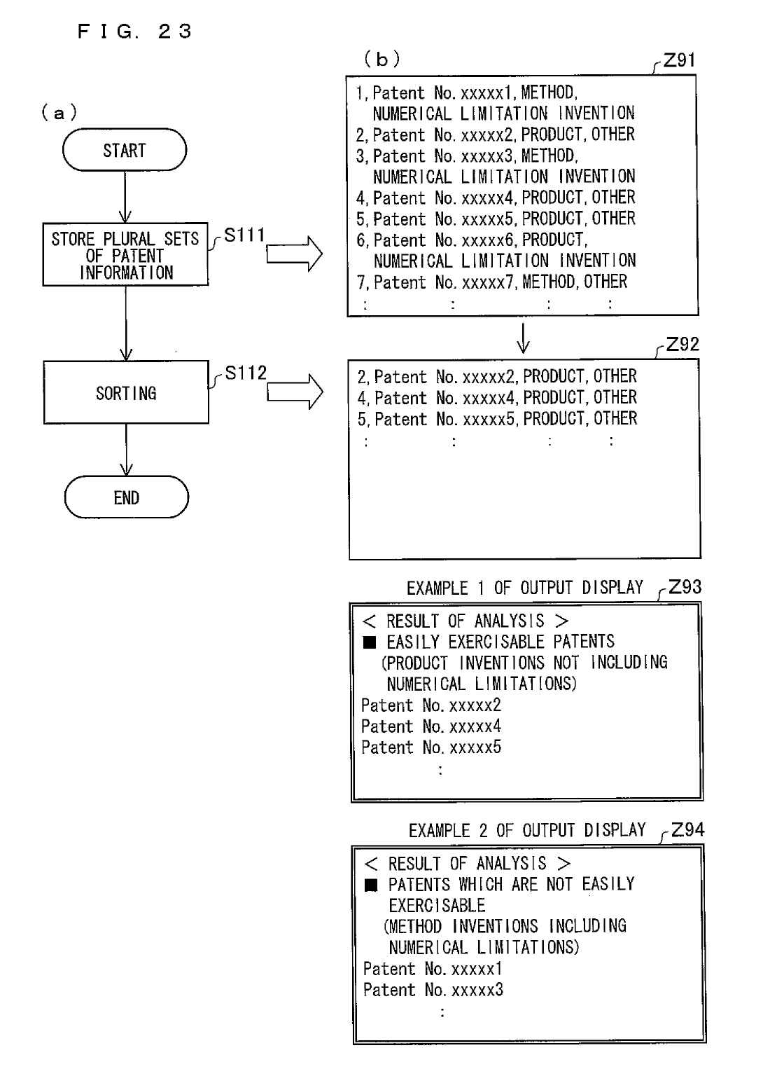

The following will explain how the patent information analyzing apparatus 13c operates, with reference to FIG. 23. the user inputs a patent number of the target of analysis through the input section 20. Based on the patent number thus input, the data processing section 53 and the data processing section 54 reads out the set of patent specification data with this patent number from the storage section 40. Then the data processing section 53 judges whether the invention pertaining to the claim is a product invention or a method invention. Furthermore, the data processing section 54 judges whether or not the invention pertaining to the claim is a numerical limitation invention. The data processing section 53 and the data processing section 54 output the result of the analysis to the sorting section 90.

The sorting section 90 tabulates the results of the analysis thus input into the text data with the format indicated by Z91 in the (b) part of FIG. 23 (S111). That is, the sorting section 90 generates data which is arranged such that serial numbers starting from 1, patent numbers, item indicating product invention or method invention, and item indicating numerical limitation invention or not are associated with one another. In the text data indicated by Z91, “Product” indicates a product invention, whereas “Method” indicates a product invention. Also, “Numerical Value” indicates a numerical limitation invention. What is indicated by “Others” is an invention without a numerical limitation. The data shown in the (b) part of FIG. 23, which is generated by the sorting section 90, is arranged such that items are separated by commas and sets of data for respective cases are separated by line feed characters.

The sorting section 90 find out inventions which are easily exercisable, from the text data indicated by Z91 (S112). That is, as indicated by Z92, the sorting section 90 extracts the line data of an invention which is a product invention and does not include a numerical limitation. That is to say, the sorting section 90 extracts sets of data with the serial numbers 2, 4, and 5 as inventions which are easily exercisable. The sorting section 90 outputs the result of the sorting to the output section 30.

The output section 30 classifies the result of the sorting by the sorting section 90 into inventions which are easily exercisable and inventions which are not easily exercisable, and outputs the result to the output device. As a result, in the example shown in the (b) part of FIG. 23, as indicated by Z93, the output device shows, by monitor display, printout, or the like, a list of the patent numbers of patent specifications of inventions which are product inventions and do not include numerical limitations. Also, as indicated by Z94, the output device shows, by monitor display, printout, or the like, a list of the patent numbers of patent specifications of inventions which are both product inventions and numerical limitation inventions.

<3. Summary>

In this manner, the patent information analyzing apparatus 13c can extract information of inventions which are easily exercisable, from a large number of patent specifications. This allows the user to know how many important patent rights easily exercisable against other companies are owned by him/her, by checking the result of the analysis by the aforesaid apparatus.

In addition to the above, the patent information analyzing apparatus 13c can also extract information regarding inventions which are not easily exercisable, from a large number of patent specifications. This allows the user to efficiently take inventory of patent rights which are not easily exercisable, by checking the result of the analysis by the aforesaid apparatus. In other words, it is possible to efficiently find patent rights which are unnecessary and may be abandoned.

### <Supplemental Remarks of Fourth to Seventh Embodiments>

In Fourth to Seventh Embodiments, the patent information analyzing apparatus analyzes patent specification data. Not limited to this, the target of analysis may be utility model specification data. In other words, patent information in the present invention includes patent specification data and utility model specification data.

In the invention type judging section 63, an invention in which a character string indicating a method invention is not recited in a claim is preferably regarded as a product invention. In doing so, the invention type judging section 63 judges that an invention which is not identified as a method invention is a product invention. That is to say, if a claim includes a character string indicating a method invention, the invention pertaining to the claim is typically determined as a method invention almost certainly. Therefore, the patent information analyzing apparatus regards other types of inventions as product inventions, and hence it is possible to certainly determine that an invention recited in a claim is a product invention.

In Fourth to Seventh Embodiments, the patent information analyzing apparatus analyzes only claim 1. The present invention, however, is not limited to this arrangement. All claims may be chosen as the targets of analysis, and in such a case inventions pertaining to independent claims are preferably chosen as the targets of analysis. The number of limitations in independent claims is typically fewer than the number inventions in dependent claims. It is therefore preferable to determine the type of the invention pertaining to an independent claim. Whether a claim is independent or dependent may be determined by, for example, checking the character strings constituting the claim. That is to say, a dependent claim includes the character strings citing another claim, such as “ [symbol] [symbol] 1 [symbol] 3 [symbol] ”, and the character string “ [symbol] ” is always included. On the other hand, not citing another claim, an independent claim does not include the character string “ [symbol] ”. It is therefore possible to judge whether a claim is independent or dependent by checking whether the character string “ [symbol] ” is included in the character strings constituting the claim.

In Fourth to Seventh Embodiments, the patent information analyzing apparatus judges whether two sets of patent specification data are patent information of the same technical field, with reference to IPC, FI, F term, US Class, or the like. Alternatively, the patent information analyzing apparatus may optionally determine whether plural sets of patent specification data are patent information of the same technical field, by means of keyword search or the like. In this case, whether sets of patent specification data are patent information of the same technical field is determined based on the result of keyword search.

### Eighth Embodiment

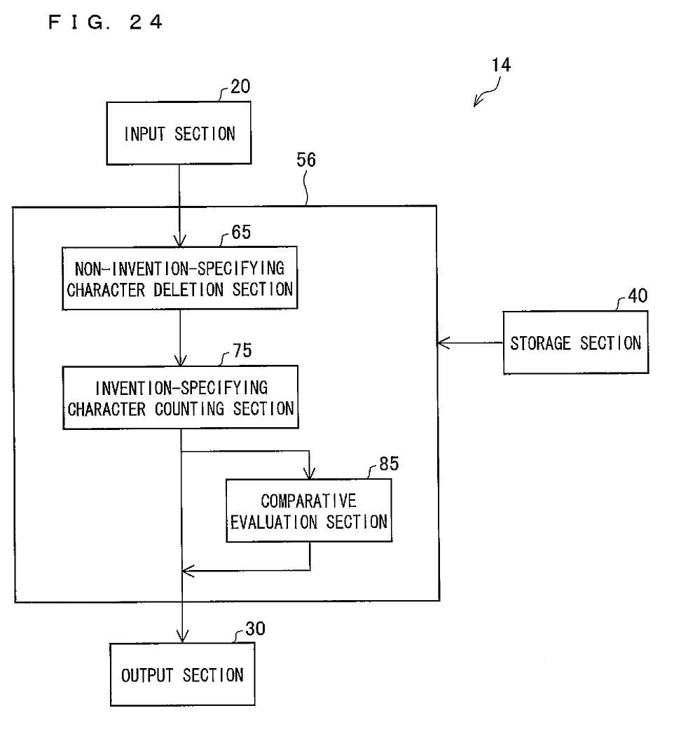

The following will explain an embodiment of the present invention with reference to FIGS. 24-27.

<Apparatus Configuration>

The following will describe a patent information analyzing apparatus 14 of the present embodiment with reference to FIG. 24. FIG. 24 is a block diagram showing the patent information analyzing apparatus 14 of Eighth Embodiment. As shown in the figure, the patent information analyzing apparatus 14 includes an input section 20, an output section 30 (output means), a storage section 40, and a data processing section 56.

The input section 20, the output section 30, and the storage section 40 are identical with those in First Embodiment and hence the explanations are omitted.

The data processing section 56 analyzes a set of patent specification data having a patent number input through the input section 20. In doing so, the data processing section 56 reads out, from the storage section 40, the set of patent specification data having the patent number thus input. In particular, the data processing section 56 reads out claim data of the set of patent specification data. In the present embodiment, the data processing section 56 reads out claim data of a set of patent specification data, as Japanese text data. The data processing section 56 stores the text data in a work memory which is not illustrated. The data processing section 56 therefore analyzes the text data stored in the non-illustrated work memory.

Details of the data processing section 56 will be given. As shown in FIG. 24, the data processing section 56 includes a non-invention-specifying character deletion section 65 (character string comparison means, non-invention-specifying character deletion means), an invention-specifying character counting section 75 (invention-specifying character counting means), and a comparative evaluation section 85 (third comparative evaluation means).

The non-invention-specifying character deletion section 65 extracts an invention feature non-specifying character in a claim of a set of patent specification data and deletes the extracted character. Invention feature non-specifying characters are formal words which do not directly specify an invention recited in a claim. Examples of invention feature non-specifying characters include symbols, reference terms, and formal character strings.

Examples of symbols in Japanese specifications include “pause mark ( [symbol] )”, “full stop ( [symbol] )”, comma “(,)”, “semicolon (;)”, “colon (:)”, and “space”.

The reference terms in Japanese specifications refer to a preceding word or a subsequent word. Examples of reference terms include “ [symbol] ”, “ [symbol] ”, “ [symbol] ”, “ [symbol] ”, “ [symbol] ”, and “ [symbol] ”.

The formal character strings in Japanese specifications are used in claims only for formal reasons, and do not function as words specifying an invention. Examples of such formal character strings include “ [symbol] [symbol] ”, “ [symbol] [symbol] ”, and “ [symbol] [symbol] ”.

The patent information analyzing apparatus 14 stores in advance such invention feature non-specifying characters in a ROM (Read Only Memory: not illustrated). The non-invention-specifying character deletion section 65 therefore reads out the data from the ROM and use it for pattern matching. The storage medium where invention feature non-specifying characters are stored in advance may be a CD-ROM, a DVD-ROM, or a hard disc.

The non-invention-specifying character deletion section 65 reads out invention feature non-specifying characters from the ROM, and then the non-invention-specifying character deletion section 65 compares character strings in a claim of the target of analysis with the invention feature non-specifying characters read out from the ROM, so as to extract an invention feature non-specifying character from the claim. Then the non-invention-specifying character deletion section 65 deletes at least one of the invention feature non-specifying character in the claim. The non-invention-specifying character deletion section 65 outputs the claim data after the deletion of the invention feature non-specifying character to the invention-specifying character counting section 75.

The invention-specifying character counting section 75 counts the number of characters in the claim thus input. That is to say, the invention-specifying character counting section 75 counts the number of characters in the claim in which at least one of the invention feature non-specifying characters has been deleted. By doing so, the invention-specifying character counting section 75 counts the number of characters in the claim which is the target of analysis. The invention-specifying character counting section 75 outputs the result of the counting to the output section 30.

In text data with the JIS character code, one full-width character is typically made of 2 bytes. The invention-specifying character counting section 75 therefore counts the number of characters in the claim in which at least one of the invention feature non-specifying characters has been deleted, by, for example, counting the bytes in the text data which is the target of analysis. Alternatively, the invention-specifying character counting section 75 may count the number of characters in the claim by a method different from the aforesaid counting of bytes.

The comparative evaluation section 85 compares sets of patent specification data of the same technical field with one another. More specifically, the comparative evaluation section 85 compares a set of patent specification data of a specific technical field with a set of patent specification data of the same field, so as to perform evaluation. Sets of patent specification data belonging to the same field in this case are those having a substantially identical patent classification symbol.

The comparative evaluation section 85 receives a patent classification symbol of a field to be processed. The comparative evaluation section 85 processes a patent classification symbol in the same manner as the comparative evaluation section 83 of Fourth Embodiment, and hence the explanation is omitted.

As such, the comparative evaluation section 85 performs a relative comparison between the scopes of the inventions recited in the claims of plural sets of patent specification data. For example, the comparative evaluation section 85 determines that the patent right of an invention recited in a claim having a fewer number of characters is wider in terms of the scope of right than the patent right of an invention recited in a claim having a larger number of characters. The comparative evaluation section 85 outputs the result of the comparison to the output section 30. Also, the comparative evaluation section 85 performs a relative comparison between the number of patent rights of one's company and the numbers of patent rights of other companies. By doing so, the strength of the patent rights of each company or the like is analyzed.

<2. Operation Flow>

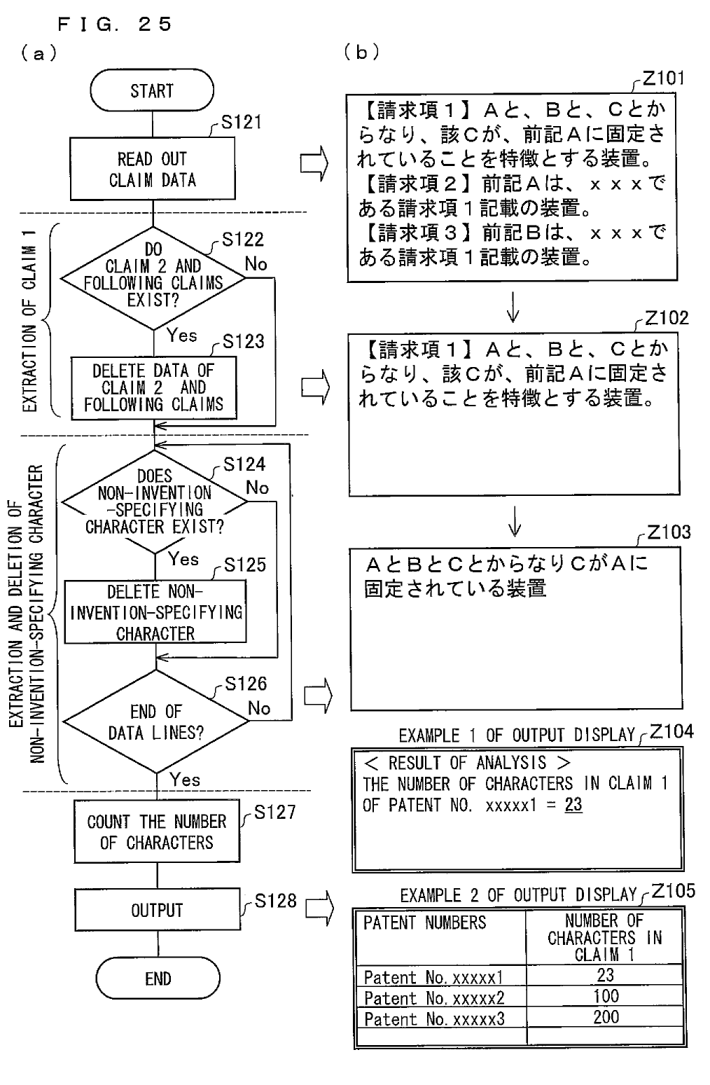

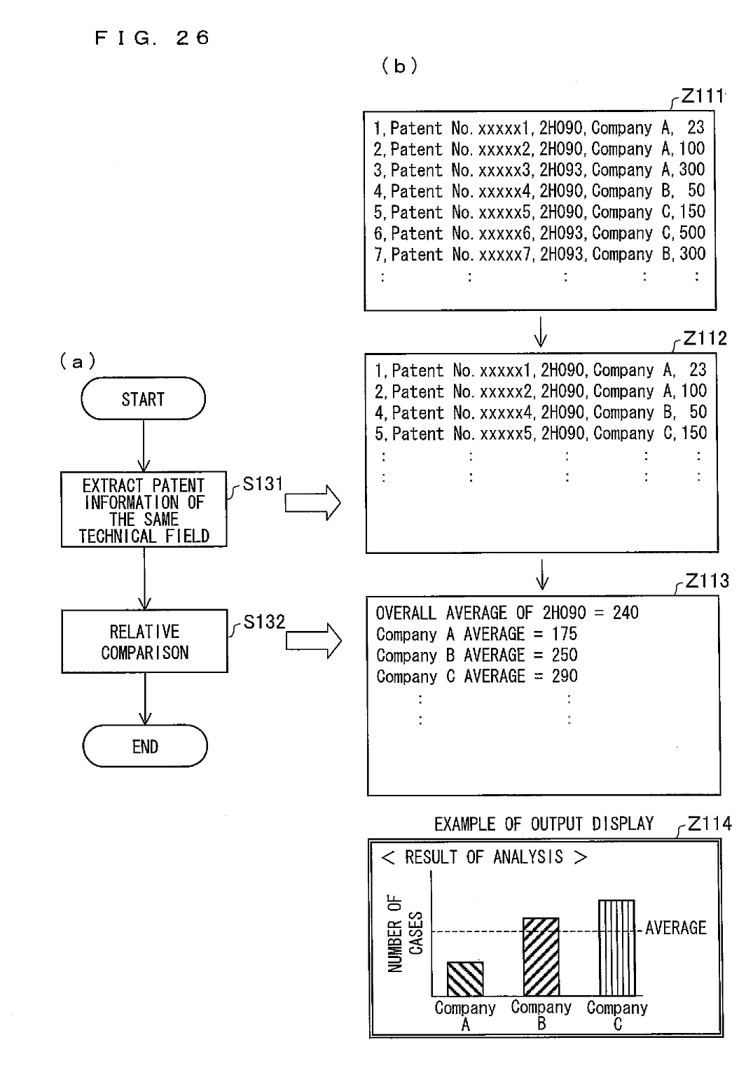

The following will describe how the patent information analyzing apparatus 14 operates, with reference to FIG. 25 and FIG. 26. FIG. 25 illustrates the operation of the patent information analyzing apparatus 14 of Eighth Embodiment. The (a) part of FIG. 25 is a flow chart of the operation of the patent information analyzing apparatus 14. The (b) part of FIG. 25 shows examples of text data processed by the patent information analyzing apparatus 14 and a result of analysis to be output. The user inputs a patent number of the target to be analyzed, through the input section 20. Based on the patent number thus input, the data processing section 56 reads out a set of patent specification number (claims in particular) having the patent number from the storage section 40 (S121).

Subsequently, the non-invention-specifying character deletion section 65 extracts, from the claim data of the Japanese patent specification thus read out, claim 1 which is an independent claim. As indicated in the (b) part of FIG. 25, in the present embodiment, the non-invention-specifying character deletion section 65 reads out the text data indicated by Z101 from the storage section 40. That is, the text data of claims including the following character strings.

[ [symbol] 1]A [symbol] B [symbol] C [symbol] , [symbol] C [symbol] A

[symbol]

[symbol]

[symbol]

[ [symbol] 2] [symbol] A [symbol] xxx [symbol] 1

[symbol]

[ [symbol] 3] [symbol] B [symbol] xxx [symbol] 1

[symbol]

Then the non-invention-specifying character deletion section 65 judges whether text data of claim 2 and following claims exists in the claim data thus read out (S122). For example, it is judged whether the character string “[ [symbol] ]2]” exists in the claim data. The signs “[” and “]” are brackets which are a pair of control signs included in patent specifications. If the judgment in S122 is “true”, the non-invention-specifying character deletion section 65 deletes the text data of claim 2 and following claims from the claim data of the target of analysis (S123). As a result of this, the non-invention-specifying character deletion section 65 extracts the text data of claim 1 which is an independent claim. On the other hand, if the judgment in S122 is “false”, the non-invention-specifying character deletion section 65 skips the process in S123.

As a result of the above, the non-invention-specifying character deletion section 65 obtains the text data indicated by Z102. Subsequently, the non-invention-specifying character deletion section 65 processes the text data of a claim including the following character strings.

[ [symbol] 1]A [symbol] B [symbol] C [symbol] , [symbol] C [symbol] A

[symbol]

[symbol]

[symbol]

Then the non-invention-specifying character deletion section 65 judges whether the text data of Z102 includes an invention feature non-specifying character (S124). If the judgment is “true”, the non-invention-specifying character deletion section 65 deletes the invention feature non-specifying character from the text data of claim 1 (S125). Deleting the invention feature non-specifying character, the non-invention-specifying character deletion section 65 judges whether the data which is currently processed is the end of the data lines of claim 1 (S126). If the judgment is “false”, the non-invention-specifying character deletion section 65 resumes the process in S124. On the other hand, if the judgment is “true”, the non-invention-specifying character deletion section 65 outputs the text data from which the invention feature non-specifying character has been removed to the invention-specifying character counting section 75.

As indicated in the (b) part of FIG. 25, the text data of Z102 includes invention feature non-specifying characters such as “pause mark ( [symbol] )”, “full stop ( [symbol] )”, “ [symbol] ”, “ [symbol] ”, and “ [symbol] [symbol] ”. The non-invention-specifying character deletion section 65 extracts these invention feature non-specifying characters and remove them from the text data which is the processing target. By doing so, the non-invention-specifying character deletion section 65 generates the text data indicated by Z103, from which the invention feature non-specifying characters have been removed. As indicated by Z103, this text data includes only important character strings representing the constituent feature of the invention recited in the claim.

The non-invention-specifying character deletion section 65 outputs, to the invention-specifying character counting section 75, the text data indicated by Z103, i.e. the text data of claim 1 from which invention feature non-specifying characters have been removed. The invention-specifying character counting section 75 counts the number of characters in the text data thus input. In the present example, the invention-specifying character counting section 75 determines that the number of characters in claim 1 is 23. The invention-specifying character counting section 75 outputs the result of the counting to the output section 30.

Subsequently, the output section 30 outputs the result of the counting by the invention-specifying character counting section 75 to the output device (S128). In response to this, the output device outputs the result of the counting indicated by Z104, by monitor display, printout, or the like. In other words, the output device indicates, by monitor display, printout, or the like, that 23 characters are included in claim 1 of the patent specification with the patent number “xxxxx1”.

When plural sets of patent specification data are analyzed, the output section 30 outputs the result of the analysis indicated by Z105 to the output device. That is, the output section 30 outputs a table in which patent numbers of plural inventions are associated with the characters of claims 1 of the patent specifications having the respective patent numbers. As a result, in the case of Z105, the output device indicates that the number of characters in the patent specification with the patent number “xxxxx1” is 23, by monitor display, printout, or the like. Furthermore, the output device indicates that the number of characters in the patent specification with the patent number “xxxxx2” is 100, by monitor display, printout, or the like. Furthermore, the output device indicates that the number of characters in the patent specification with the patent number “xxxxx3” is 200, by monitor display, printout, or the like.

Subsequently, referring to FIG. 26, the following will describe a case where the patent information analyzing apparatus 14 analyzes and compares sets of patent specification data of the same field with one another. FIG. 26 illustrates the operation of the patent information analyzing apparatus 14 of Eighth Embodiment. The (a) part of FIG. 26 is a flowchart showing how the patent information analyzing apparatus 14 operates. The (b) part of FIG. 26 shows examples of text data processed by the patent information analyzing apparatus 14 and a result of analysis to be output.

Based on the patent number thus input, the data processing section 56 reads out a set of patent specification data having this patent number from the storage section 40. By the aforesaid analysis, the non-invention-specifying character deletion section 65 removes invention feature non-specifying characters from the character strings in claim 1 of the set of patent specification data. The invention-specifying character counting section 75 counts the number of characters in claim 1. Furthermore, the invention-specifying character counting section 75 extracts the F term and applicant from each set of patent specification data. By doing so, the invention-specifying character counting section 75 generated the data with the format indicated by Z111 in the (b) part of FIG. 26. The generated data is arranged such that reference numbers starting from 1, patent numbers, F terms, applicants, and the numbers of characters in claims 1 are associated with one another. The data shown in the (b) part of FIG. 26, which is generated by the invention-specifying character counting section 75, is arranged such that items are separated by commas and sets of data for respective cases are separated by line feed characters.

Based on the data of Z111 in the (b) part of FIG. 26, the comparative evaluation section 85 performs a relative comparison between plural sets of patent specification data. First, the comparative evaluation section 85 extracts all sets of line data having the F term “2H090”, as indicated by Z112 in the (b) part of FIG. 26. Also, as indicated by Z113 in the (b) part of FIG. 26, the comparative evaluation section 85 calculates the average of the characters of each applicant. In this example, the comparative evaluation section 85 determines that the average of the characters in claims 1 of the company A is 175, the average of the characters of the company B is 250, and the average of the number of the characters of the company C is 290.

The comparative evaluation section 85 further calculates the industry average of the characters in claims 1 (i.e. the average of the characters of sets of patent specification data having the same F term). In the present example, the comparative evaluation section 85 determines that the industry average of the characters is 240. The industry average may be calculated in such a manner that the average of sets of patent specification data belonging to the same F term and applicant is calculated, and the average is further calculated. In the present embodiment, the targets of analysis are sets of patent specification data belonging to the technical field indicated by F term “2H090a” patent specification data. This technical field is liquid crystal displays.

As indicated by Z114 in the (b) part of FIG. 26, the output section 30 produces a graph and outputs the same to the output device. This graph is arranged such that the averages of the characters in claims 1 of the patent specifications regarding the patent rights of the respective applicants are indicated. In doing so, as indicated by the dotted line in the figure, the industry average is concurrently output. In response to this, the output device outputs the graph of Z114 by monitor display, printout, or the like. The user can therefore understand at a glance the number of characters in claim 1 of each patent right of each applicant. It is therefore possible to easily perform a relative comparison between comprehensive capabilities in patent matters between applicants. Sets of patent specification data are analyzed fairly and with a high reliability.

### Ninth Embodiment

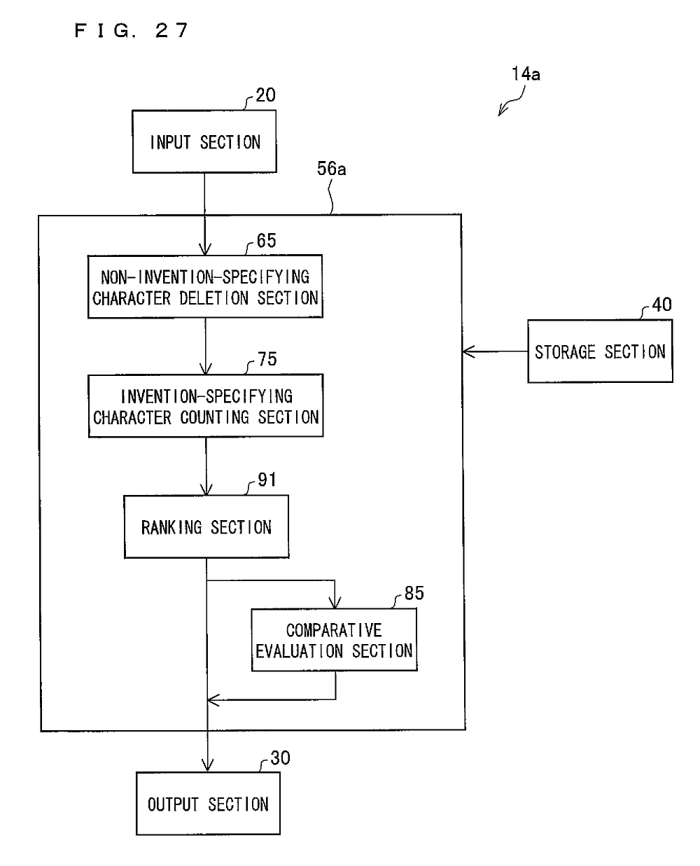

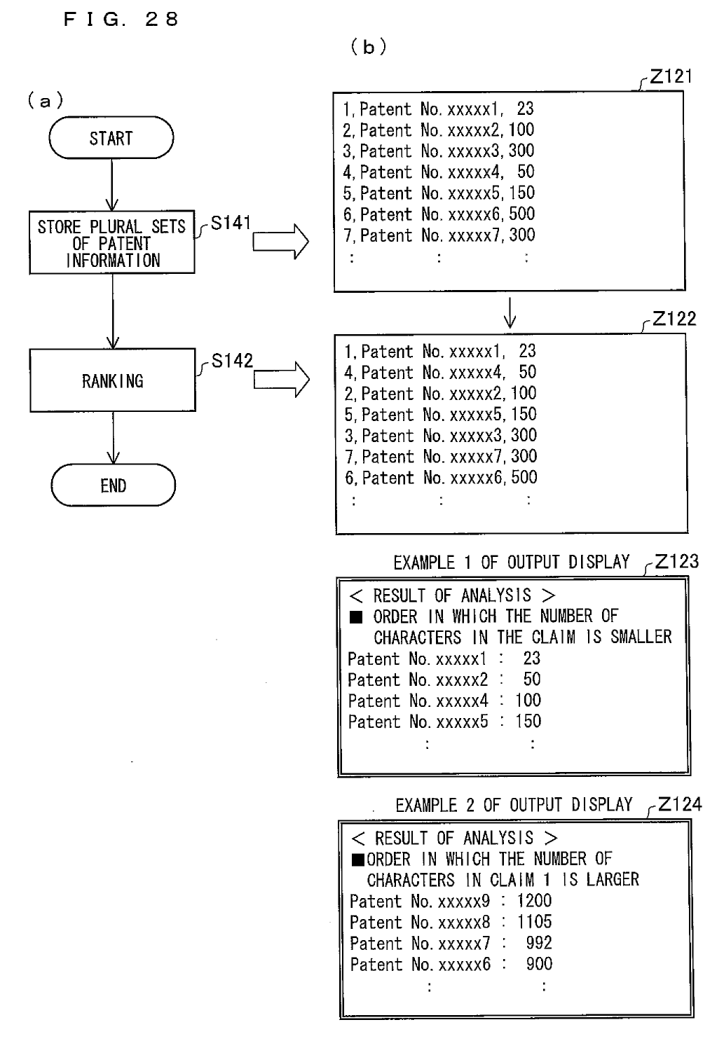

The following will explain Ninth Embodiment of the present invention with reference to FIG. 27 and FIG. 28.

The patent information analyzing apparatus 14a of the present embodiment ranks plural sets of patent specification data based on the number of characters in claim 1.

<Apparatus Configuration>

First, the following will explain the patent information analyzing apparatus 14a of the present embodiment, with reference to FIG. 27. FIG. 27 is a block diagram showing the patent information analyzing apparatus 14a of Ninth Embodiment. As shown in the figure, the patent information analyzing apparatus 14a includes an input section 20, an output section 30, a storage section 40, and a data processing section 56a.

Among these members, the input section 20, the output section 30, and the storage section 40 are identical with those shown in FIG. 24 and hence the explanations are omitted.

The following will explain the data processing section 56a with reference to FIG. 27. As shown in FIG. 27, the data processing section 56a includes a non-invention-specifying character deletion section 65 (character string comparison means, non-invention-specifying character deletion means), an invention-specifying character counting section 75 (invention-specifying character counting means), a ranking section 91 (ranking means), and a comparative evaluation section 85 (third comparative evaluation means).

Among these members, the non-invention-specifying character deletion section 65, the invention-specifying character counting section 75, and the comparative evaluation section 85 are identical with those shown in FIG. 24 and hence the explanations are omitted.

Based on the result of the counting by the invention-specifying character counting section 75, the ranking section 91 appropriately ranks the results of analysis of plural sets of patent specification data, in the order in which the number of characters in the claim is smaller. Alternatively, the results may be ranked in the order in which the number of characters in the claim is larger.

<2. Operation Flow>

The following will explain how the patent information analyzing apparatus 14a operates, with reference to FIG. 28. FIG. 28 illustrates the operation of the patent information analyzing apparatus 14a of Ninth Embodiment. The (a) part of FIG. 28 is a flowchart of the operation of the patent information analyzing apparatus 14a. The (b) part of FIG. 28 shows examples of text data processed by the patent information analyzing apparatus 14a and a result of analysis to be output.

The user inputs a patent number of the target of analysis through the input section 20. Based on the patent number thus input, the data processing section 56a reads out the set of patent specification data having this patent number from the storage section 40. Subsequently, the non-invention-specifying character deletion section 65 deletes invention feature non-specifying characters in claim 1. The non-invention-specifying character deletion section 65 sends the result of the analysis to the invention-specifying character counting section 75.

The invention-specifying character counting section 75 tabulates the results of the analysis thus input, as text data having the format indicated by Z121 in the (b) part of FIG. 28 (S141). That is the invention-specifying character counting section 75 generates data in which the reference numbers starting from 1, the patent numbers, and the numbers of characters in claims 1 are associated with one another.

The ranking section 91 processes text data indicated by Z121, which is stored in a work memory which is not illustrated. In doing so, the ranking section 91 suitably ranks the results of the analysis of sets of patent specification data, which are indicated by Z121, in the order in which the number of characters in the claim is smaller as indicated by Z122 (S142). Alternatively, the results are ranked in the order in which the number of characters in the claim is larger (S142). The ranking section 91 outputs the result of the ranking to the output section 30.

The output section 30 outputs the results of the analysis, which have been ranked by the ranking section 91, to the output device. Therefore, in the example of the (b) part of FIG. 28, the output device outputs, as monitor display, printout, or the like, the results of the analysis of the sets of patent specification data in the order in which the number of characters in the claim is smaller, as indicated by Z123. Furthermore, as indicated by Z124, the results of the analysis of the sets of patent specification data are output, in the form of monitor display, printout, or the like, the results of the analysis of the sets of patent specification data in the order in which the number of characters in claim 1 is larger.

<3. Summary>

In this manner, the patent information analyzing apparatus 14a can extract, from a lot of patent specifications, information regarding the strength of a patent right (i.e. the scope of a patent claim). The user can therefore efficiently sort many sets of patent specification data into necessary ones and unnecessary ones.

For example, the user can check patent rights in the order corresponding to the importance and ease of exercisability against other companies, by checking the information of patent specifications each having claim 1 with the fewer number of characters. Also, the user can check patent rights in the order corresponding to narrower scopes and difficulty in exercisability against other companies, by checking the information of patent specifications each having claim 1 with the larger number of characters. This allows the user to efficiently take inventory of patent rights which have narrow scopes and are not easily exercisable. In other words, it is possible to efficiently find patent rights which are unnecessary and may be abandoned.

### Tenth Embodiment

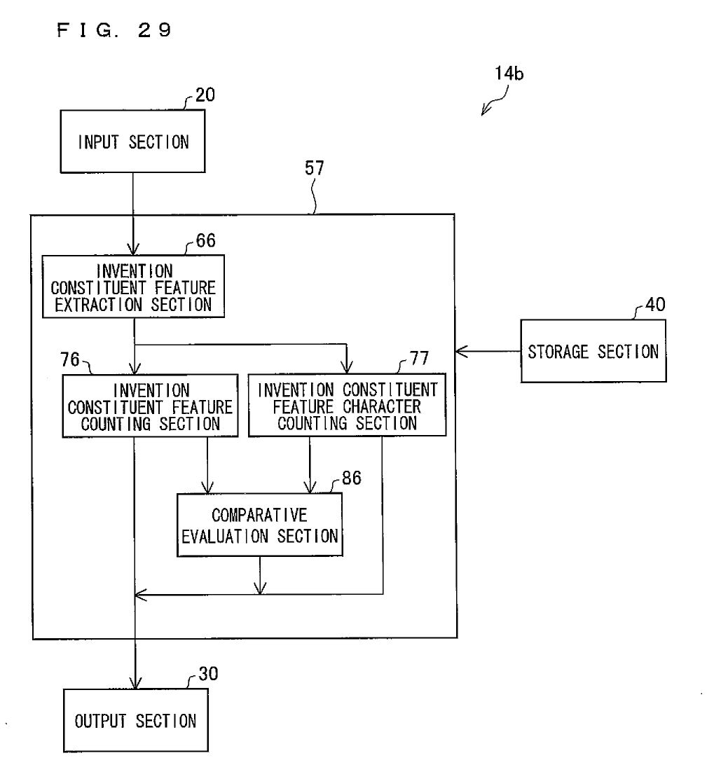

The following will explain Tenth Embodiment of the present invention with reference to FIG. 29 to FIG. 32.

The patent information analyzing apparatus 14b of the present embodiment extracts invention constituent features included in an independent claim of patent specification data, and counts the number of the extracted invention constituent features. Furthermore, the patent information analyzing apparatus 14b counts the number of characters in the extracted invention constituent features.

<Apparatus Configuration>

The following will explain the patent information analyzing apparatus 14b of the present embodiment with reference to FIG. 29. FIG. 29 is a block diagram showing the patent information analyzing apparatus 14b of Tenth Embodiment. As shown in the figure, the patent information analyzing apparatus 14b includes an input section 20, an output section 30, a storage section 40, and a data processing section 57.

Among these members, the input section 20, the output section 30, and the storage section 40 are identical with those shown in FIG. 24 and hence the explanations are omitted.

The following will describe the data processing section 57 with reference to FIG. 29. As shown in FIG. 29, the data processing section 57 includes an invention constituent feature extraction section 66 (character string comparison means, invention constituent feature extraction means), an invention constituent feature counting section 76 (invention constituent feature counting means), an invention constituent feature character counting section 77 (invention constituent feature character counting means), and a comparative evaluation section 86 (third comparative evaluation means).

The data processing section 57 analyzes a set of patent specification data having a patent number input through the input section 20. In doing so, the data processing section 57 reads out, from the storage section 40, the set of patent specification data having the patent number thus input. In particular, the data processing section 57 reads out the claim data of the set of patent specification data. In the present embodiment, the data processing section 57 reads out the claim data of the set of patent specification data, as Japanese text data. The data processing section 57 stores the text data in a work memory which is not illustrated. The data processing section 57 therefore analyzes the text data stored in the non-illustrated work memory.

The invention constituent feature extraction section 66 extracts, from the work memory, invention constituent features included in a claim of the set of patent specification data. In doing so, the invention constituent feature extraction section 66 extracts invention constituent features by means of a character search technique such as pattern matching. For example, in case where an independent claim of a Japanese patent specification which is the target of analysis includes the character strings “A [symbol] B [symbol] [symbol] ”, the invention constituent feature extraction section 66 extracts, from this claim, two invention constituent features “A” and “B”. More specifically, the invention constituent feature extraction section 66 extracts, as an invention constituent feature, the character string sandwiched between “ [symbol] ” and “ [symbol] ” or the character string sandwiched between “ [symbol] ” and “ [symbol] ”, from the claim text data. The aforesaid “ [symbol] ” is a character string constituted by the particle “ [symbol] ” and the pause mark “ [symbol] ”.

Alternatively, the invention constituent feature extraction section 66 performs the extraction by searching a line feed character in the text data. In case of text data with the ASCII character code, a control symbol indicating line feed is “LF (line feed)”. The invention constituent feature extraction section 66 therefore extracts the break between paragraphs by searching the claim data for the control symbol indicating a line feed. In this manner, the invention constituent feature extraction section 66 may extracts, as a single invention constituent feature, character strings in each paragraph.

The invention constituent feature extraction section 66 outputs, as text data, the invention constituent features extracted from the claim data to the invention constituent feature counting section 76 and the invention constituent feature character counting section 77.

The patent information analyzing apparatus 14b stores in advance predetermined invention constituent feature searching character strings such as “ [symbol] ” and “ [symbol] ” in a ROM which is not illustrated. The invention constituent feature extraction section 66 reads out this data from the ROM and uses it for pattern matching. The storage medium in which the invention constituent feature searching character strings are stored in advance may be a CD-ROM, a DVD-ROM, a hard disc, or the like.

The invention constituent feature counting section 76 counts the number of invention constituent features extracted by the invention constituent feature extraction section 66. In the meanwhile, the invention constituent feature character counting section 77 counts the number of characters in constituent features extracted by the invention constituent feature extraction section 66. In doing so, the invention constituent feature character counting section 77 counts the number of characters in the same manner as the invention-specifying character counting section 75 of Eighth Embodiment.

The comparative evaluation section 86 compares sets of patent specification data belonging to the same technical field with one another. More specifically, the comparative evaluation section 86 compares a set of patent specification data of a specific technical field with a set of patent specification data of the same field.

The comparative evaluation section 86 receives a patent classification symbol of the field to be analyzed. As the patent classification symbol, the comparative evaluation section 86 may use a patent classification symbol input by the user through the input section 20.

Alternatively, as the patent classification symbol, a patent classification symbol stored in advance in a work memory (not illustrated) may be used. Examples of patent classification symbols include IPC, FI, and F term in patent specification data. Based on a predetermined patent classification symbol, the comparative evaluation section 86 extracts the result of the analysis of the set of patent specification data indicated by the patent classification symbol.

In this way, the comparative evaluation section 86 performs a relative comparison between the scopes of inventions recited in claims of plural sets of patent specification data. For example, the comparative evaluation section 86 evaluates a patent right of the invention recited in a claim having fewer invention constituent features as having a wider scope of right than a patent right of the invention recited in a claim having a larger number of invention constituent features. Also, the comparative evaluation section 86 evaluates a patent right of the invention recited in a Claim having invention constituent features constituted by a smaller number of characters as having a wider scope of right than a patent right of the invention recited in a claim having invention constituent features constituted by a larger number of characters.

The comparative evaluation section 86 outputs the result of the comparison to the output section 30. Also, the comparative evaluation section 86 performs a relative comparison between the number of patent rights of one's company and the numbers of patent rights of other companies. As a result of this, the strength of patent rights of each company or the like is analyzed. The comparative evaluation section 86 outputs the result of the comparison to the output section 30.

<2. Operation Flow>

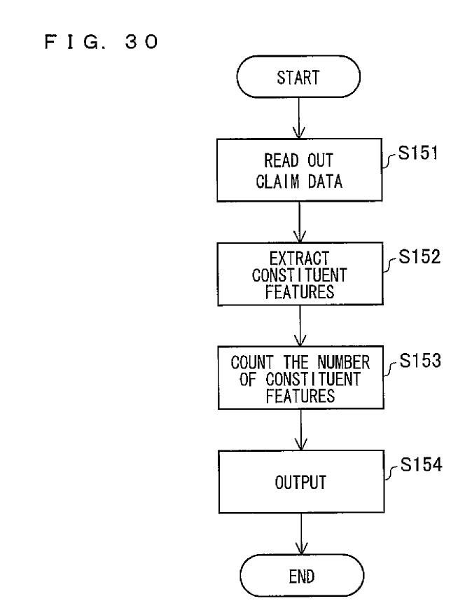

The following will explain how the patent information analyzing apparatus 14b operates, with reference to FIG. 30 to FIG. 32. FIG. 30 illustrates the operation of the patent information analyzing apparatus 14b of Tenth Embodiment. The user inputs a patent number of the target of analysis through the input section 20. Based on the patent number thus input, the data processing section 57 reads out claim data of the set of patent specification data with this patent number, from the storage section 40 (S151). The invention constituent feature extraction section 66 extracts, from the claim data thus read out, an invention constituent feature (S152). The invention constituent feature counting section 76 counts the number of characters of the invention constituent feature extracted by the invention constituent feature extraction section 66 (S153). The output section 30 outputs the result of the analysis by the invention constituent feature counting section 76 to the output device (S154).

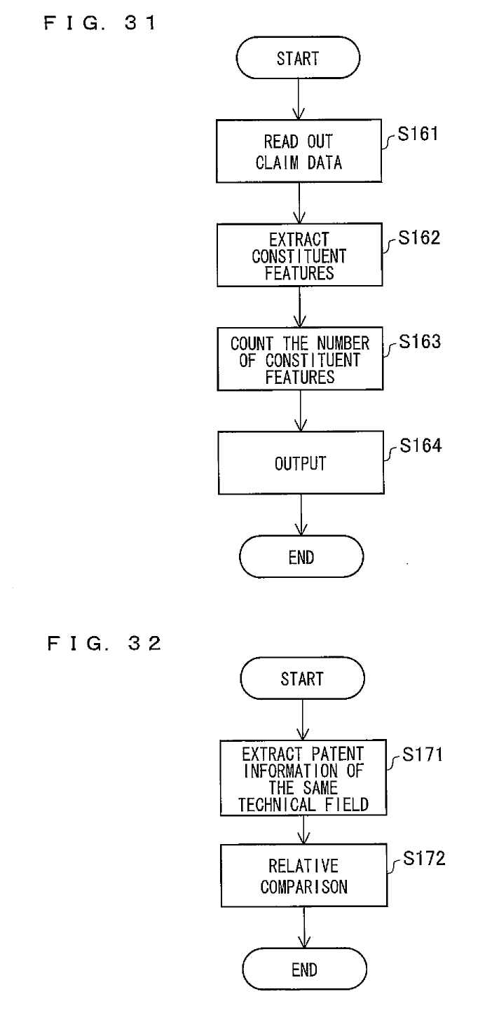

FIG. 31 illustrates how the patent information analyzing apparatus 14b of Tenth Embodiment operates. The user inputs a patent number of the target of analysis, through the input section 20. Based on the patent number thus input, the data processing section 57 reads out claim data of the set of patent specification data with this patent number from the storage section 40 (S161). The invention constituent feature extraction section 66 extracts, from the claims thus read out, an invention constituent feature (S162). The invention constituent feature character counting section 77 counts the number of characters constituting the invention constituent feature extracted by the invention constituent feature extraction section 66 (S163). The output section 30 outputs the result of the analysis by the invention constituent feature character counting section 77 to the output device (S164).

FIG. 32 illustrates how the comparative evaluation section 86 of the patent information analyzing apparatus 14b of Tenth Embodiment operates.

As discussed above, the invention constituent feature counting section 76 counts the number of invention constituent features in an independent claim of each set of patent specification data. Furthermore, the invention constituent feature character counting section 77 counts the number of characters of invention constituent features in an independent claim of each set of patent specification data. From the data to which the aforesaid processes have been performed, the comparative evaluation section 86 extracts patent information regarding sets of patent specification data of the same field (S171).

Subsequently, the comparative evaluation section 86 performs a relative comparison between the sets of patent specification data of the same field (S172). For example, the comparative evaluation section 86 calculates the industrial average in one technical field of the number of invention constituent features in claim 1, and performs a relative comparison between the industrial average and (i) patents owned by one's company, (ii) the number of invention specifying features of patents of other companies, or (iii) the number of characters, so as to compare and evaluate the comprehensive capabilities in patent matters of the companies.

As discussed above. the patent information analyzing apparatus 14b of the present embodiment processes (i) the number of invention constituent features and (ii) the number of characters in the invention specifying features, and (i) and (ii) are processed independently. Alternatively, the patent information analyzing apparatus 14b may analyze patent specification data by combining the number of invention constituent features with the number of characters in invention specifying features. As a result of this, for example, the patent information analyzing apparatus 14b can analyze patent specification data in a detailed manner, in such a way that a set of patent specification data having fewer invention constituent features and including claims in which the number of characters in invention specifying features is regarded as a set of patent specification data having a broad scope of right.

### Eleventh Embodiment

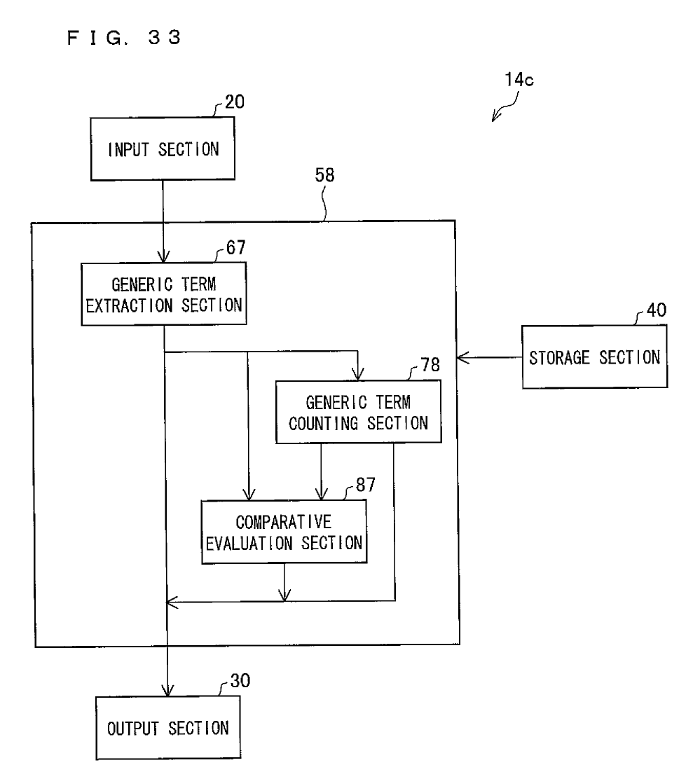

The following will explain Eleventh Embodiment of the present invention with reference to FIG. 33 to FIG. 35.

The patent information analyzing apparatus 14c of the present embodiment extracts generic terms from the character strings in an independent claim of a set of patent specification data. Furthermore, the patent information analyzing apparatus 14c counts the number of the extracted generic terms.

<Apparatus Configuration>

The following will explain the patent information analyzing apparatus 14c of the present embodiment with reference to FIG. 33. FIG. 33 is a block diagram showing the patent information analyzing apparatus 14c of Eleventh Embodiment. As shown in the figure, the patent information analyzing apparatus 14c includes an input section 20, an output section 30, a storage section 40, and a data processing section 58.

Among these members, the input section 20, the output section 30, and the storage section 40 are identical with those shown in FIG. 24 and hence the explanations are omitted.

The following will describe the data processing section 58 with reference to FIG. 33. As shown in FIG. 33, the data processing section 58 includes a generic term extraction section 67 (character string comparison means, generic term extraction means), a generic term counting section 78 (generic term counting means), and a comparative evaluation section 87 (third comparative evaluation means).

Based on a patent number input through the input section 20, the data processing section 58 analyzes the set of patent specification data with this patent number. In doing so, the data processing section 58 reads out the set of patent specification data with the patent number thus input, from the storage section 40. In particular, the data processing section 58 reads out claim data of the set of patent specification data. In the present embodiment, the data processing section 58 reads out the claim data of the set of patent specification data, as Japanese text data. The data processing section 58 stores the text data thus read out in a work memory which is not illustrated. The data processing section 58 therefore analyzes the text data stored in the non-illustrated work memory.

The generic term extraction section 67 extracts, from the work memory, generic terms included in the claim of the set of patent specification data. A generic term is a collective term of related matters or a collective term of matters sharing a particular characteristic, and indicates a conception which is abstract as compared to a conception indicated by a narrower term. For example, an example of a generic term in Japanese patent specifications is “elastic member” which is a superordinate conception of “spring and rubber”. Another example is “stretchable member” which is a superordinate conception of “sponge, urethane, air-bag”.

The patent information analyzing apparatus 14c stores such generic terms in an non-illustrated ROM in advance. The generic term extraction section 67 therefore reads out the data from the ROM and use it for pattern matching. The storage medium in which generic terms are stored in advance may be a CD-ROM, a DVD-ROM, a hard disc, or the like.

The generic term extraction section 67 reads out the generic terms from the ROM. Then the generic term extraction section 67 compares the character strings in the claim which is the target of analysis with the generic terms read out from the ROM, so as to extract generic terms from the claim. The generic term extraction section 67 outputs the extracted generic terms to the generic term counting section 78.

The generic term counting section 78 counts the number of generic terms extracted by the generic term extraction section 67. The generic term counting section 78 outputs the result of the counting to the output section 30.

<2. Operation Flow>

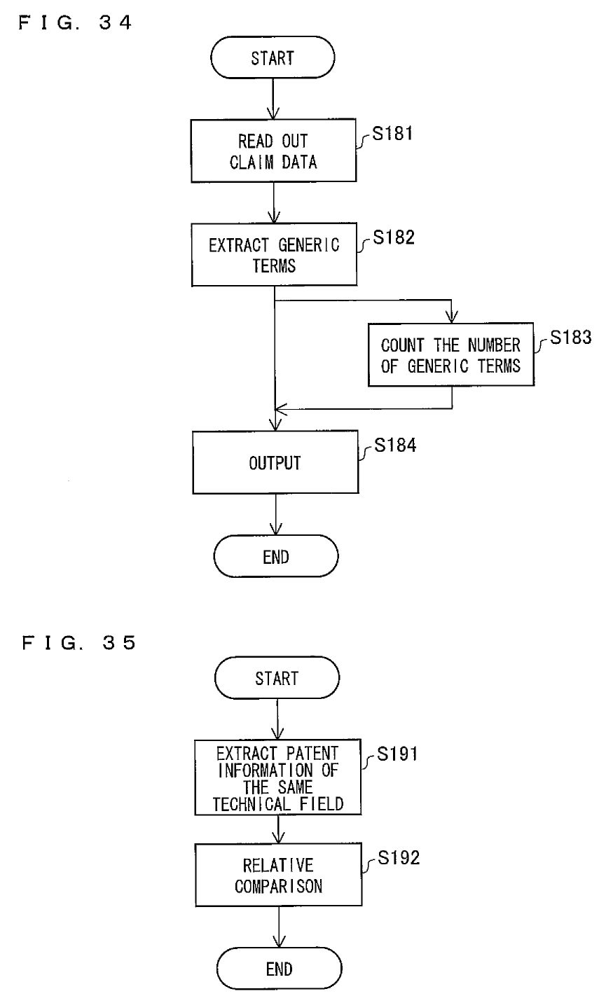

The following will explain how the patent information analyzing apparatus 14c operates, with reference to FIG. 34 and FIG. 35. FIG. 34 illustrates how patent information analyzing apparatus 14c of Eleventh Embodiment operates. The user input a patent number of the target of analysis through the input section 20. Based on the patent number thus input, the data processing section 58 reads out claim data of the set of patent specification data with this patent number, from the storage section 40 (S181). The generic term extraction section 67 extracts generic terms from the claim data thus read out (S182). The generic term extraction section 67 outputs, to the output section 30, the result of the process of determining whether a generic term has been extracted or not (S184). The generic term counting section 78 counts the number of the generic terms extracted by the generic term extraction section 67 (S183). The output section 30 outputs the result of the counting by the generic term counting section 78 to the output device (S184).

FIG. 35 illustrates how the comparative evaluation section 87 of the patent information analyzing apparatus 14c of Eleventh Embodiment operates.

As discussed above, the generic term counting section 78 counts the number of generic terms in an independent claim of each set of patent specification data. From the data to which the aforesaid processes have been performed, the comparative evaluation section 87 extracts patent information regarding sets of patent specification data of the same technical field (S191).

Subsequently, the comparative evaluation section 87 performs a relative comparison between the sets of patent specification data of the same field (5192). For example, the comparative evaluation section 87 calculates the industry average of the number of generic terms in each claim 1 in the technical field, and performs a relative comparison between the industrial average and (i) generic terms in patents owned by one's company or (ii) the number of generic terms in patents of other companies, so as to compare and evaluate the comprehensive capabilities in patent matters of the companies.

<3. Summary>

As discussed above, the patent information analyzing apparatus 14c of the present embodiment extracts generic terms from an independent claim of a set of patent specification data. The patent information analyzing apparatus 14c can therefore analyze the scope of the patent pertaining to the claim which is the target of analysis. Furthermore, when plural sets of patent specification data are analyzed, sets of patent information of sets of patent specification data of the same technical field are compared with one another and hence sets of patent specification data are fairly analyzed with a high reliability.

### Twelfth Embodiment

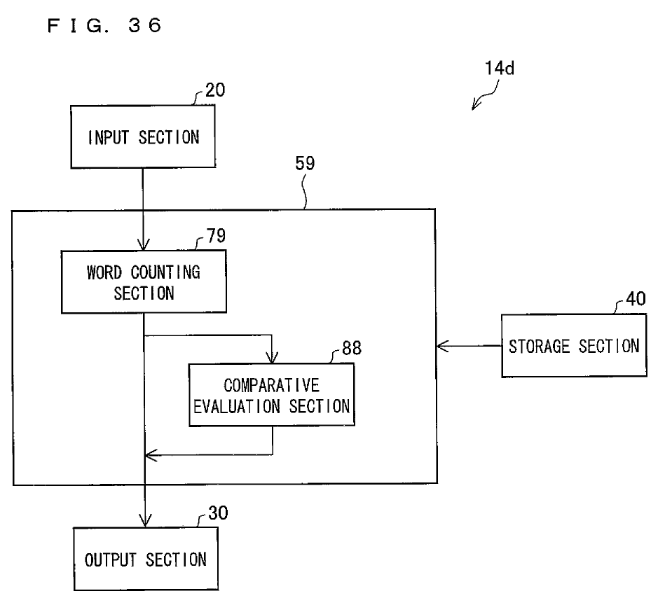

The following will explain Twelfth Embodiment of the present invention with reference to FIG. 36 to FIG. 39.

The patent information analyzing apparatus 14d of the present embodiment particularly counts the number of words in a claim of English patent specification data such as U.S. patent specifications. More specifically, the patent information analyzing apparatus 14d extracts spaces in an independent claim of a set of patent specification data, so as to count the number of spaces.

<Apparatus Configuration>

The following will explain the patent information analyzing apparatus 14d with reference to FIG. 36. FIG. 36 is a block diagram showing the patent information analyzing apparatus 14d of Twelfth Embodiment. As shown in the figure, the patent information analyzing apparatus 14d includes an input section 20, an output section 30, a storage section 40, and a data processing section 59.

Among these members, the input section 20, the output section 30, and the storage section 40 are identical with those shown in FIG. 24 and hence the explanations are omitted.

The data processing section 59 analyzes a set of patent specification data having a patent number input through the input section 20. In doing so, the data processing section 59 reads out the set of patent specification data having the patent number thus input, from the storage section 40. In particular, the data processing section 59 reads out claim data of the set of patent specification data. In the present embodiment, the data processing section 59 reads out the claim data of the set of patent specification data, as text data. The data processing section 59 stores this text data in a work memory which is not illustrated. The data processing section 59 therefore analyzes the text data stored in the non-illustrated work memory.

The following will describe the data processing section 59 with reference to FIG. 36. As FIG. 36 shows, the data processing section 59 includes a word counting section 79 (word counting means) and a comparative evaluation section 88 (third comparative evaluation means).

The word counting section 79 extracts words in a claim of a set of patent specification data. In doing so, the word counting section 79 extracts spaces in the claim which is the target of analysis. The word counting section 79 therefore counts the number of spaces in the claim. Patent specifications written in European languages, such as U.S. patent specifications, are typically arranged such that a claim is constituted by words each of which is sandwiched between spaces. On this account, the patent information analyzing apparatus 14d can loosely grasp the number of words by counting the number of spaces, when text data of a patent specification written in a European language is analyzed.

In addition to spaces, the word counting section 79 may count line feed characters indicating line feeds in text data. For example, in case where the text data is encoded by ASCII code, the word counting section 79 may count the number of control symbols “LF (line feed)” indicating line feeds. This allows the word counting section 79 to count the number of words in a more precise manner.

<2. Operation Flow>

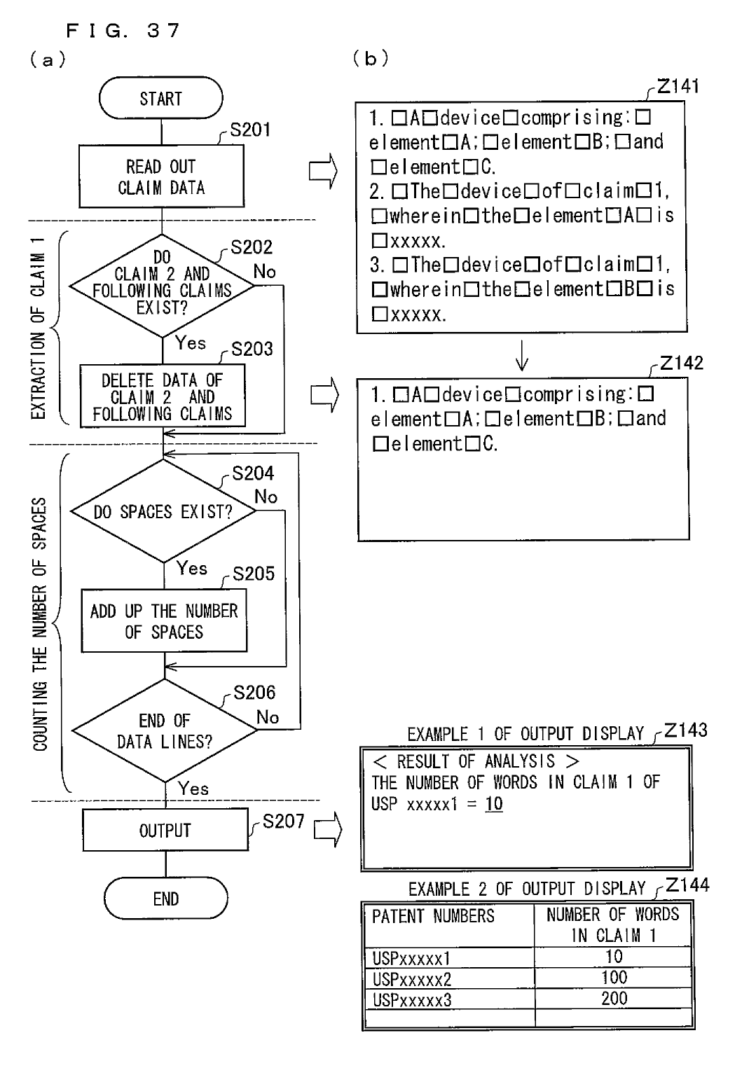

The following will explain how the patent information analyzing apparatus 14d operates, with reference to FIG. 37 to FIG. 39. FIG. 37 illustrates the operation of the patent information analyzing apparatus 14d of Twelfth Embodiment. The (a) part of FIG. 37 is a flowchart of the operation of the patent information analyzing apparatus 14d. The (b) part of FIG. 37 shows examples of text data processed by the patent information analyzing apparatus 14d and a result of analysis to be output. The user inputs a patent number of the target of analysis through the input section 20. Based on the patent number thus input, the data processing section 59 reads out the set of patent specification data (claim data in particular) with the patent number, from the storage section 40 (S201).

As indicated in the (b) part of FIG. 37, in the present embodiment, the data processing section 59 reads out text data indicated by Z141 from the storage section 40. That is, text data of claim data including the following words is read out.

A device comprising: element A; element B; and element C.

The device of claim 1, wherein the element A is xxxxx.

The device of claim 1, wherein the element B is xxxxx.

The format of the text data indicated by Z141 is arranged such that words are separated by spaces and claims are separated by line feed characters. IN Z141 and Z142, spaces are indicated by the symbol “□” (white square).

The word counting section 79 then judges whether the claim data thus read out includes claim 2 and following claims (S202). For example, the word counting section 79 judges whether text data includes the words “2.” which indicates the existence of claim 2. If the judgment is “true”, the word counting section 79 deletes the text data of claim 2 and following claims from the claim data thus read out (S203). In other words, the word counting section 79 deletes the data of “2.” and all data subsequent to “2.”, from the text data which is the target of analysis. As a result, the word counting section 79 extracts text data of only claim 1. On the other hand, if the judgment is “false”, the word counting section 79 skips the process in S202.

As a result of the processes above, the word counting section 79 obtains the text data indicated by Z142. Then the word counting section 79 processes text data of a claim including the following words.

A device comprising: element A; element B; and element C.

The word counting section 79 then judges whether a space exists in the text data indicated by Z142 (S204). In the present embodiment, the word counting section 79 judges a space is included in the text data. If the judgment is “true”, the word counting section 79 adds 1 to the number of spaces having currently been counted (S205). Subsequently, the word counting section 79 judges whether the data which is currently processed is the end of the data row (S206). If the judgment is “false”, the word counting section 79 resumes the process in S204. That is to say, the word counting section 79 repeatedly performs the search of spaces and addition to the number of spaces, from the start to the end of the text data. On the other hand, if the judgment in S206 is “true”, the word counting section 79 outputs the counted number of spaces, i.e. the number of words to the output section 30.

The text data indicated by Z142 includes 10 spaces. The word counting section 79 therefore counts 10 spaces in the text data indicated by Z142.

Subsequently, the output section 30 outputs the result of the counting to the output device (S207). In response to this, the output device outputs the result of the analysis in Z143 by monitor display, printout, or the like. In other words, the output section 30 indicates the number of words in claim 1 of “USP xxxxx1” is 10, by monitor display, printout, or the like.

When plural sets of patent specification data are analyzed, the output section 30 outputs the result of the analysis indicated by Z144 to the output device. That is to say, the output section 30 outputs a table in which patent numbers of sets of patent specification are associated with the numbers of words in claims 1 of the respective sets of patent specification. With this, in the case of Z144, the output device indicates, by monitor display, printout, or the like, that the number of words in claim 1 of a set of patent specification with the patent number “USP xxxxx1” is “10”). The output device also indicates, by monitor display, printout, or the like, that the number of words in claim 1 of a set of patent specification with the patent number “USP xxxxx2” is “100”. The output device also indicates, by monitor display, printout, or the like, that the number of words in claim 1 of a set of patent specification with the patent number “USP xxxxx3” is “200”.

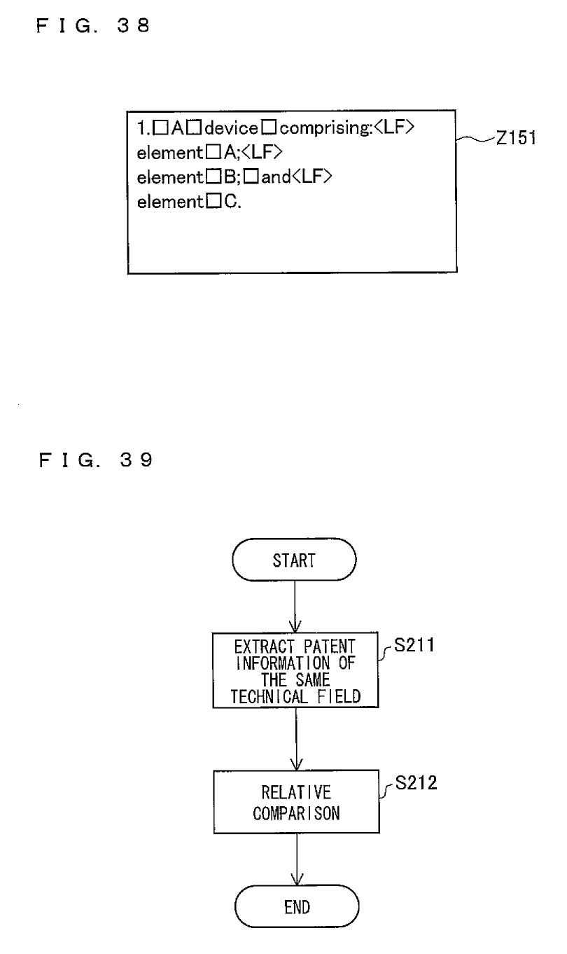

FIG. 38 shows text data with another format which is analyzed by the patent information analyzing apparatus 14d of Twelfth Embodiment. The output section 30 can process the text data having the format indicated by Z151 in FIG. 38. The text data indicated by Z151 is arranged as follows.

A device comprising: <LF>

element A;<LF>

element B;<LF>

and element C.

In this way, the paragraph or line always ends with the line feed character (“<LF>” in the figure).

To count the number of words in the text data with the aforesaid format, the word counting section 79 counts the number of line feed characters (control symbol “LF (line feed)” in the case of ASCII) indicating line feeds, in addition to spaces. This makes it possible to count the number of words immediately before the line feed characters. The word counting section 79 can therefore count the number of words in the text data which is the target of analysis, in a further precise manner.

Referring to FIG. 39, the following will describe a case where the patent information analyzing apparatus 14d performs a relative comparison between sets of patent specification data belonging to the same technical field. FIG. 39 illustrates how the comparative evaluation section 88 of the patent information analyzing apparatus 14d of Twelfth Embodiment operates. As discussed above, word counting section 79 counts the number of words in an independent claim of a set of patent specification data, by counting the number of spaces in the independent claim. From the data to which the aforesaid processes have been performed, the comparative evaluation section 88 extracts patent information regarding sets of patent specification data belonging to the same technical field (S211).

Subsequently, the comparative evaluation section 88 performs a relative comparison between the sets of patent specification data belonging to the same technical field (S212). For example, the comparative evaluation section 88 calculates the industry average of words in claim 1 in the same technical field and performs a relative comparison between the industrial average and the number of words in the patents of one's company or of other companies, so as to compare and evaluate the comprehensive capabilities in patent matters of the respective companies.

<3. Summary>

As discussed above, the patent information analyzing apparatus 14d of the present embodiment counts the number of words in an independent claim of a set of patent specification data. By doing so, the patent information analyzing apparatus 14d can analyze the scope of right of the claim which is the target of the analysis. Furthermore, to analyze plural sets of patent specification data, the patent information analyzing apparatus 14d performs a comparison between sets of patent specification data belonging to the same technical field. It is therefore possible to analyze patent specification data further fairly and with a high reliability.

### Thirteenth Embodiment

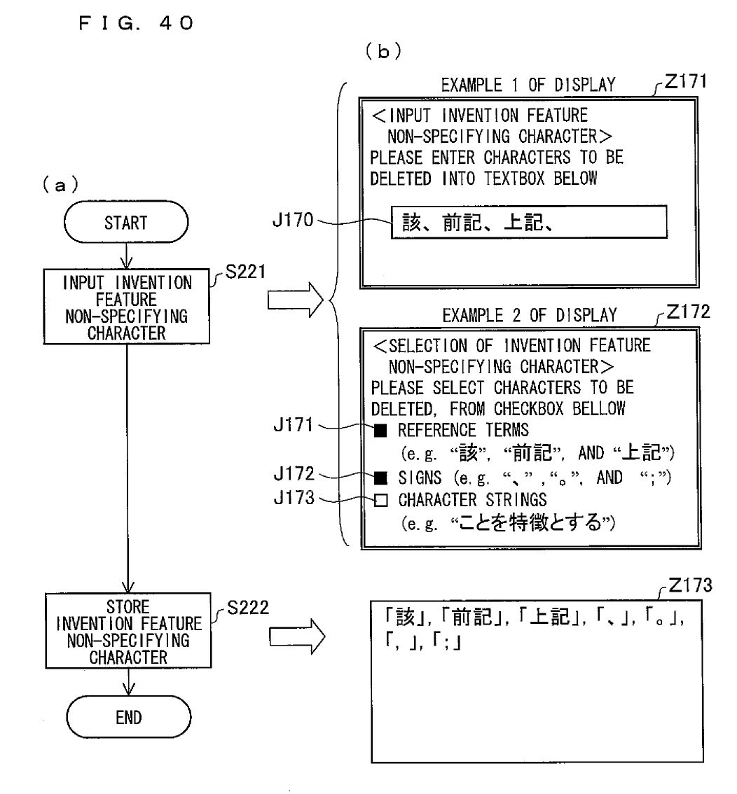

The following will explain Thirteenth Embodiment of the present invention with reference to FIG. 40.

<Apparatus Configuration>

A patent information analyzing apparatus 14′ (not illustrated) of the present embodiment is a variant of the patent information analyzing apparatus 14 of Eighth Embodiment and the patent information analyzing apparatus 14a of Ninth Embodiment. In this patent information analyzing apparatus 14′, an input section 20 (input means) receives data input from the outside. The user therefore inputs, through the input section 20 (input means), an invention feature non-specifying character to delete it from a claim. The input section 20 receives the invention feature non-specifying character input by the user, and stores it as data in a work memory. In the patent information analyzing apparatus 14′, the non-invention-specifying character deletion section 65 fetches, from the work memory, the invention feature non-specifying character which has been input by the user through the input section 20, and use the character as the character to be deleted from a claim.

<2. Operation Flow>

The following will explain the steps performed in the patent information analyzing apparatus 14′, with reference to FIG. 40. FIG. 40 illustrates how the patent information analyzing apparatus 14′ of Thirteenth Embodiment operates. The (a) part of FIG. 40 is a flowchart showing the operation of the patent information analyzing apparatus 14′. The (b) part of FIG. 40 shows examples of text data processed by the patent information analyzing apparatus 14′ and a result of analysis to be output. The patent information analyzing apparatus 14′ displays the display screen indicated by Z171, by means of a display section (not illustrated). This screen is displayed to prompt the user to input an invention feature non-specifying character to be deleted from a claim. The user inputs an invention feature non-specifying character to be deleted into the text box J170 (S221). In the example of Z171, the user inputs) “ [symbol] ”, “ [symbol] ”, and “ [symbol] ”. The input section 20 receives the invention feature non-specifying characters input by the user and stores them in a work memory which is not illustrated.

Alternatively, the patent information analyzing apparatus 14′ may display a display screen indicated by Z172, as another example of the user input screen. The display screen of Z172 includes a check box J171, a check box J172, and a check box J173. The check box J171 is provided for selecting reference terms (e.g. “ [symbol] ”, “ [symbol] ”, and “ [symbol] ”). The check box J172 is provided for selecting symbols (e.g. “ [symbol] ” “ [symbol] ”, and “;”). The check box J173 is provided for selecting formal character strings (e.g. “ [symbol] [symbol] ”). Displaying this screen, the patent information analyzing apparatus 14′ prompts the user to select invention feature non-specifying characters to be deleted from a claim.

In the example of Z172, the user has selected the check boxes J171 and J172 (indicated by “▪” (black square)). In the meanwhile, the user has not selected the check box J171 (indicated by “□” (white square)).

The non-invention-specifying character deletion section 65 stores the invention feature non-specifying characters selected by the user (S222). That is to say, as indicated in Z173, the items of the check boxes selected by the user, which are “ [symbol] ”, “ [symbol] ”, “ [symbol] ”, “ [symbol] ” “ [symbol] ”, “,”, and “;” are stored. The non-invention-specifying character deletion section 65 therefore reads out these words from the claim data and delete them.

<3. Summary>

As discussed above, the patent information analyzing apparatus 14′ of the present embodiment allows the user to optionally specify invention feature non-specifying characters. It is therefore possible to determine words to be deleted in accordance with the technical field of patent specifications to be analyzed, and hence detailed analysis suitable for the situation can be done.

### Fourteenth Embodiment

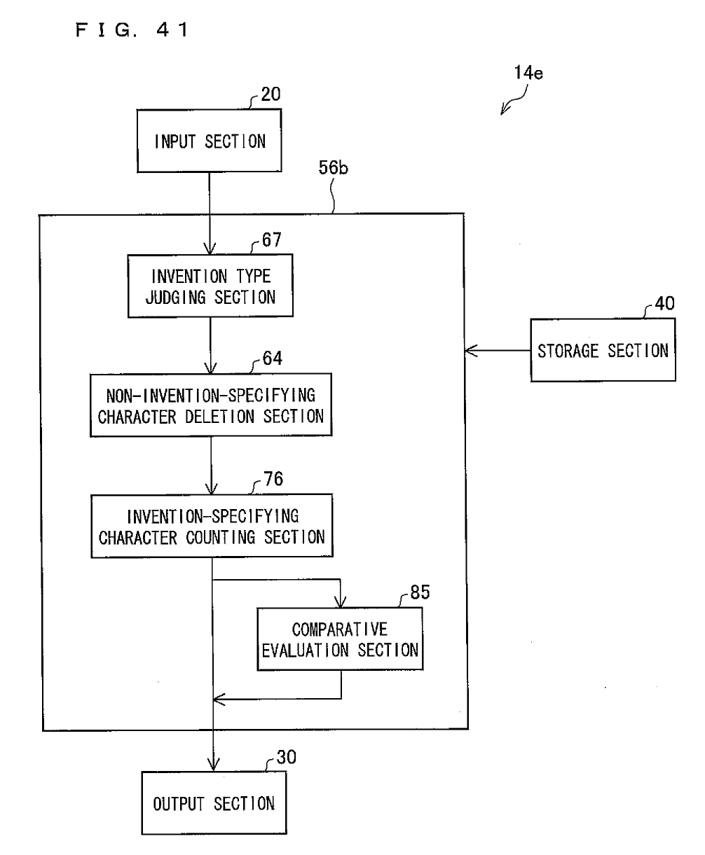

The following will explain Fourteenth Embodiment of the present invention with reference to FIG. 41.

A patent information analyzing apparatus 14e of the present embodiment judges the type of an invention recited in a claim of a set of patent specification data. Also, the patent information analyzing apparatus 14e deletes an invention feature non-specifying character included in the claim. The patent information analyzing apparatus 14e performs, with respect to the claim which is the target of analysis, both the judgment of the type of the invention and the deletion of an invention feature non-specifying character.

<Apparatus Configuration>

The following will describe a patent information analyzing apparatus 14e of the present embodiment with reference to FIG. 41. FIG. 41 illustrates how the patent information analyzing apparatus 14e of Fourteenth Embodiment operates. As shown in the figure, the patent information analyzing apparatus 14e includes an input section 20, an output section 30, a storage section 40, and a data processing section 56b.

Among these members, the input section 20, the output section 30, and the storage section 40 are identical with those shown in FIG. 24 and hence the explanations are omitted.

The data processing section 56b analyzes a set of patent specification data having a patent number input through the input section 20. In doing so, the data processing section 56b reads out the set of patent specification data having the patent number thus input, from the storage section 40. In particular, the data processing section 56b reads out claim data of the set of patent specification data. In the present embodiment, the claim data is read out by the data processing section 56b, as Japanese text data. The data processing section 56b stores the text data in a work memory which is not illustrated. The data processing section 56b therefore analyzes the text data stored in the non-illustrated work memory.

The following will describe a data processing section 58 with reference to FIG. 41. As shown in FIG. 41, the data processing section 58 includes a non-invention-specifying character deletion section 65 (character string comparison means, non-invention-specifying character deletion means), an invention-specifying character counting section 75 (invention-specifying character counting means), an invention type judging section 67 (character string comparison means, invention constituent feature extraction means, second invention type judging means), and a comparative evaluation section 85 (third comparative evaluation means).

Among these members, the non-invention-specifying character deletion section 65, the invention-specifying character counting section 75, and the comparative evaluation section 85 are identical with those shown in FIG. 24 and hence the explanations are omitted.

The invention type judging section 67 judges the type of an invention recited in a claim of a set of patent specification data. In doing so, the invention type judging section 67 judges whether an invention pertaining to a claim is a product invention or a method invention. The invention type judging section 67 performs the judgment by means of a character search technique such as pattern matching.

The patent information analyzing apparatus 14e stores in advance character strings specifying the types of inventions in a ROM which is not illustrated. The invention type judging section 67 therefore reads out the data from the ROM and use it for pattern matching. The storage medium in which character strings specifying the types of inventions are stored in advance may be a CD-ROM, a DVD-ROM, a hard disc, or the like.

A claim of a Japanese patent specification typically ends with the character string in which a word specifying the type of an invention is followed by the full stop “ [symbol] ”. For example, claims pertaining to product inventions end with the word such as “ [symbol] ”, “ [symbol] ”, “ [symbol] ”, “ [symbol] ”, “ [symbol] ”, “ [symbol] ”, and “ [symbol] ” followed by the full stop “ [symbol] ”. Claims pertaining to method inventions end with the word such as “ [symbol] ”, “ [symbol] ”, and “ [symbol] ” followed by the full stop “ [symbol] ”.

The invention type judging section 67 reads out, from the ROM, such character strings specifying the types of inventions. The invention type judging section 67 performs a relative comparison between the word with which the claim to be analyzed ends and the invention type indicating character strings read out from the ROM, so as to judge whether the ending word of the claim is one of the predetermined invention type indicating character strings. If it is judged that the ending word of the claim is a character string indicating a product claim, the invention type judging section 67 determines that the claim which is the target of the analysis is a claim pertaining to a product invention. On the other hand, if it is judged that the ending word of the claim is a character string indicating a method invention, the invention type judging section 67 determines that the claim which is the target of the analysis is a claim pertaining to a method invention. Alternatively, if it is judged that the ending word of the claim is not a character string indicating a method invention, the invention type judging section 67 determines that the claim which is the target of the analysis is a claim pertaining to a product invention.

Roughly speaking, claims (independent claims) of patent specifications written in English are typically constituted by three parts, which are the preamble (introductory part describing the object to be claimed), the transitional phrase (connecting the preamble with the substantive part), and the substantive part (important part reciting the characteristic of the invention). The words (character strings) specifying the type of the invention are usually recited in the preamble. For this reason, the invention type judging section 67 compares the words in the preamble with the invention type indicating character strings (in English, words such as “apparatus” in cases of product inventions or words such as “process” in cases of method inventions) reads out from the ROM, so as to determine that the invention is a product invention or a method invention.

The invention type judging section 67 associates the patent number of the set of patent specification data which is the target of the analysis with the invention type indicating character string thus specified. For example, the invention type judging section 67 associates the patent number “ . . . ” with the character string “method invention”. The invention type judging section 67 outputs the data generated by the aforesaid association to the non-invention-specifying character deletion section 65.

In this manner, the patent information analyzing apparatus 14e of the present embodiment includes the non-invention-specifying character deletion section 65 and the invention type judging section 67. On this account, the patent information analyzing apparatus 14e can, for example, delete a invention feature non-specifying character from claim data which is determined to be related to a product invention. The patent information analyzing apparatus 14e can therefore analyze claims having wider scopes of rights. In other words, the patent information analyzing apparatus 14e can analyze patent specification data in a more detailed manner.

<2. Summary>

As discussed above, the patent information analyzing apparatus 14e of the present embodiment is a combination of the patent information analyzing apparatus 14 of Eighth Embodiment with the invention type judging section 67. Not limited to this arrangement, the patent information analyzing apparatus 14e may be a combination of a patent information analyzing apparatus of another embodiment with the invention type judging section 67.

### Fifteenth Embodiment

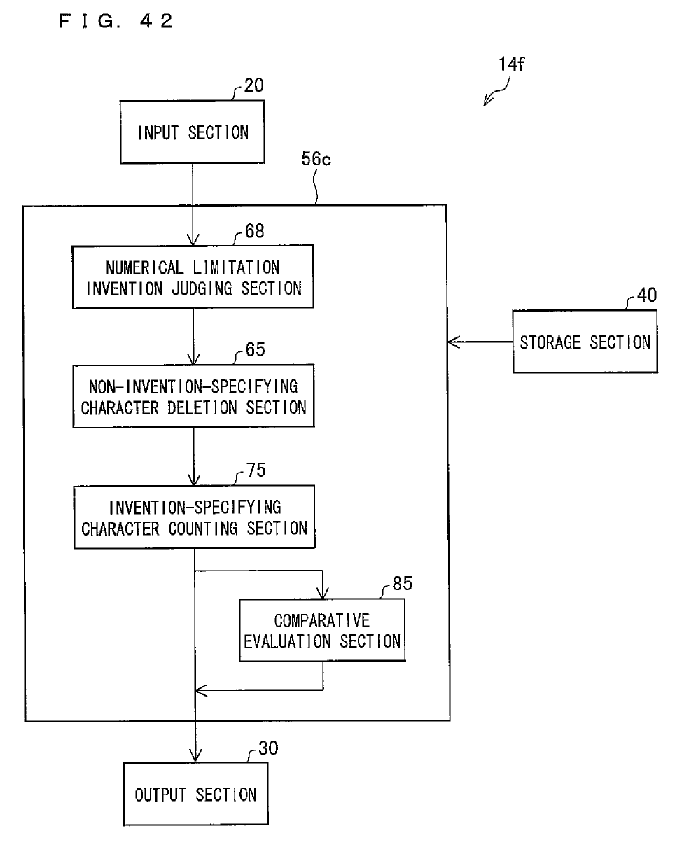

The following will describe Fifteenth Embodiment of the present invention with reference to FIG. 42.

A patent information analyzing apparatus 14f of the present embodiment judges whether the invention pertaining to a claim of a set of patent specification data is a numerical limitation invention. Furthermore, the patent information analyzing apparatus 14f deletes an invention feature non-specifying character in the claim. The patent information analyzing apparatus 14f therefore performs, with respect to the claim to be analyzed, both the judgment as to whether a numerical limitation invention or not and the deletion of an invention feature non-specifying character.

<Apparatus Configuration>

The following will describe a patent information analyzing apparatus 14f of the present embodiment with reference to FIG. 42. FIG. 42 illustrates how the patent information analyzing apparatus 14f of Fifteenth Embodiment operates. As shown in the figure, the patent information analyzing apparatus 14f includes an input section 20, an output section 30, a storage section 40, and a data processing section 56c.

Among these members, the input section 20, the output section 30, and the storage section 40 are identical with those shown in FIG. 24 and hence the explanations are omitted.

The data processing section 56c analyzes a set of patent specification data having a patent number input through the input section 20. In doing so, the data processing section 56c reads out, from the storage section 40, the set of patent specification data having the patent number thus input. In particular, the data processing section 56c reads out claim data of the set of patent specification data. In the present embodiment, the data processing section 56c reads out the claim data of the set of patent specification data, as Japanese text data. The data processing section 56c stores this text data in a work memory which is not illustrated. The data processing section 56c therefore analyzes the text data stored in the non-illustrated work memory.

The numerical limitation invention judging section 68 (second numerical limitation invention judging means) judges the type of an invention recited in a claim of a set of patent specification data. In doing so, the numerical limitation invention judging section 68 judges whether the invention recited in a claim is a numerical limitation invention. The numerical limitation invention judging section 68 carries out this judgment by means of a character search technique such as pattern matching.

The patent information analyzing apparatus 14f stores in advance character strings indicating predetermined numerical limitations in a ROM which is not illustrated. The numerical limitation invention judging section 68 therefore reads out this data from the ROM and use it for pattern matching. The storage medium in which the character strings indicating predetermined numerical limitations are stored may be a CD-ROM, a DVD-ROM, a hard disc, or the like.

Examples of the character strings indicating numerical limitations include unit symbols (e.g. “°”, “μ”, and “%”), arithmetic signs which are part of numerical expressions (e.g. “≧”, “>”, “≦”, and “<”), and character strings indicating quantities (e.g. “not more than” and “less than”). In case where the invention pertaining to the claim of the patent specification is a numerical limitation invention, the claim includes such a character string indicating a numerical limitation.

The numerical limitation invention judging section 68 judges the type of the invention recited in a claim of a set of patent specification data. In doing so, the numerical limitation invention judging section 68 [symbol] judges whether the invention pertaining to the claim is a numerical limitation invention. The numerical limitation invention judging section 68 carries out this judgment by means of a character search technique such as pattern matching.

The numerical limitation invention judging section 68 therefore reads out, from the ROM, character strings indicating numerical limitations. The numerical limitation invention judging section 68 then compares character strings in the claim which is the target of analysis with the character strings indicating numerical limitations and read out from the ROM, so as to judge whether the claim includes a character string indicating a numerical limitation. If it is judged that the claim includes a character string indicating a numerical limitation, the numerical limitation invention judging section 68 determines that the claim which is the target of the analysis is a claim pertaining to a numerical limitation invention. On the other hand, if it is judged that the claim does not include a character string indicating a numerical limitation, the numerical limitation invention judging section 68 determines that the claim which is the target of the analysis is a claim pertaining to an invention not including a numerical limitation.

The numerical limitation invention judging section 68 associates the patent number of the patent specification data which is the target of the analysis with the invention type indicating character string thus specified. For example, the numerical limitation invention judging section 68 associated the patent number “ . . . ” with the character string “numerical limitation invention”. The numerical limitation invention judging section 68 outputs the data generated by this association to the non-invention-specifying character deletion section 65.

<2. Summary>

As discussed above, the patent information analyzing apparatus 14f of the present embodiment is a combination of the patent information analyzing apparatus 14 of Eighth Embodiment with the numerical limitation invention judging section 68. Not limited to this arrangement, the patent information analyzing apparatus 14f may be a combination of a patent information analyzing apparatus of another embodiment with the numerical limitation invention judging section 68.

<Supplemental Remarks of Eighth to Fifteenth Embodiments>

The patent information analyzing apparatus may combine the results of analysis in Eighth to Fifteenth Embodiments. For example, it is possible to search a set of patent specification data with a broader scope of right by combining the extraction of constituent feature in the claim with the extraction of generic terms in the same claim.

In Eighth to Fifteenth Embodiments, the patent information analyzing apparatus analyzes patent specification data. Alternatively, the target of analysis may be utility model specification data. That is, patent information in the present invention includes patent specification data and utility model specification data.

In Eighth to Fifteenth Embodiments, the patent information analyzing apparatus analyzes only claim 1. Not limited to this arrangement, the target of analysis may be all claims. In doing so, it is preferable that the target of analysis be inventions pertaining to independent claims. The number of limitations in an invention pertaining to an independent claim is typically smaller than those in an invention pertaining to a dependent claim. It is therefore preferable to judge the type of the invention pertaining to an independent claim.

Whether a claim is independent or not may be determined, for example, by checking the character strings constituting the claim. That is to say, a dependent claim includes a character string citing another claim such as “ [symbol] [symbol] 1 [symbol] 3 [symbol] ”, and the character string “ [symbol] ” is always included. On the other hand, not citing another claim, an independent claim does not include the character string “ [symbol] ”. Therefore, it is possible to determine whether a claim is independent or not by checking whether the character string “ [symbol] ” is included in the claim.

In Eighth to Fifteenth Embodiments, the patent information analyzing apparatus judges whether two sets of patent specification data are patent information belonging to the same technical field, by means of patent classification symbols such as IPC, FI, F term, and US Class. Alternatively, the patent information analyzing apparatus may judge whether plural sets of patent specification data are patent information belonging to the same technical field, by optionally performing keyword search or the like. In such a case, whether sets patent specification data are patent information belonging to the same technical field is determined based on the result of the keyword search.

<Overall Supplemental Remarks>

In First to Fifteenth Embodiments, the patent information analyzing apparatus stores text data in the storage section 40. The patent specification data may have a format other than text data, on condition that the data is processable by the patent information analyzing apparatus. For example, the patent specification data may be HTML (Hyper Text Markup Language) data or XML (Extensible Markup Language).

In First to Fifteenth Embodiments the targets of analysis are mainly Japanese patent specification (written in Japanese) or U.S. patent specifications (written in English). Not limited to this arrangement, in accordance with patent specifications of different countries, words (character strings) of various languages may be appropriately judged and analyzed.

As discussed above, the invention type judging section 63 compares character strings in a claim of a set of patent specification data with predetermined character strings indicating types of inventions. Based on the result of the comparison, the invention type judging section 63 judges the type of the invention recited in the claim which is the target of the analysis. The invention quantity counting section 73 counts the number of inventions specified by the invention type judging section 63. The comparative evaluation section 83 evaluates patent specification data based on the result of the counting by the invention quantity counting section 73. It is therefore possible to objectively analyze whether the invention recited in a claim of a set of patent specification is easily exercisable.

In addition to the above, the non-invention-specifying character deletion section 65 compares the character strings in the claim with predetermined formal character strings not directly related to the specification of the invention recited in the claim. By doing so, the non-invention-specifying character deletion section 65 deletes, from the set of patent specification data which is the target of the analysis, at least one of formal character strings included in the claim. The invention-specifying character counting section 75 counts the number of words in the claim from which at least one of the formal character strings has been deleted. It is therefore possible to objectively analyze the scope of right of the invention recited in the claim of the set of patent specification.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

The objective of the present invention can be achieved in the following manner: program code (e.g. an executable code program, intermediate code program, and source program) of the patent information analyzing apparatus, the control program being software for realizing the functions, is recorded on a storage medium in a computer-readable manner, this storage medium is supplied to the patent information analyzing apparatus, and the computer (or CPU (Central Processing Unit). MPU (Micro Processing Unit), or DSP (Digital Signal Processor)) reads out the program code from the storage medium and execute the program.

Such a storage medium for supplying the program code may be arranged to be detachable from the apparatus. The storage medium may store the program code in a fixed manner and can supply the program code. The storage medium may be attached to the apparatus in such a manner that the stored program code can be directly read by the computer or may be attached as an external storage device so that the program code is read via a program reading device attached to the apparatus.

Examples of such a storage medium include a tape, such as a magnetic tape and a cassette tape; a magnetic disk, such as a flexible disk and a hard disk; a disc inclusive of an optical disc, such as a CD-ROM/MO/MD/DVD/CD-R/DVD-R/DVD-RAM; a card, such as an IC card (inclusive of a memory card) and an optical card; and a semiconductor memory, such as a mask ROM, an EPROM, an EEPROM, or a flash ROM.

The apparatus may be connectable to a communication network so that the program code is supplied to the apparatus via the communication network. The communication network is not particularly limited. Specific examples thereof are: the Internet, intranet, extranet, LAN, ISDN, VAN, CATV (cable TV) communication network, virtual private network, telephone network, mobile communication network, satellite communication network, and the like. Further, the transmission medium constituting the communication network is not particularly limited. Specific examples thereof are: (i) a wired channel using an IEEE1394, a USB, a power-line communication, a cable TV line, a telephone line, a ADSL line, or the like; or (ii) a wireless channel using IrDA, infrared rays used for a remote controller, Bluetooth®, IEEE802.11, a mobile phone network, a satellite connection, a terrestrial digital network, or the like. The present invention may be realized as a computer data signal (data signal array) which realizes the program code by electronic transmission and which is embedded in a carrier wave. The aforesaid functions may not only be realized by causing a computer to read out and execute the aforesaid program code but also be realized in such a manner that, based on instructions from the program code, an OS (Operation System) running on the computer executes at least a part of actual processes.

In addition to the above, the aforesaid functions may be realized in such a manner that the program code read out from the storage medium is written in a function enhancement board attached to the computer or a memory of a function enhancement unit attached to the computer, and then a CPU or the like of the function enhancement board or the function enhancement unit performs at least a part of the actual processes, under the instruction of the program code.

### INDUSTRIAL APPLICABILITY

The present invention is suitably used for analyzing the right acquisition capabilities of an applicant, based on patent specification data of a patent or utility model.

In addition, the present invention can be used as a patent information analyzing apparatus by which whether the invention recited in a claim of a set of patent specification data is easily exercisable, and also as a patent information analyzing apparatus for analyzing utility model specification data.

Furthermore, the present invention can be used as a patent information analyzing apparatus for objectively analyzing the scope of the invention recited in a claim of a patent specification or a utility model specification.

1. A patent information analyzing apparatus analyzing at least one set of patent specification data including at least one claim, comprising:
claim analysis means for representing the scope of right of the first claim of said at least one claim by a numerical value; and
first analysis process means for adding up the total number of said at least one set of patent specification data whose scope of rights have been represented by numerical values by the claim analysis means, and calculating the average of the scopes of rights.

2. The patent information analyzing apparatus as defined in claim 1, further comprising first comparative evaluation means for performing a relative comparison of the averages of the scopes of rights calculated by the first analysis process means, between different applicants.

3. The patent information analyzing apparatus as defined in claim 1, further comprising first comparative evaluation means for performing a relative comparison of the averages of the scopes of rights calculated by the first analysis process means, between different attorneys.

4. (canceled)

5. The patent information analyzing apparatus as defined in claim 1,
wherein, said at least one set of patent specification data is obtained from an unexamined patent publication.

6. The patent information analyzing apparatus as defined in claim 1,
wherein, said at least one set of patent specification data is obtained from a registered patent publication.

7. A patent information analyzing apparatus analyzing sets of patent specification data including at least one claim, comprising:
claim analysis means for representing the scope of right of the first claim of said at least one claim by a numerical value; and
second analysis process means for performing a comparison between the scopes of rights, which have been represented by numerical values by the claim analysis means, of the sets of one set of patent specification data belonging to a single application.

8. The patent information analyzing apparatus as defined in claim 7,
wherein, the sets of patent specification data are specified based on an application number.

9. The patent information analyzing apparatus as defined in claim 7,
wherein, the sets of patent specification data are obtained from patent specification data of an unexamined patent publication and from a registered patent publication.

10. The patent information analyzing apparatus as defined in claim 7, further comprising first comparative evaluation means for performing a comparison and evaluation between differences which are results of comparisons by the second analysis process means, the results of comparisons belonging to a single technical field.

11. The patent information analyzing apparatus as defined in claim 7, further comprising third analysis process means for analyzing the result of the comparison by the second analysis means, based on data of a patent registration success rate which indicates the rate of registration of applications.

12. (canceled)

13. A patent information analyzing apparatus analyzing at least one set of patent specification data including a registered patent publication or an unexamined patent publication,
the patent information analyzing apparatus comprising fourth analysis means for adding up the number of said at least one set of patent specification data and analyzing said at least one set of patent specification data based on public attention data which indicates how said at least one set of patent specification data have drawn attentions.

14. The patent information analyzing apparatus as defined in claim 13, further comprising first comparative evaluation means for performing a comparison and evaluation between results of analysis by the fourth analysis process means, the results of analysis belonging to a single technical field.

15. The patent information analyzing apparatus as defined in claim 13,
wherein, the public attention data indicates any one of:
the number of cases against each of which a notice of trial, an opposition, or a request for reexamination has been filed;
the number of cases which have been cited as documents for denying the novelty or inventive step of an invention taught in another application or have been cited as prior art documents in specifications; and
the number of cases to each of which a request of inspection of a matter of record in the specification has been made.

16. (canceled)

17. (canceled)

18. The patent information analyzing apparatus as defined in claim 13, further comprising claim analysis means for representing the scope of right of at least one claim in said at least one set of patent specification data, by a numerical value.

19. The patent information analyzing apparatus as defined in claim 1,
wherein, the claim analysis means counts the number of characters, words, or constituent features constituting an independent claim in said at least one claim.

20. (canceled)

21. (canceled)

22. (canceled)

23. (canceled)

24. (canceled)

25. (canceled)

26. (canceled)

27. (canceled)

28. A patent information analyzing apparatus analyzing at least one set of patent specification data including at least one claim, comprising:
character string comparison means for comparing at least one character string in said at least one claim with at least one predetermined character string indicating the type of an invention; and
invention type judging means for judging the type of an invention recited in said at least one claim based on the result of the comparison by the character string comparison means.

29. (canceled)

30. A patent information analyzing apparatus analyzing at least one set of patent specification data including at least one claim, comprising:
invention type judging means for judging the type of an invention recited in said at least one claim by comparing at least one character string in said at least one claim with predetermined at least one character string indicating the type of an invention; and
numerical limitation invention judging means for judging whether the invention recited in at least one claim is a numerical limitation invention, by comparing said at least one character string in said at least one claim with the predetermined at least one character string indicating the numerical limitation invention.

31. A patent information analyzing apparatus as defined in claim 28,
wherein, said at least one claim is an independent claim.

32. (canceled)

33. The patent information analyzing apparatus as defined in claim 28, wherein, said at least one character string indicating the type of invention indicates a product invention, and
the invention type judging means judges that the invention recited in said at least one claim is a product invention.

34. The patent information analyzing apparatus as defined in claim 28,
wherein, said at least one character string indicating the type of invention indicates a method invention, and
the invention type judging means judges that the invention recited in said at least one claim is a method invention.

35. The patent information analyzing apparatus as defined in claim 28,
wherein, said at least one character string indicating the type of invention indicates a method invention, and
the invention type judging means determines that the invention recited in said at least one claim is a product invention, if the character string indicating the method invention is not recited in said at least one claim.

36. (canceled)

37. (canceled)

38. The patent information analyzing apparatus as defined in claim 30,
wherein, said at least one character string indicating the numerical limitation invention is any one of a unit symbol, an arithmetic sign which is a part of a numerical expression, and a symbol indicating a numerical quantity.

39. (canceled)

40. (canceled)

41. The patent information analyzing apparatus as defined in claim 28, further comprising invention quantity counting means for counting the number of the types of the inventions specified by the invention type judging means.

42. The patent information analyzing apparatus as defined in claim 30, further comprising numerical limitation invention quantity counting means for counting the number of the numerical limitation inventions specified by the numerical limitation invention judging means.

43. (canceled)

44. (canceled)

45. (canceled)

46. (canceled)

47. (canceled)

48. (canceled)

49. (canceled)

50. (canceled)

51. (canceled)

52. (canceled)

53. A patent information analyzing apparatus analyzing at least one set of patent specification data including at least one claim, comprising:
non-invention-specifying character deletion means for deleting, from said at least one claim, at least one formal character string which does not directly specify an invention recited in said at least one claim; and
invention-specifying character counting means for counting the number of characters in said at least one claim from which said at least one formal character string has been deleted.

54. (canceled)

55. A patent information analyzing apparatus analyzing at least one set of patent specification data including at least one claim, comprising generic term extraction means for extracting at least one generic term from said at least one claim of said at least one set of patent specification data; and
generic term counting means for counting the number of said at least one generic term extracted by the generic term extraction means.

56. A patent information analyzing apparatus analyzing at least one set of patent specification data including at least one claim, comprising word counting means for counting the number of words in said at least one claim by counting at least the number of spaces in said at least one claim.

57. The patent information analyzing apparatus as defined in claim 53,
wherein, said at least one claim is an independent claim.

58. (canceled)

59. (canceled)

60. (canceled)

61. The patent information analyzing apparatus as defined in claim 53,
wherein, said at least one formal character string is at least one of a reference term, a symbol, and a formal character string.

62. The patent information analyzing apparatus as defined in claim 53, further comprising input means for receiving data input from outside,
the non-invention-specifying character deletion means deleting, from said at least one claim, said at least one formal character string input through the input means.

63. The patent information analyzing apparatus as defined in claim 53, further comprising third comparative evaluation means for evaluating said at least one set of patent specification data, based on the result of the counting by the invention-specifying character counting means.

64. (canceled)

65. (canceled)

66. The patent information analyzing apparatus as defined in claim 55, further comprising third comparative evaluation means for evaluating said at least one set of patent specification data, based on the result of the counting by the generic term counting means.

67. The patent information analyzing apparatus as defined in claim 56, further comprising third comparative evaluation means for evaluating said at least one set of patent specification data, based on the result of the counting by the word counting means.

68. (canceled)

69. (canceled)

70. (canceled)

71. (canceled)

72. The patent information analyzing apparatus as defined in claim 53, further comprising second invention type judging means for judging the type of an invention recited in said at least one claim, by comparing at least one character string in said at least one claim with predetermined at least one character string indicating the types of an invention.

73. The patent information analyzing apparatus as defined in claim 53, further comprising second numerical limitation invention judging means for judging whether an invention recited in said at least one claim is a numerical limitation invention, by comparing at least one character string in said at least one claim with predetermined at least one character string indicating a numerical limitation.

74. (canceled)

75. (canceled)

76. (canceled)

77. (canceled)

78. (canceled)

79. A computer-readable storage medium storing a patent information analyzing program for operating the patent information analyzing apparatus defined in claim 1, the patent information analyzing program causing a computer to function as the means of the patent information analyzing apparatus.
